(19) United States
(12) Patent Application Publication
(10) Pub. No.: US 2024/0264719 A1
(43) Pub. Date: Aug. 8, 2024

(54) USER INTERFACES FOR CREATING JOURNALING ENTRIES

(71) Applicant: Apple Inc., Cupertino, CA (US)

(72) Inventors: Joseph-Alexander P. WEIL, San Anselmo, CA (US); Daniel J. ZIGMOND, Palo Alto, CA (US); Mariah W. WHITMORE, San Diego, CA (US); Adeeti V. ULLAL, Los Altos, CA (US); Nadaleen F. TEMPELMAN-KLUIT, San Jose, CA (US); Nathan A. RUSSAK, San Marcos, CA (US); Joanna M. NEWMAN, San Jose, CA (US); Elizabeth C. CRANFILL, San Francisco, CA (US)

(21) Appl. No.: 18/431,904

(22) Filed: Feb. 2, 2024

Related U.S. Application Data
(60) Provisional application No. 63/593,206, filed on Oct. 25, 2023.
(60) Provisional application No. 63/503,759, filed on May 23, 2023.
(60) Provisional application No. 63/483,263, filed on Feb. 3, 2023.

(51) Int. Cl. G06F 3/0482; G06F 9/451

(52) U.S. Cl. CPC G06F 3/0482; G06F 9/451

(57) ABSTRACT

An electronic device detects an activity event associated with a user of the electronic device and displays a prompt that facilitates creation of a journaling entry based on the activity event, displays suggested content for inclusion in a journal entry of a journaling application, displays different user interfaces including options for a user to selectively include content items of suggested content in a journal entry of a journaling application, and/or displays one or more lookbacks.

### CROSS-REFERENCE TO RELATED APPLICATIONS

This application claims the benefit of U.S. Provisional Application No. 63/593,206, filed Oct. 25, 2023, U.S. Provisional Application No. 63/503,759, filed May 23, 2023, and U.S. Provisional Application No. 63/483,263, filed Feb. 3, 2023, the contents of which are incorporated by reference in their entirety for all purposes.

### FIELD OF THE DISCLOSURE

This relates generally to user interfaces associated with creating journaling entries.

### BACKGROUND OF THE DISCLOSURE

User interaction with electronic devices has increased significantly in recent years. These devices can include computers, tablet computers, televisions, multimedia devices, mobile devices, and the like.

In some circumstances, users may wish to journal via an electronic device.

### SUMMARY OF THE DISCLOSURE

Some embodiments described in this disclosure are directed to one or more electronic devices that detect an activity event associated with a user of the electronic device, and provide prompts to a user for creating journaling entries based on such activity events. Some embodiments described in this disclosure are directed to one or more electronic devices that display suggested content for inclusion in a journal entry of a journaling application. Some embodiments described in this disclosure are directed to one or more electronic devices that display one or more lookbacks. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6QQ illustrate exemplary ways of detecting activity events and displaying a prompt to create journaling entries in accordance with some embodiments.

FIG. 7 is a flow diagram illustrating a method 700 of displaying a prompt that is selectable to initiate a process to create a journal entry in accordance with some embodiments.

FIGS. 8A-8V generally illustrate exemplary ways of displaying user interfaces for journaling in accordance with some embodiments.

FIG. 9 is a flow diagram illustrating a method 900 of displaying user interfaces for journaling in accordance with some embodiments.

FIG. 10 is a flow diagram illustrating a method 1000 for displaying user interfaces including lookbacks in accordance with some embodiments.

FIGS. 11A-11G generally illustrate ways to selectively include content of a list of suggested content items in a journal entry of a journaling application in accordance with some embodiments.

FIG. 12 is a flow diagram illustrating a method 1200 for displaying a user interface for journaling in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

It is common for users to use multiple applications to capture or track various activities, interests, and events. For example, a user may use a camera application to capture photos at a birthday party, or use a fitness application to capture the user's route or performance during a marathon. Such applications generate and store various content items (such as photos, videos, activity logs, and/or maps) that are associated with an event or activity. Users may want to keep a record of and/or remember important events and activities, such as by keeping a journal. It may be desirable for an electronic device to provide journaling user interfaces that allow the user to easily add content items from different applications to a journal entry and/or to prompt the user to create journal entries based on previously generated content items. Such user interfaces can reduce the cognitive burden on a user who uses such devices and/or wishes to create journaling entries, and can provide enhanced privacy or security. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

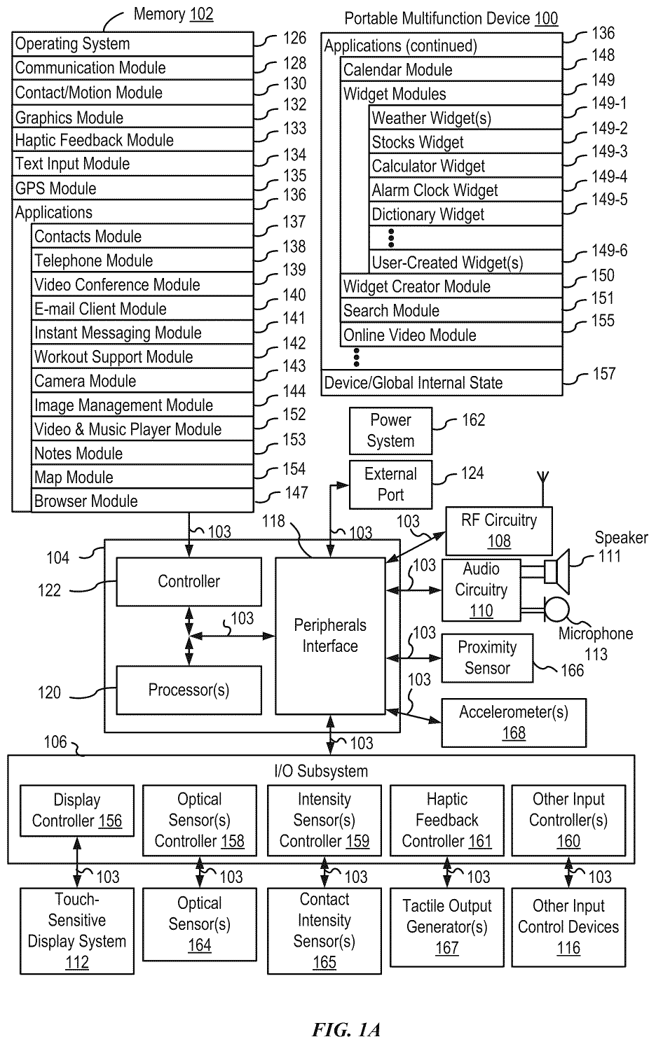

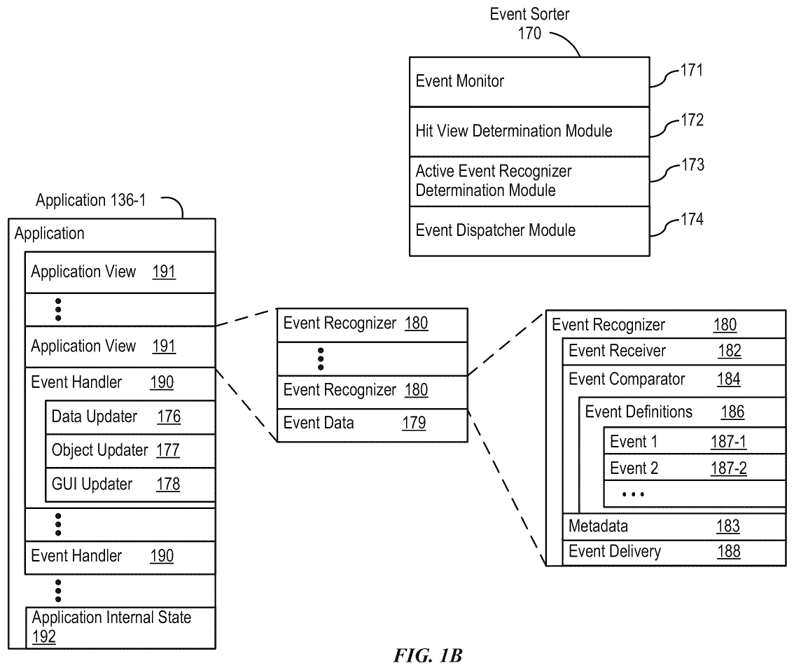

Attention is now directed toward embodiments of portable devices with touch-sensitive displays. FIG. 1A is a block diagram illustrating portable multifunction device 100 with touch-sensitive display 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

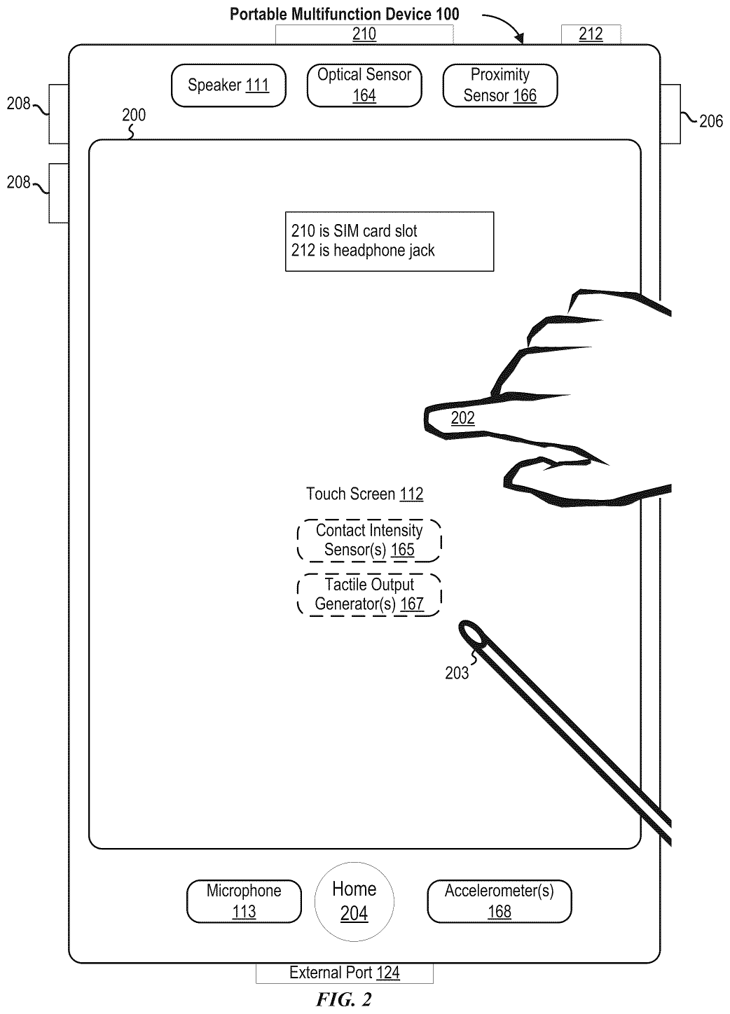

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch-sensitive display 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

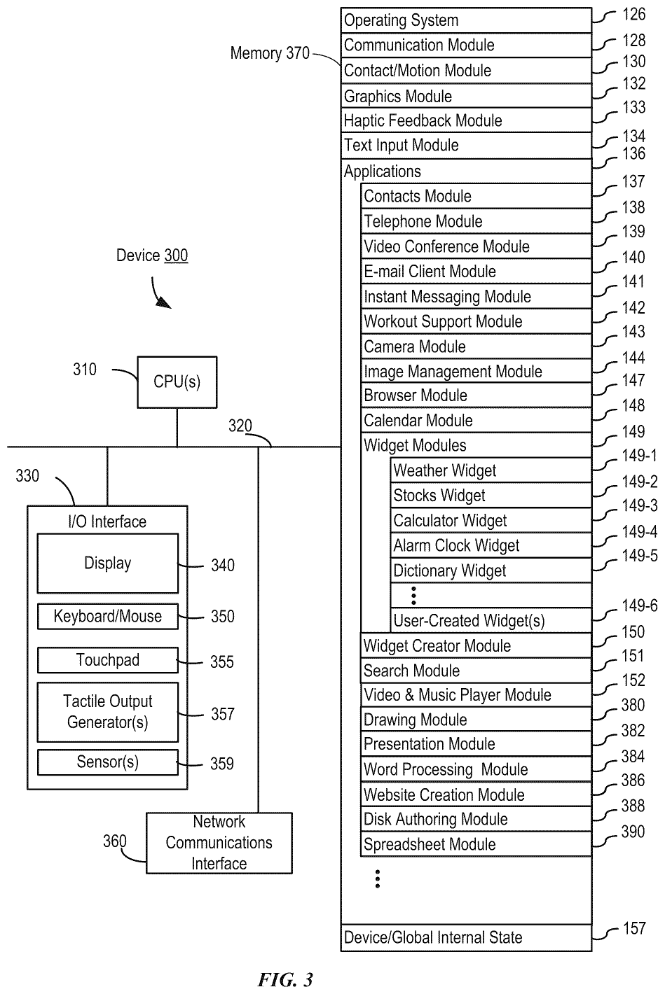

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

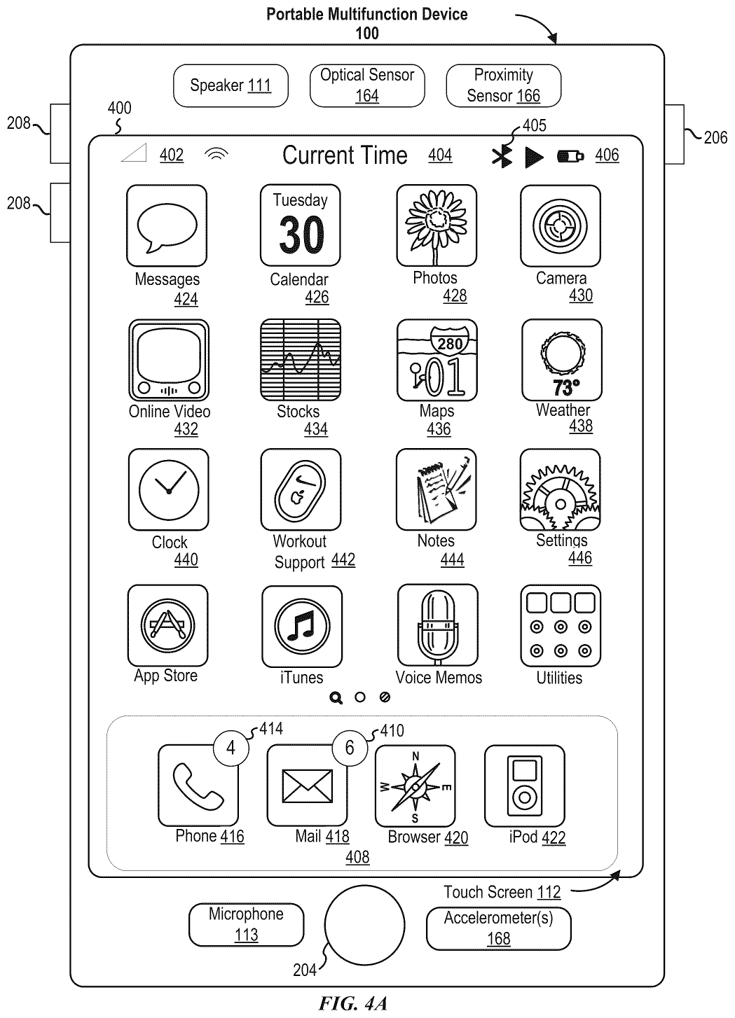

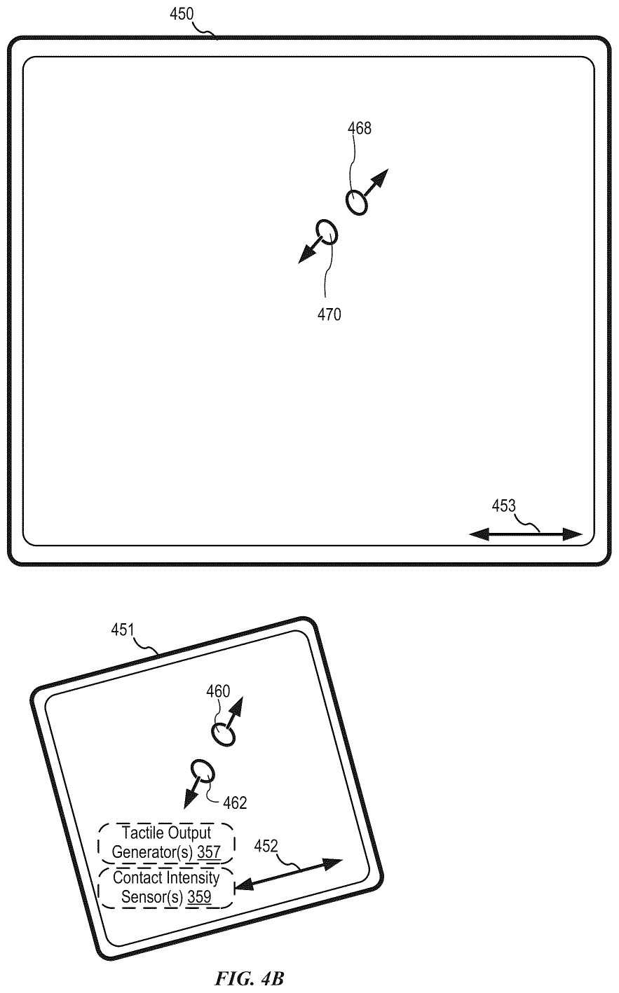

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

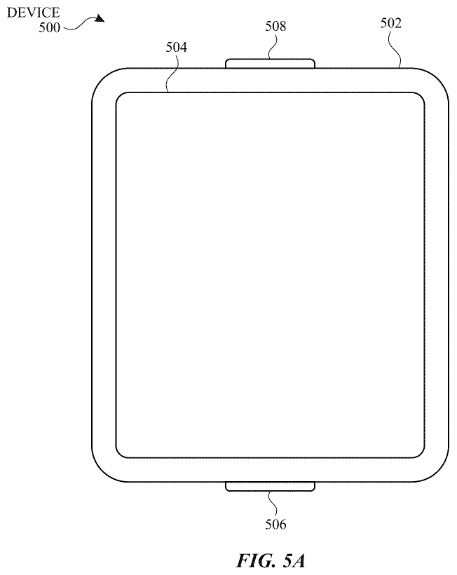

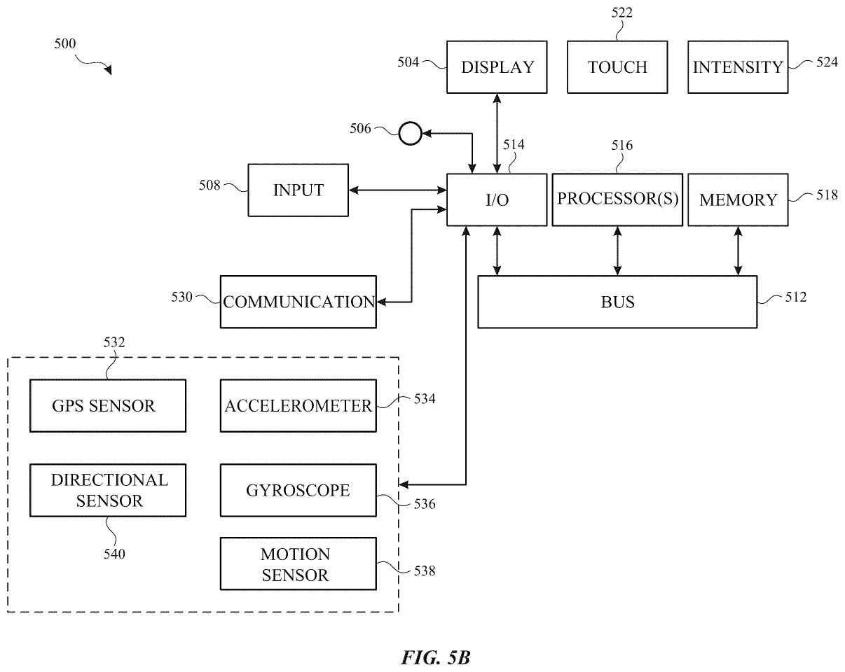

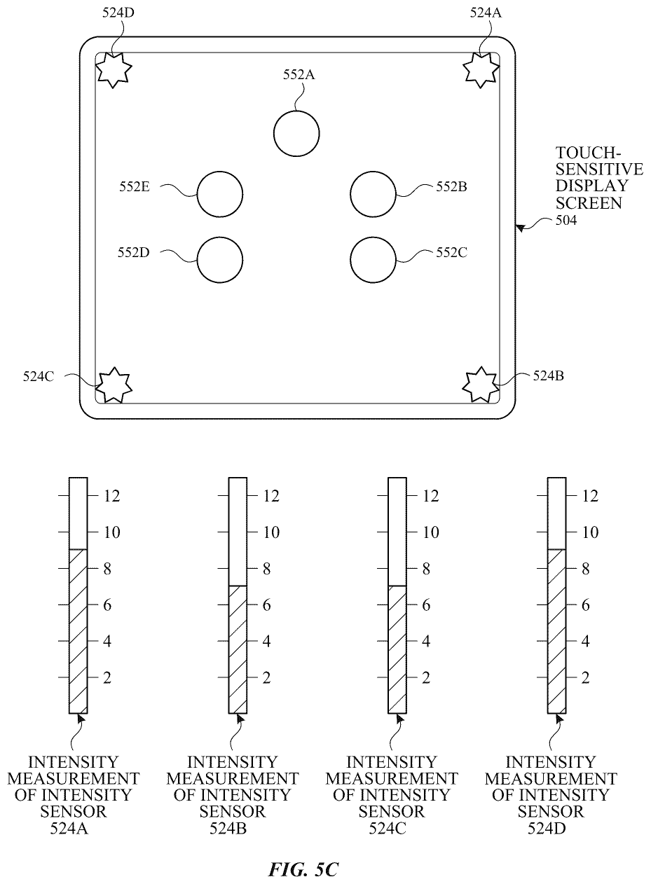

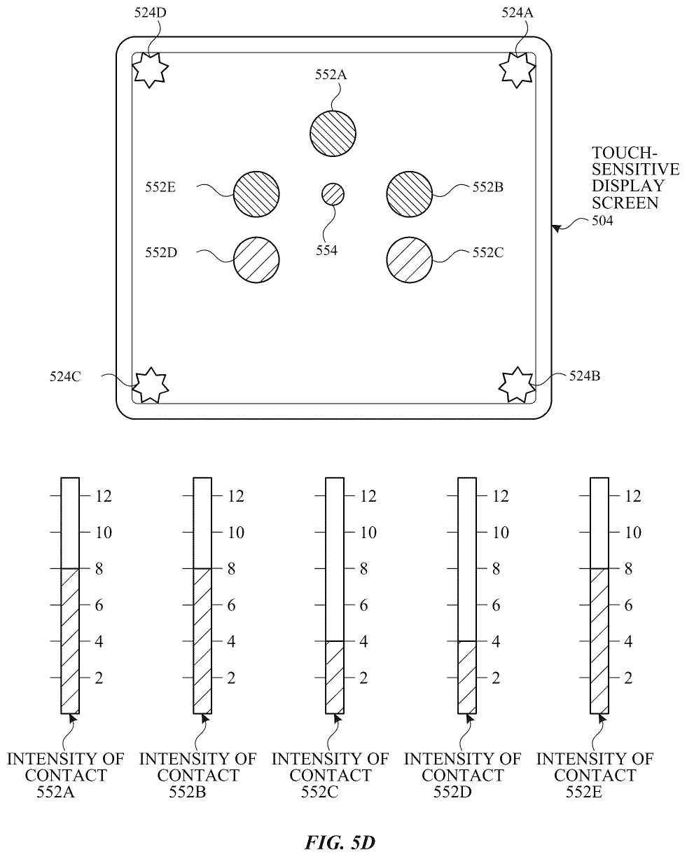

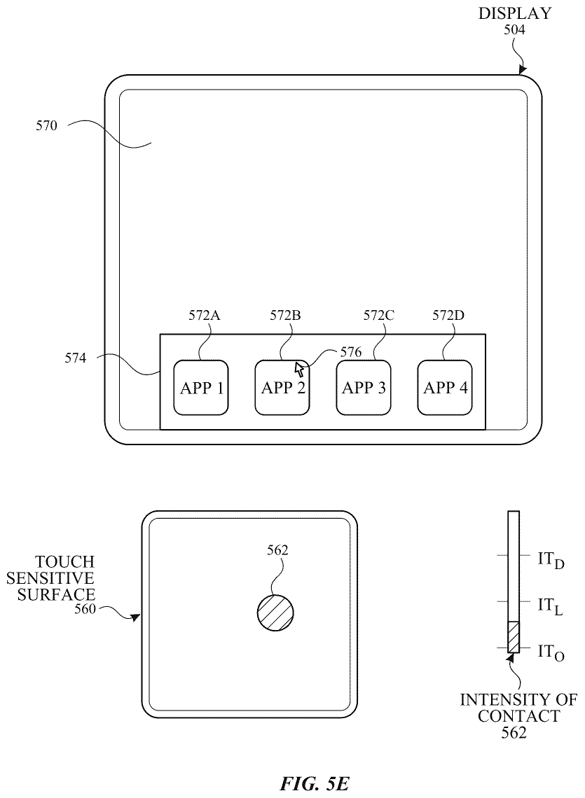

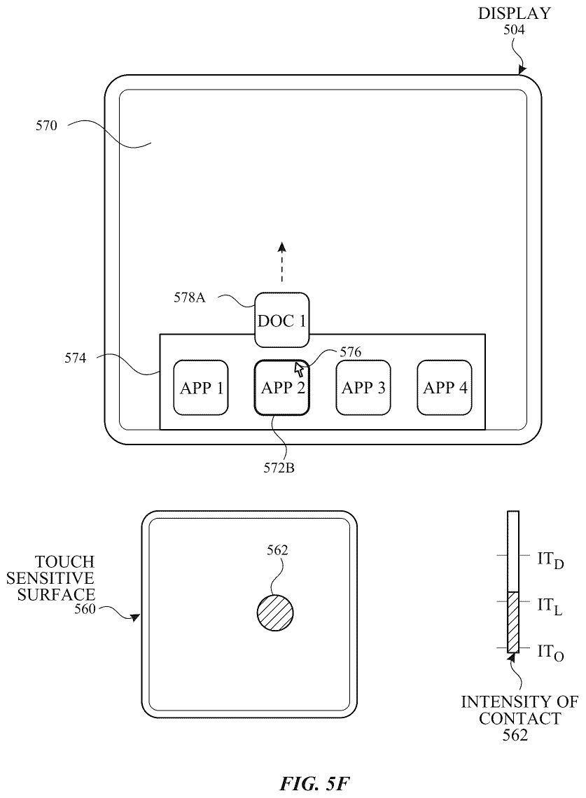

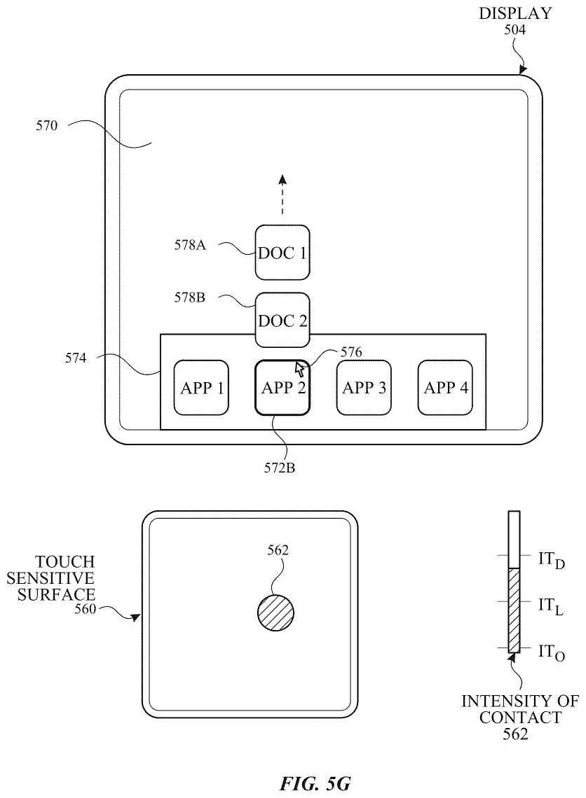

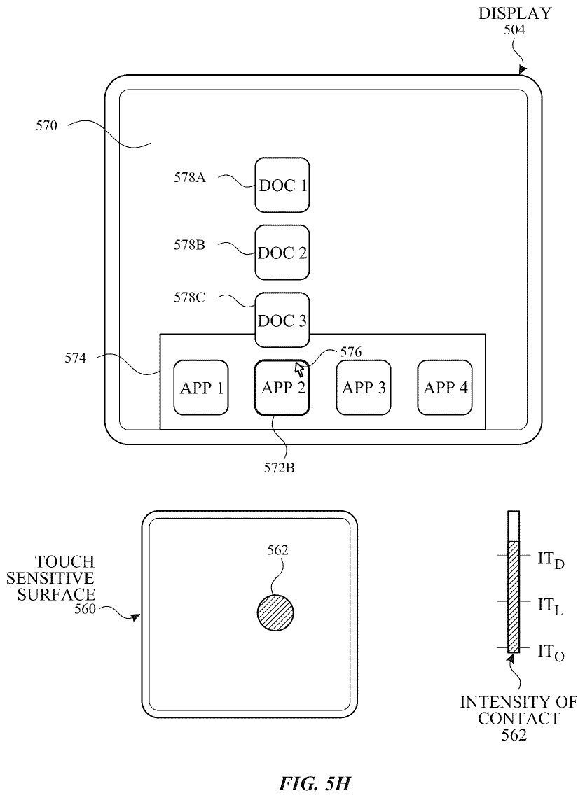

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to touch screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

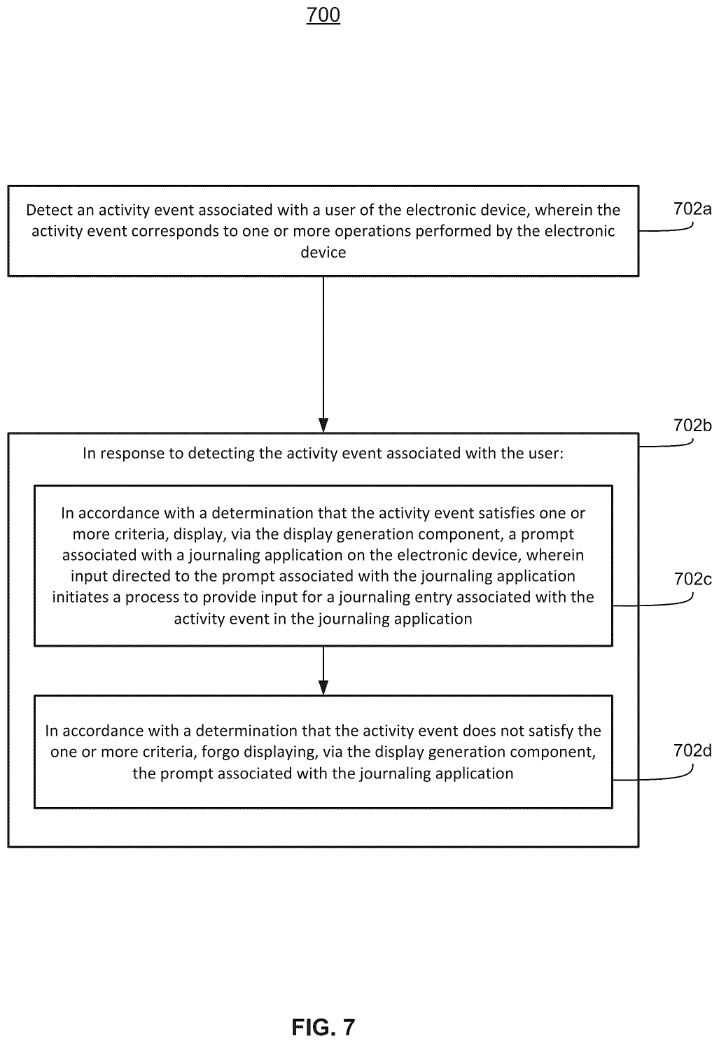

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700, 900, 1000, and/or 1200 (FIGS. 7, 9, 10, and 12). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

Table 1 below provides representative examples of tactile output/haptic feedback behaviors and configurations, and examples of their use with respect to the user interfaces for managing content-based tactile outputs that are illustrated and described herein.

TABLE 1

| | | Textural |
|---|---|---|
| Type of Tactile | | (continuous) or |
| Output Sequence | Waveform | Discrete |
| “Major” | MiniTap at 180 Hz | Discrete |
| “Minor” | MicroTap at 80 Hz | Textural |
| “Major-reduced” | MiniTap at 200 Hz | Discrete |
| “Minor-Reduced” | MicroTap at 200 Hz | Discrete |

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Prompting Users to Make Journaling Entries

Users interact with electronic devices in many different manners. The embodiments described below provide ways in which an electronic device displays prompts to a user that are selectable to initiate a process to create a journal entry, thus enhancing the user's interactions with the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

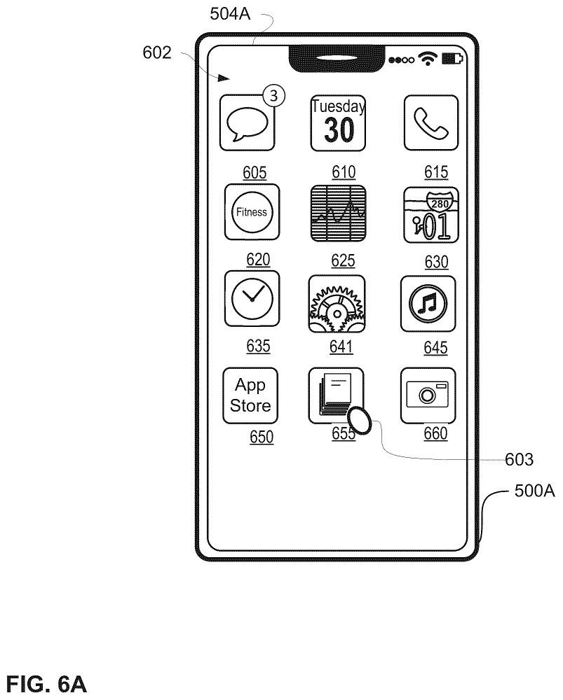

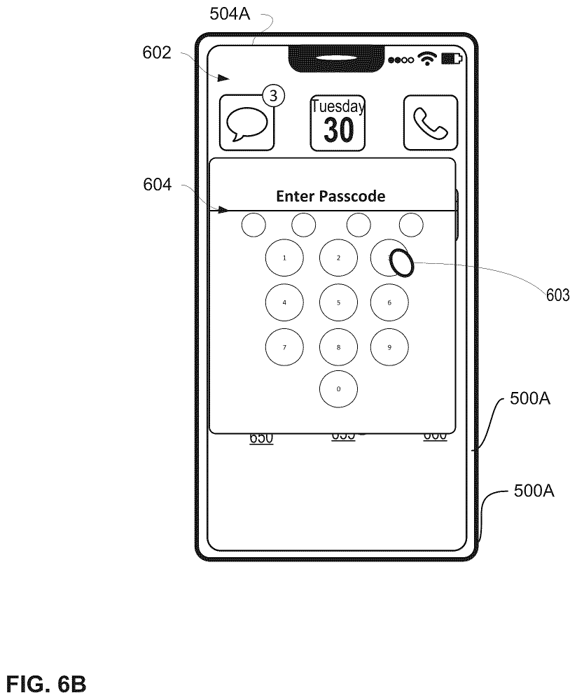

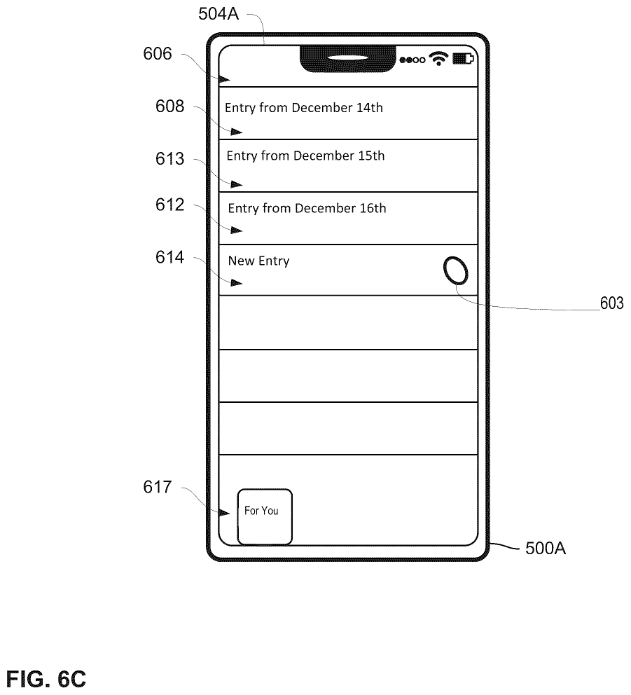

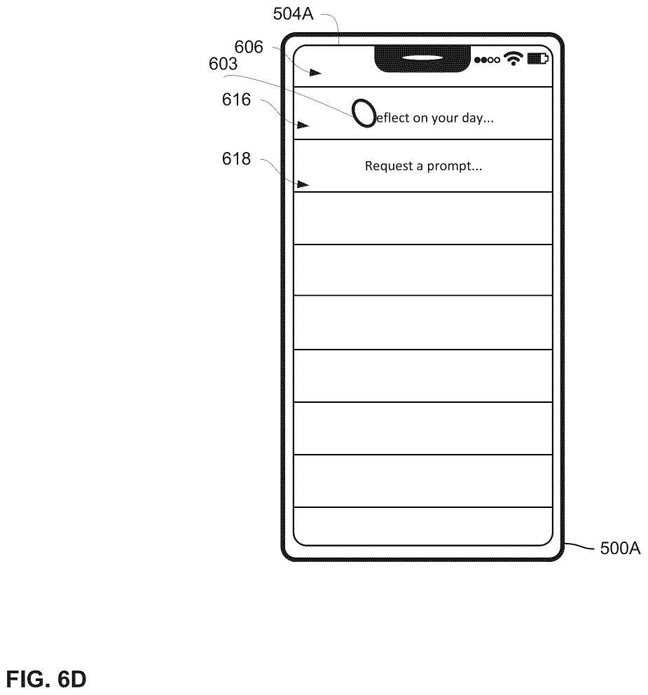

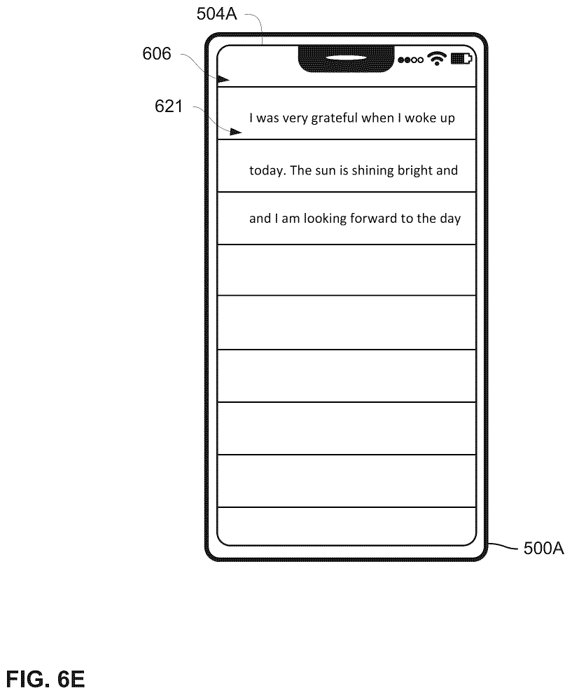

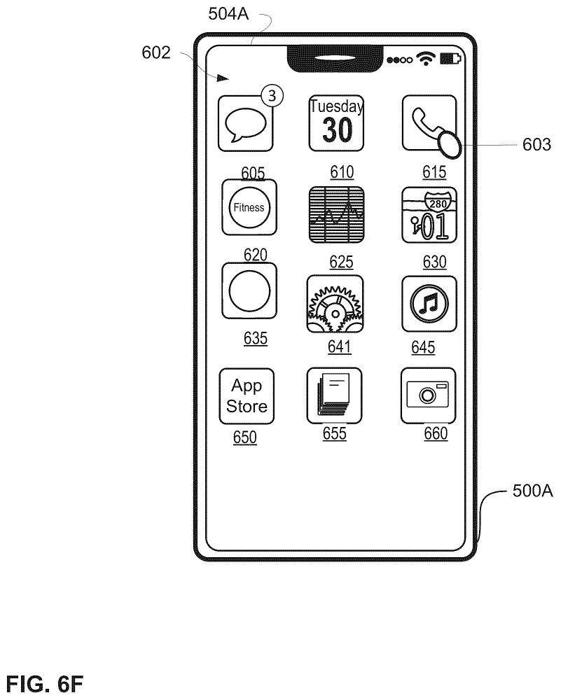

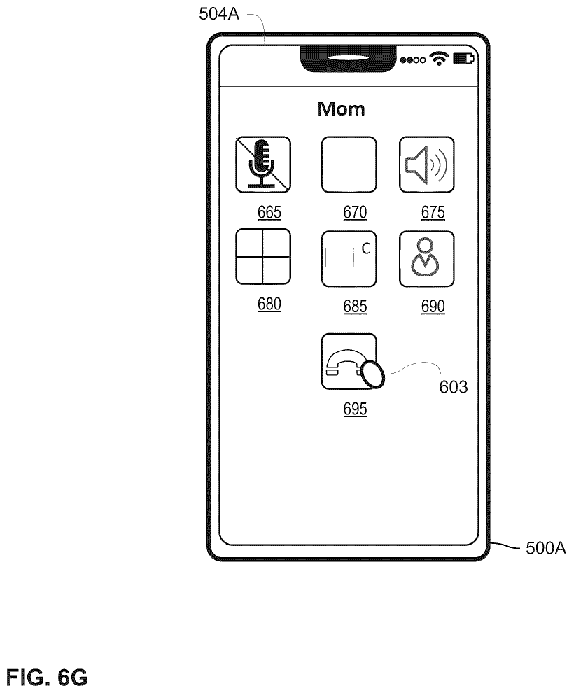

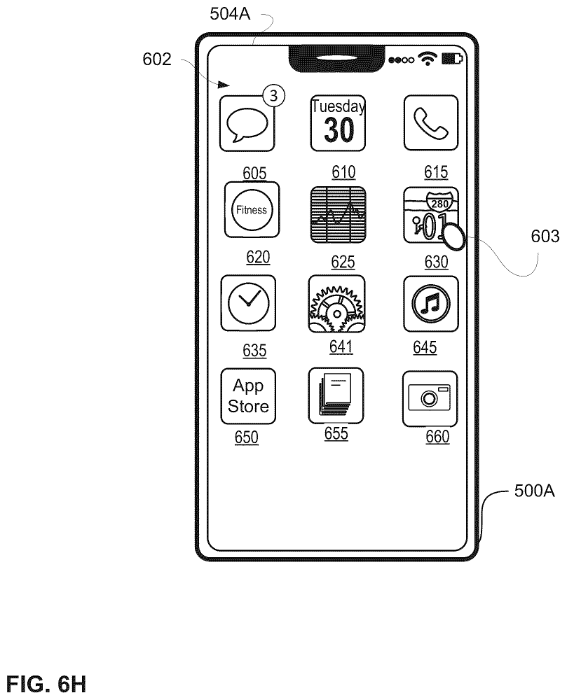

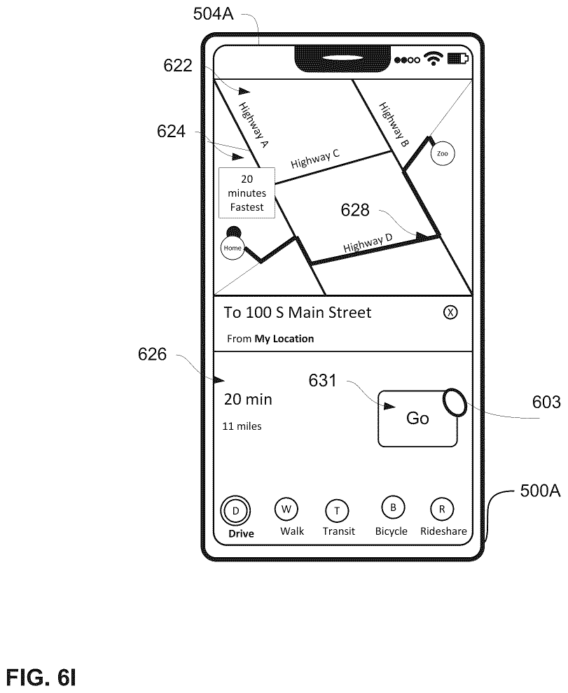

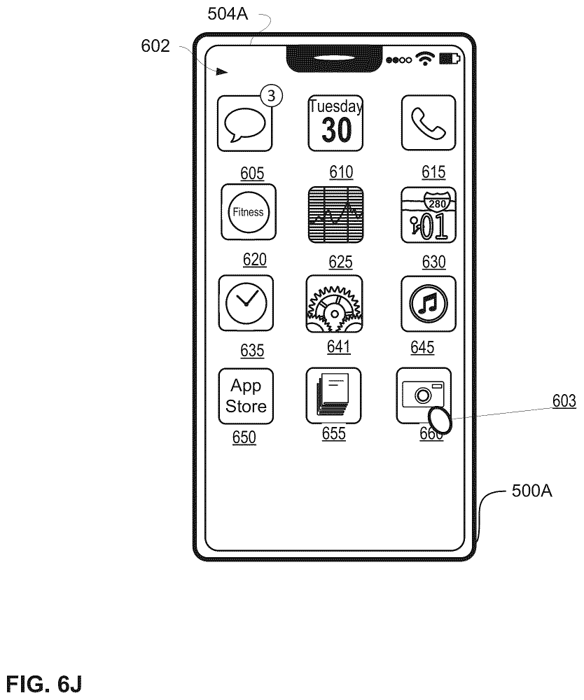

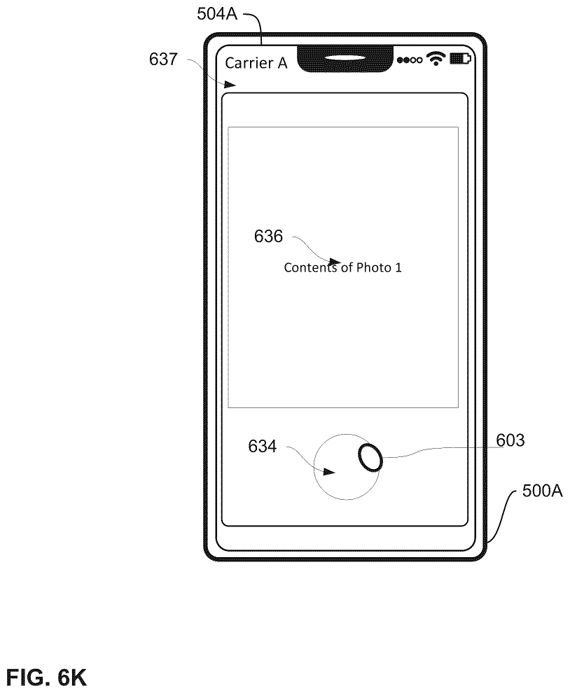

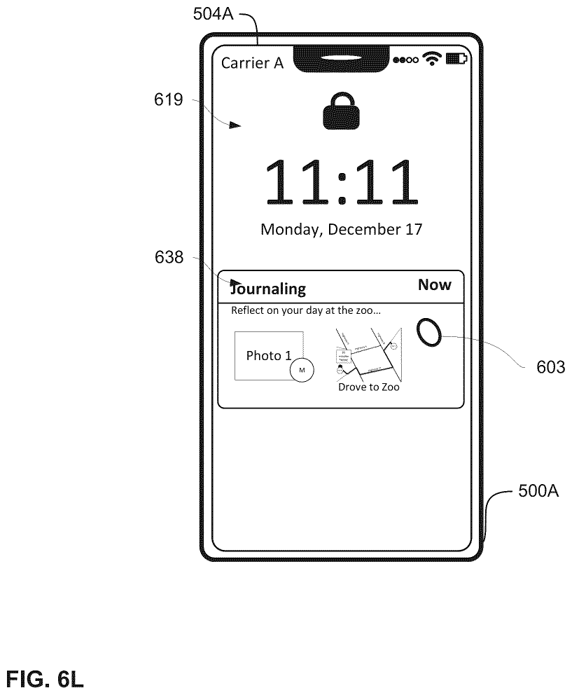

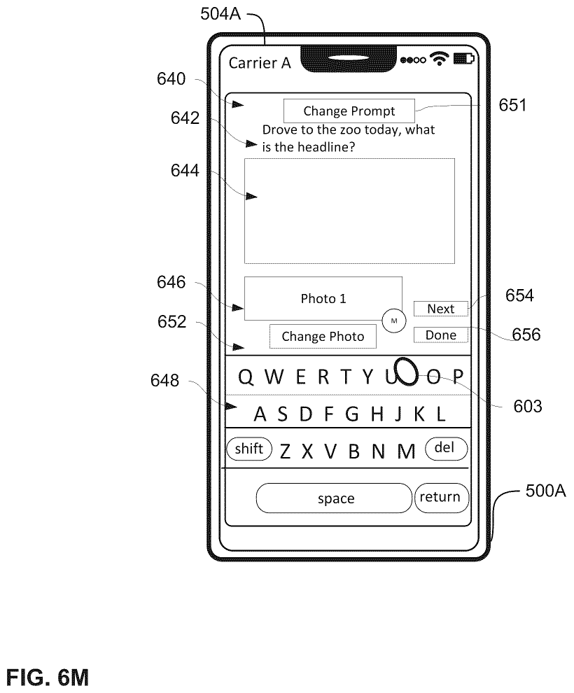

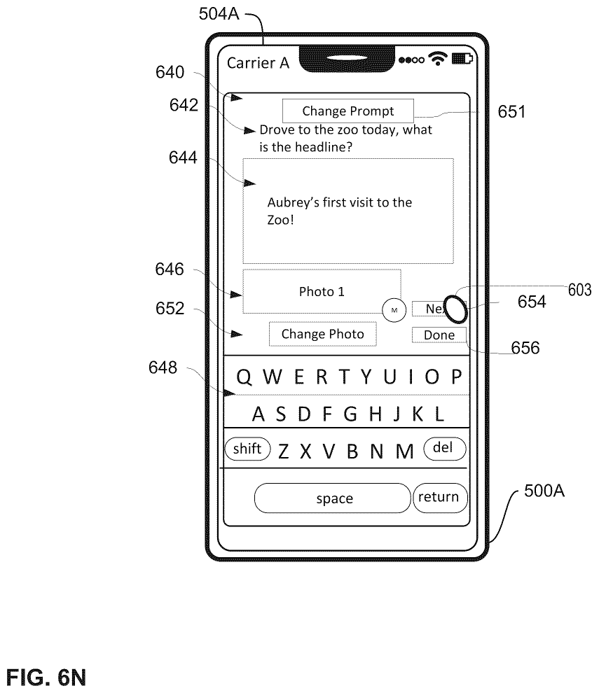

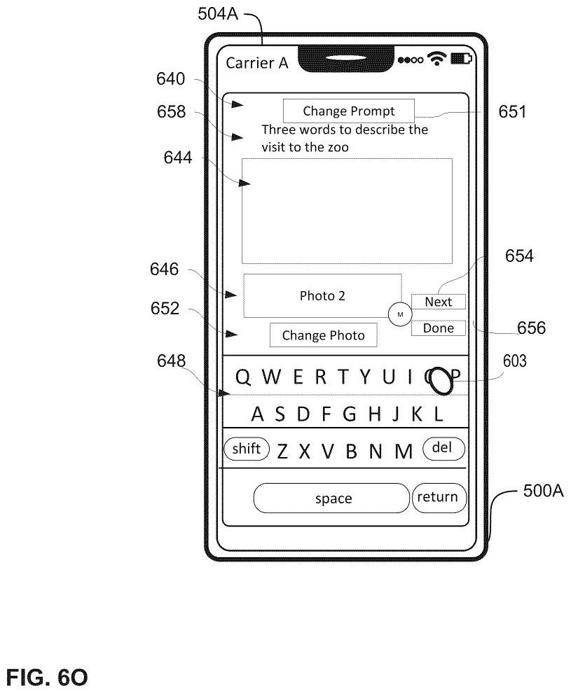

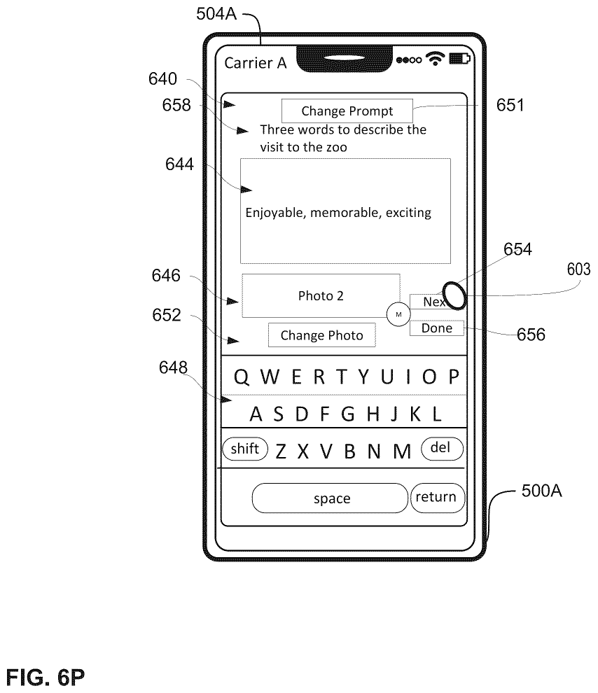

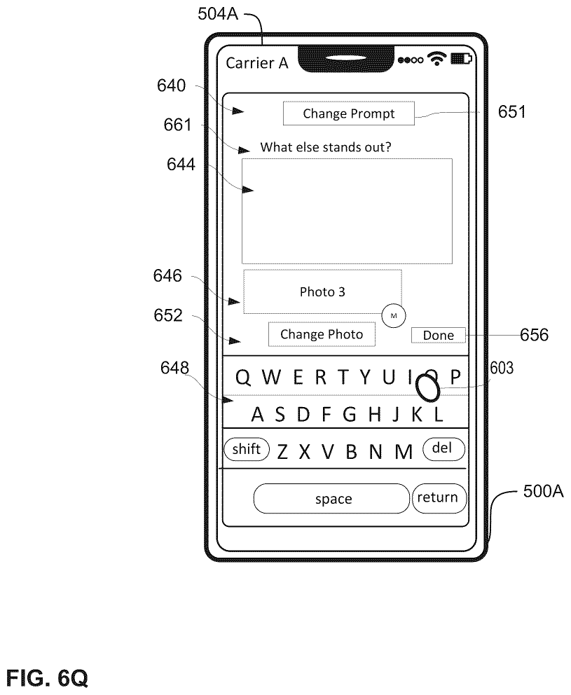

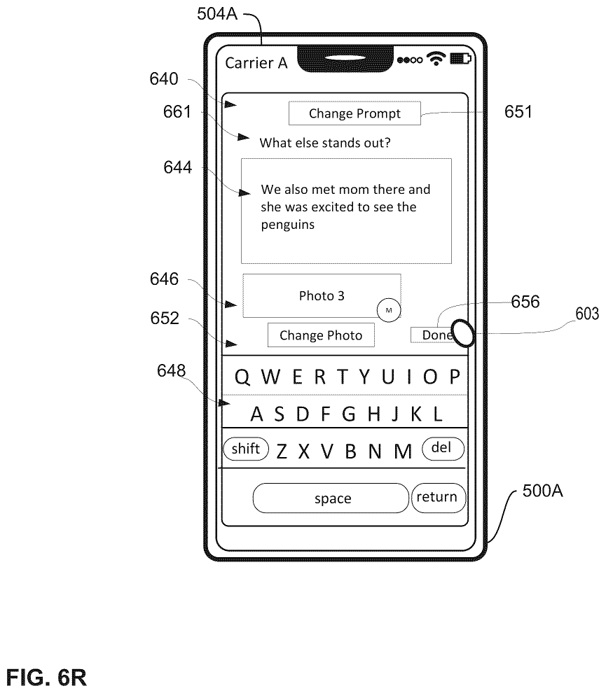

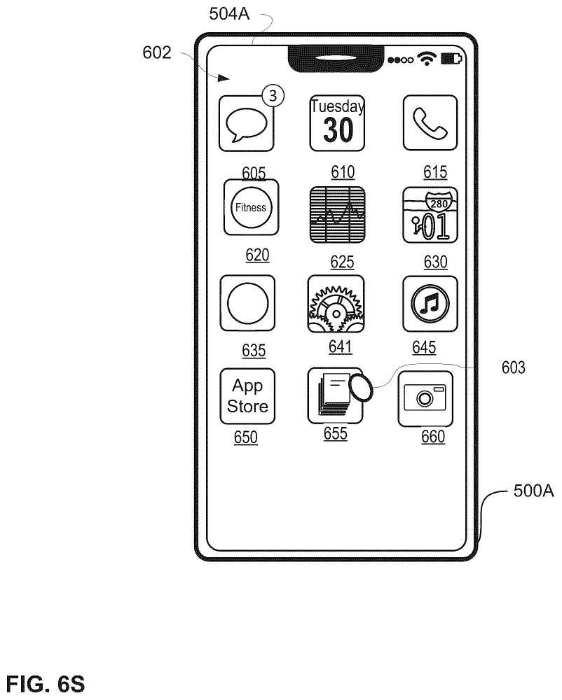

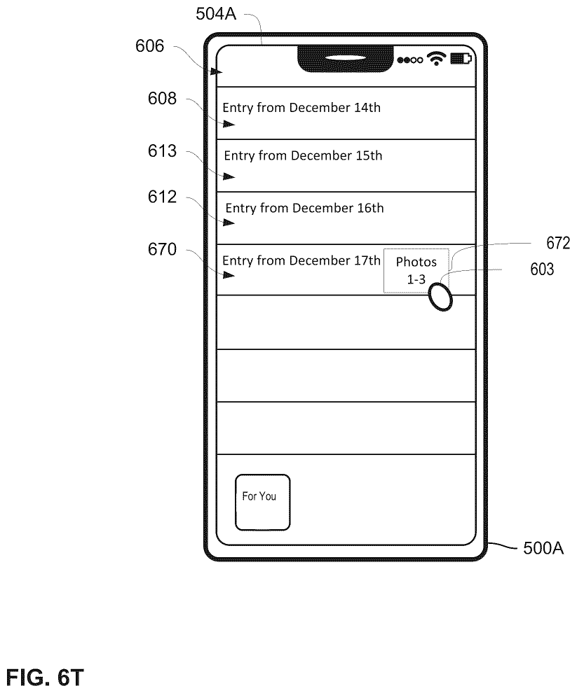

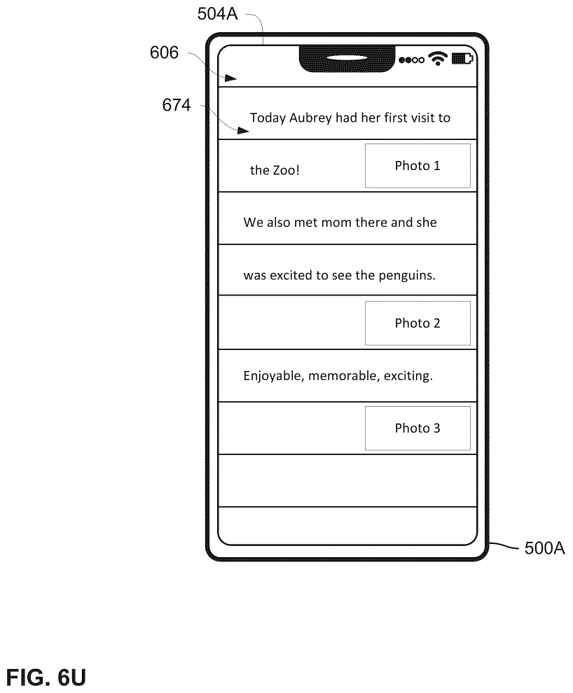

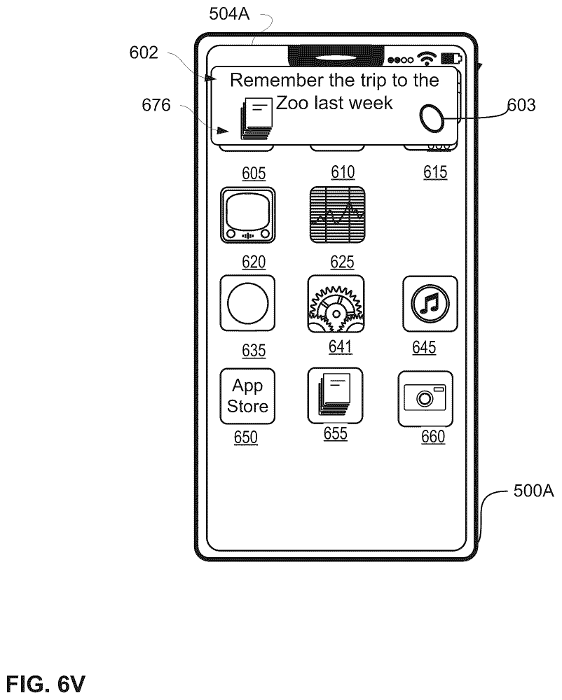

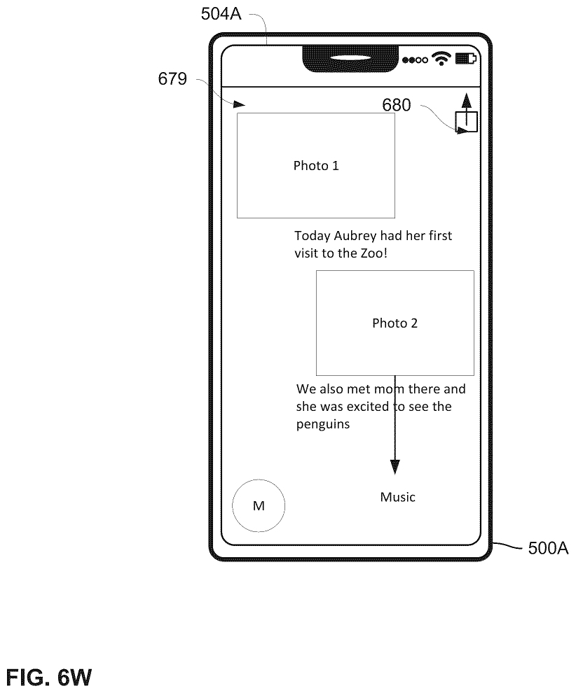

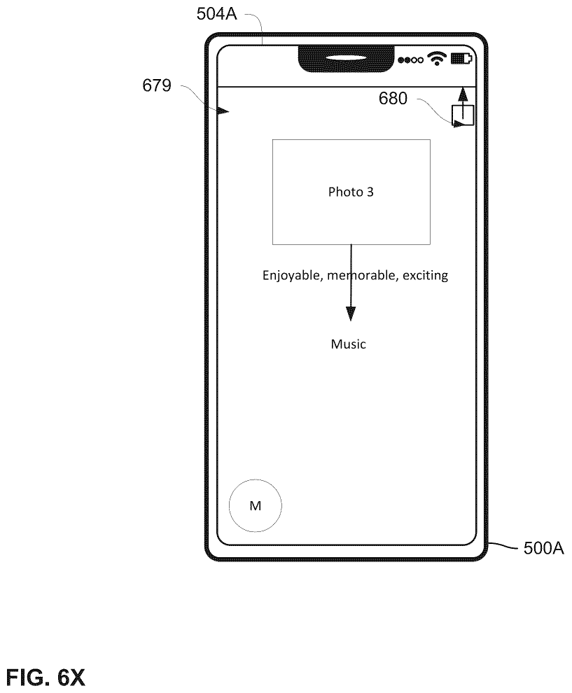

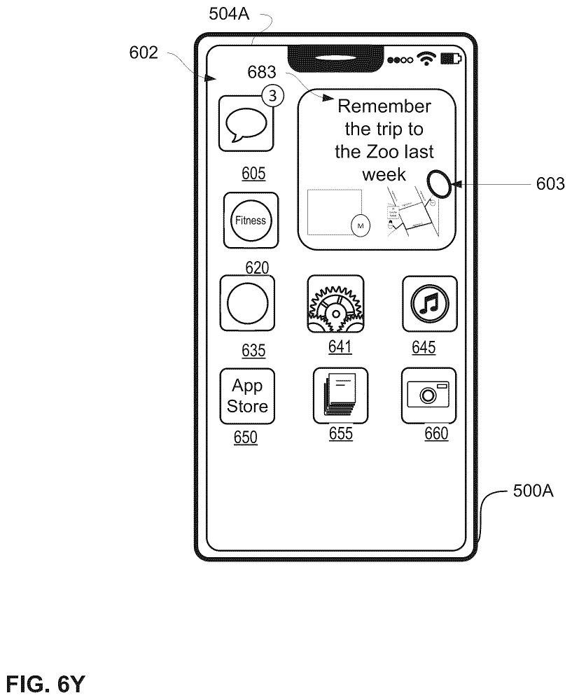

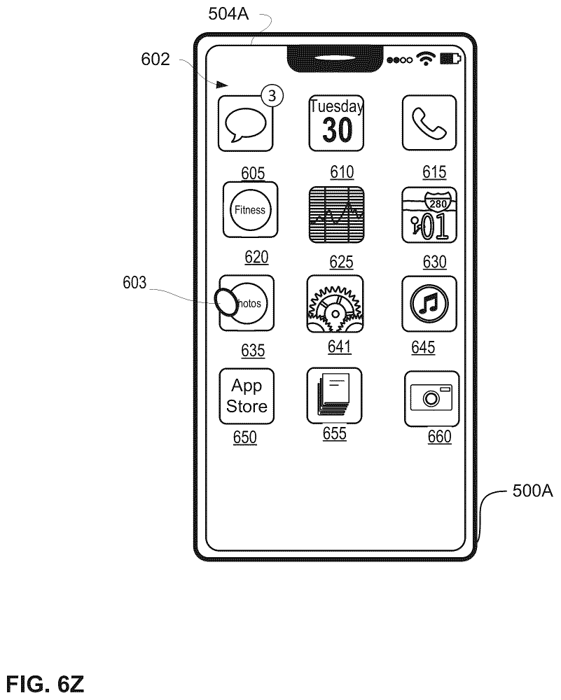

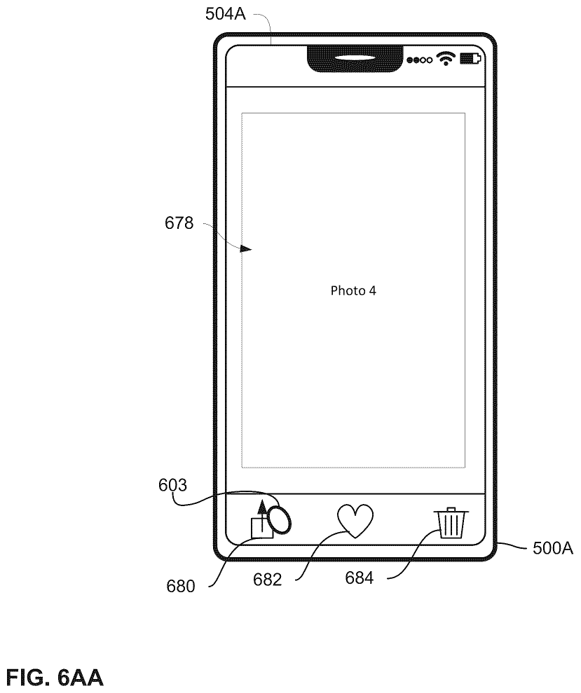

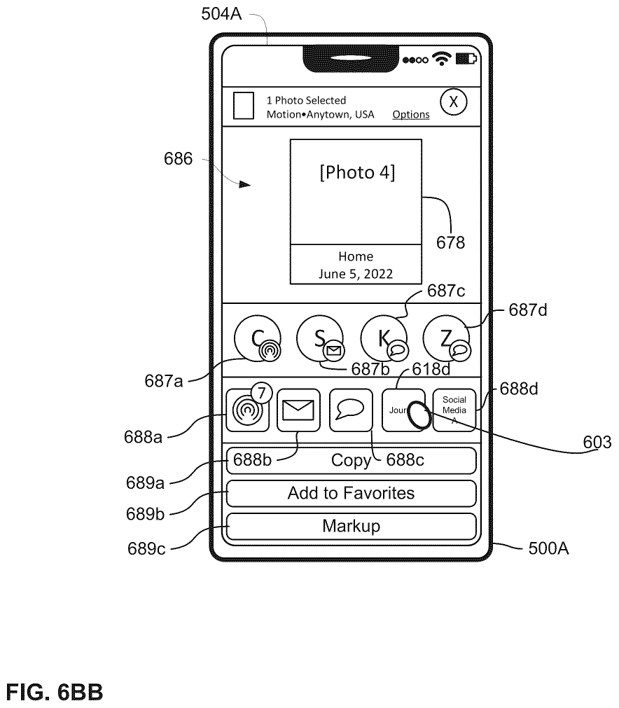

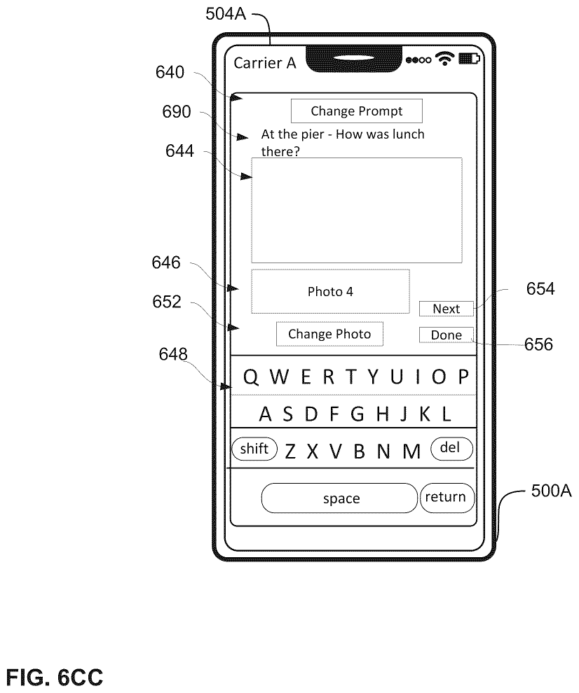

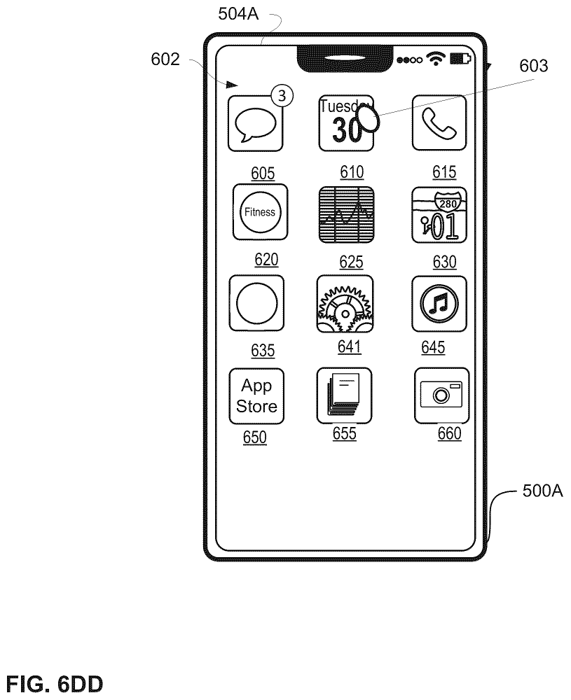

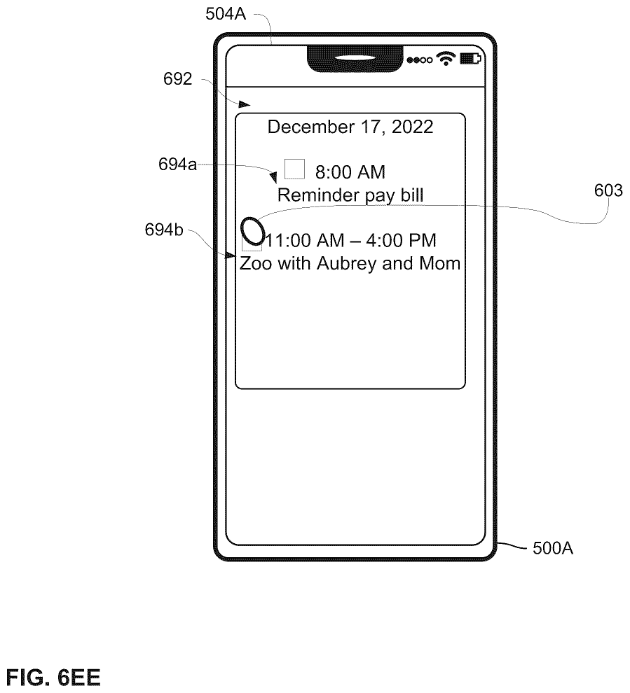

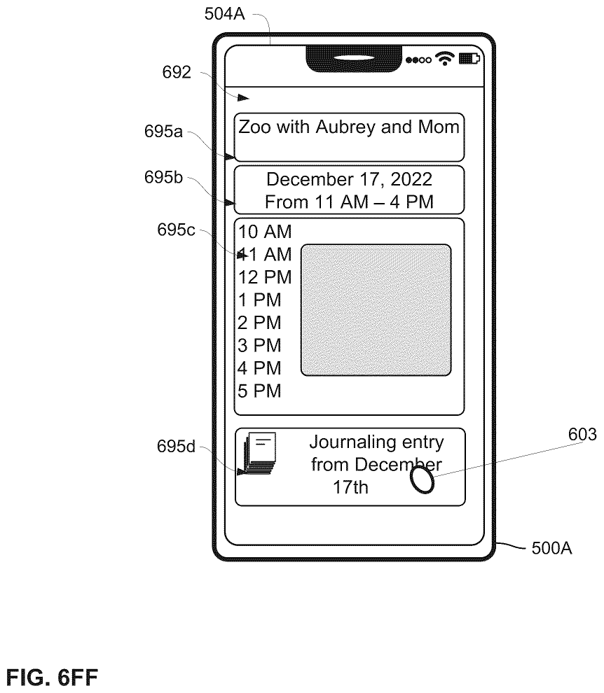

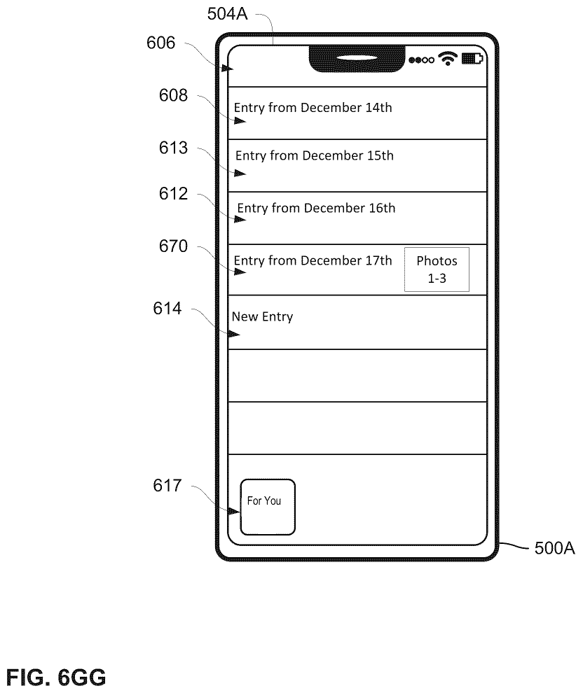

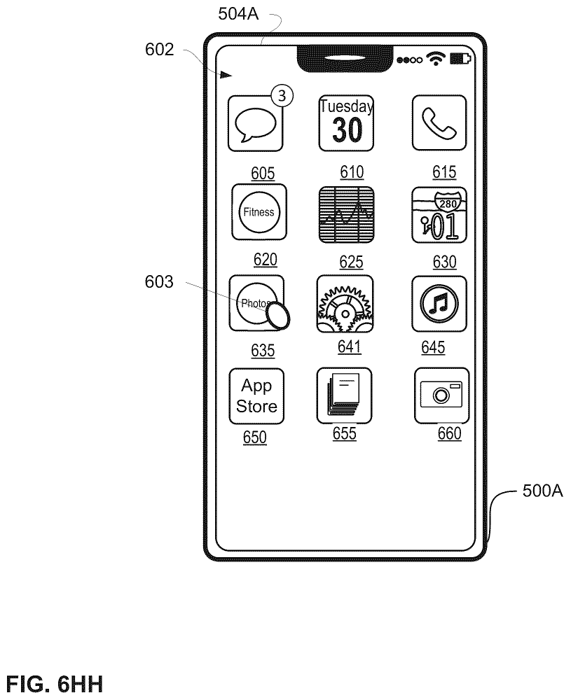

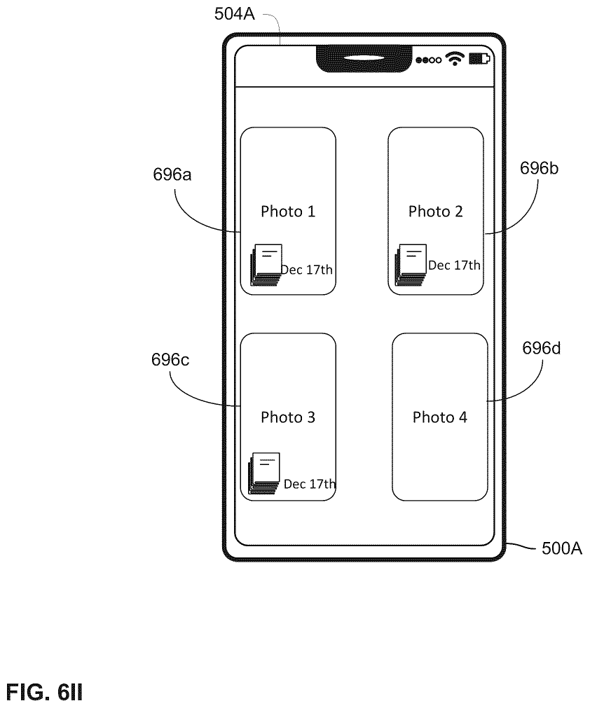

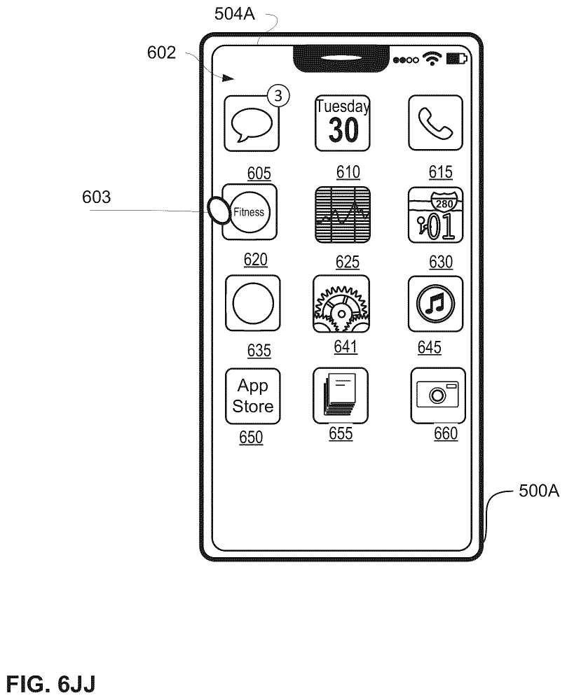

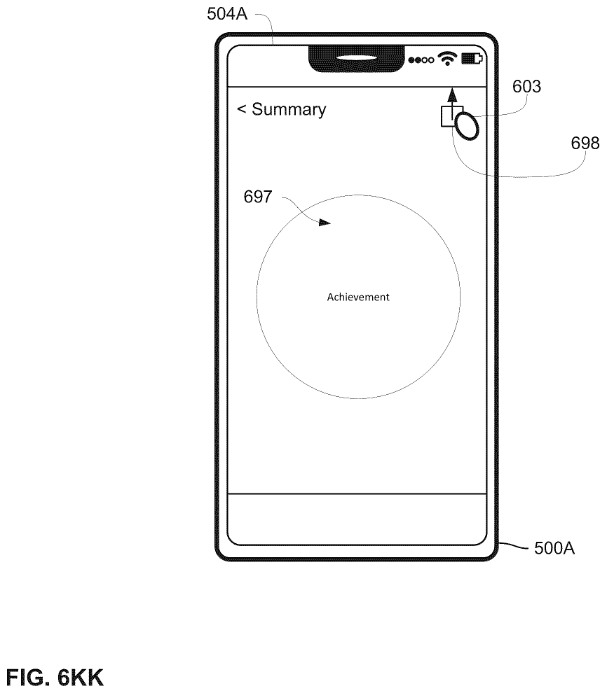

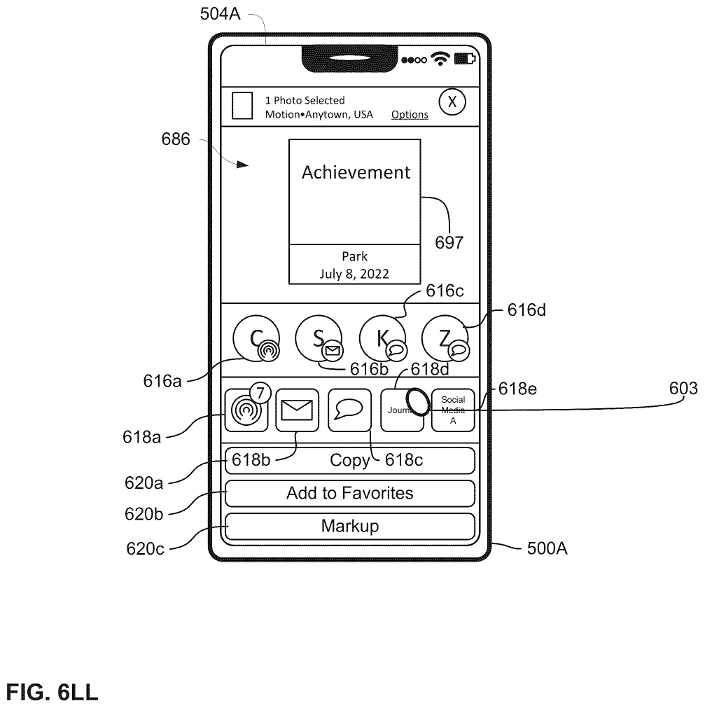

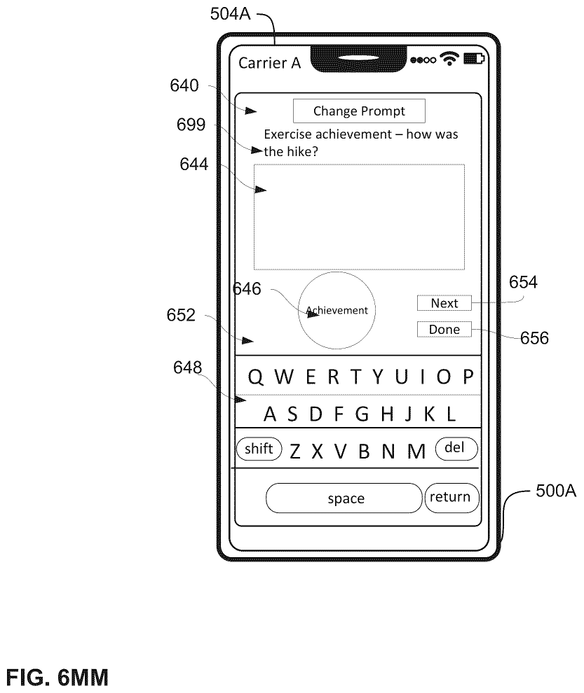

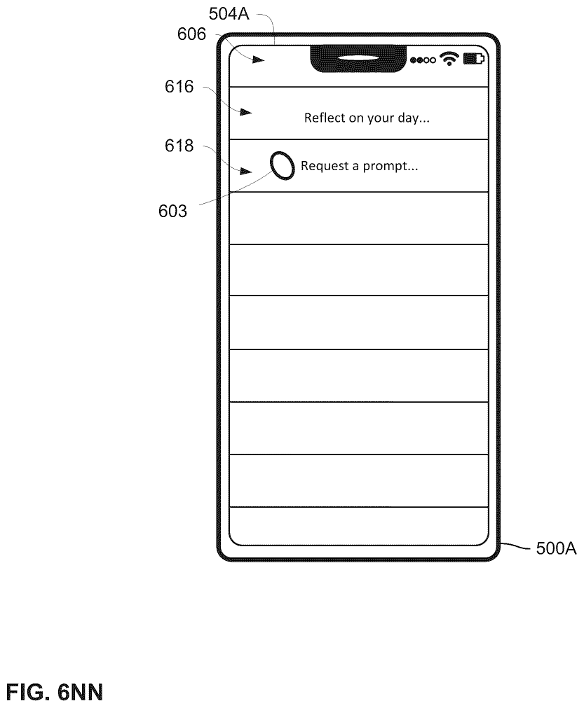

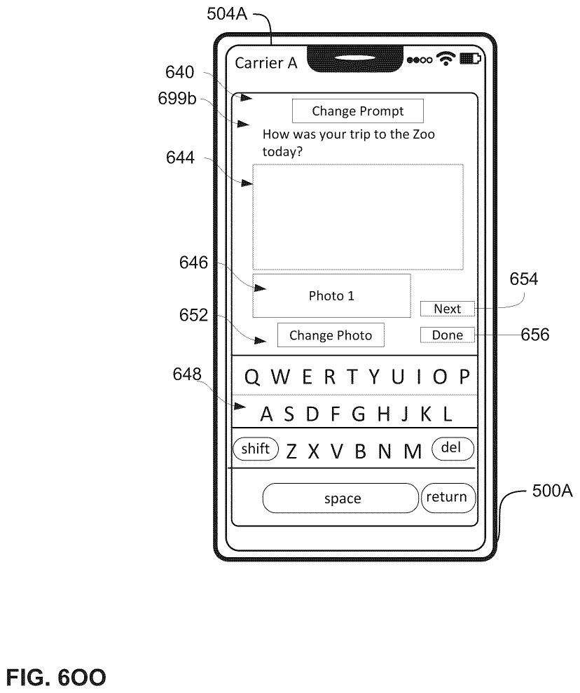

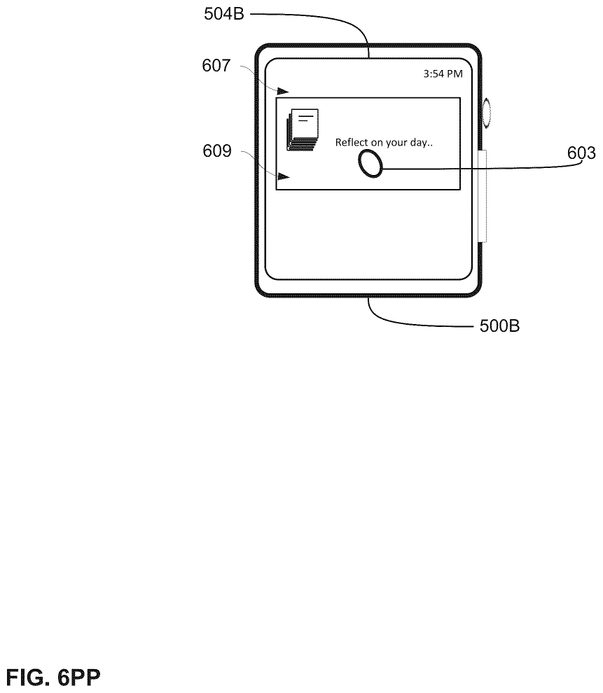

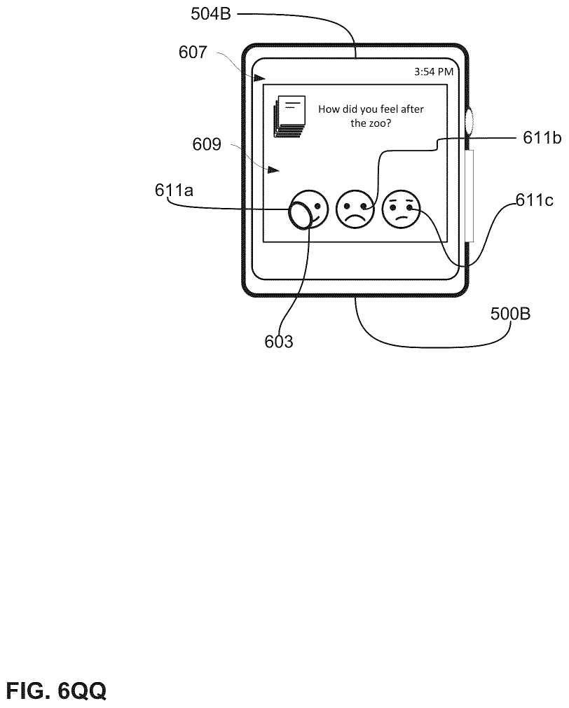

FIGS. 6A-6QQ illustrate exemplary ways of creating journaling entries in a journaling application in accordance with some embodiments of the disclosure. The embodiments in these figures are used to illustrate the processes described below, including the processes described with reference to FIG. 7.

FIG. 6A illustrates an exemplary device 500A that includes touch screen 504A (e.g., touch screen 504, display 112). In FIG. 6A, device 500A is displaying a user interface 602 including an application icon 605, an application icon 610, an application icon 615, an application icon 620, an application icon 625, an application icon 630, an application icon 635, an application icon 6411 an application icon 645, an application icon 650, an application icon 655, and an application icon 660. In some embodiments, user interface 602 is a home screen user interface of device 500A (e.g., as described with reference to FIG. 4A), and includes the different application icons selectable to display different applications as described above. Application icon 605 corresponds to a messaging application for initiating and maintaining messaging conversations. Application icon 610 corresponds to a calendar application for entering and managing a calendar. Application icon 615 corresponds to a calling application for initiating phone calls. Application icon 620 corresponds to a fitness application for maintaining fitness information. Application icon 625 corresponds to a stock application for monitoring stock activity. Application icon 630 corresponds to a map application for searching maps as well as generating and following routes. Application icon 635 corresponds to a clock application for displaying the time in one or more locations. Application icon 641 corresponds to a settings application for maintaining configurations of device 500. Application icon 645 corresponds to a music application for accessing, downloading, and playing music. Application icon 650 corresponds to a store application for purchasing additional applications. Application icon 655 corresponds to a journaling application for creating and accessing journaling entries. Application icon 660 corresponds to a camera application for taking photos.

In FIG. 6A, device 500A detects selection of application icon 655 (e.g., via contact 603). In response, in FIG. 6B, device 500A displays an authentication user interface 604 and only allows entry to the journaling application upon receiving authentication input (e.g., biometric, PIN, passcode or other authentication) that is successfully authenticated and will not display the journaling application if the authentication input is not successfully authenticated.

In FIG. 6B, device 500A detects an authentication input to authentication user interface 604 that is successfully authenticated (e.g., via contact 603). In response, in FIG. 6C, device 500A displays a user interface 606 of the journaling application that includes representations of journaling entries 608-612 that have already been created in the journaling application, and selectable option 614. Representation of journaling entry 608 corresponds to a journaling entry from December 14th. Representation of journaling entry 613 corresponds to a journaling entry from December 15th. Representation of journaling entry 612 corresponds to a journaling entry from December 16th. Selectable option 614 is selectable to initiate a process to add a new journaling entry to the journaling application. Selectable option 617 is selectable to initiate a process to view one or more animated video presentations that are related to activity events and/or journaling entries, discussed in more detail hereinafter.

In FIG. 6C, device 500A detects selection of selectable option 614 (e.g., via contact 603). In response, in FIG. 6D, device 500A updates user interface 606 to display selectable options 616 and 618. Selectable option 616 is selectable to initiate a process to manually create a journaling entry. Selectable option 618 is selectable to request a prompt from device 500A to facilitate creation of a journaling entry.

In FIG. 6D, device 500A detects selection of selectable option 616 (e.g., via contact 603) and one or more inputs to enter content into the journaling entry. In response, in FIG. 6E, device 500A updates user interface 606 to display journaling entry 621, including the content manually provided by a user to device 500A (e.g., via manual soft keyboard entry and/or manual voice entry).

In some embodiments, rather than requiring manual creation of journaling entries, device 500A facilitates creation of journaling entries by automatically (e.g., without user input for doing so) displaying one or more prompts that facilitate the creation of journaling entries based on activities detected by device 500A, as will be described with reference to FIGS. 6F-6R. For example, FIG. 6F represents an additional exemplary way of creating a journaling entry at device 500A. In FIG. 6F, device 500A detects selection of application icon 615 (e.g., via contact 603). In response, in FIG. 6G, and upon device 500A detecting one or more additional inputs, device 500 initiates a call via the calling application to the user's “Mom.”

In FIG. 6G, device 500A detects selection of selectable option 695 (e.g., via contact 603). In response, in FIG. 6H, device 500A ends the call with “Mom” and returns to displaying user interface 602. Thus, device 500A detects that the user of device 500A has had a call with “Mom.”

In FIG. 6H, device 500A detects selection of application icon 630 (e.g., via contact 603). In response, in FIG. 6I, device 500A displays user interface 622 of the map application that includes a first portion 624 that includes a representation of a map and a second portion 626 that includes a user interface element for searching and displaying routes. First portion 624 includes a visual indication of a route 628, and second portion 626 includes selectable button 631 that is selectable to initiate navigation directions along the route.

In FIG. 6I, device 500A detects selection of selectable button 631 (e.g., via contact 603) and initiates navigation directions along route 628 (not shown) and subsequently returns to displaying user interface 602, as shown in FIG. 6J. Thus, device 500A detects that the user of device 500A has traveled along route 628.

In FIG. 6J, device 500A detects selection of application icon 660 (e.g., via contact 603). In response, in FIG. 6K, device 500A displays user interface 637 of the photo application. User interface 637 includes user selectable button 634 that is selectable to take photos, such as of the contents of photo preview 636 (e.g., corresponding to images currently being captured by one or more cameras of device 500a).

In FIG. 6K, device 500A detects selection of user selectable button 634 (e.g., via contact 603). In response, device 500A takes photo 1 (not shown) and upon detection of additional inputs, returns to displaying user interface 602, as shown in FIG. 6L. Thus, device 500A detects that the user of device 500A has taken photo 1.

As described in more detail with reference to method 700, device 500A optionally tracks various activities performed by device 500A (e.g., such as activities described above), and determines whether those activities satisfy criteria for generating and displaying a prompt for facilitating the creation of a journaling entry that is based on those activities. For example, in FIG. 6L, after the various activities described previously have been performed, and upon determining that those activities satisfy one or more criteria to facilitate the generation of a prompt, device 500A displays a prompt 638 on the lock screen 619 of device 500A. Device 500A optionally displays prompt 638 on any of a number of user interfaces displayed by device 500A, such as the lock screen user interface, the user interface of an application, or any other user interface currently being displayed by device 500A when device 500A determines to display prompt 638. A user can also be prompted on any number of personal or communal devices, including tablet, phone, smartwatch, TV, speaker, or other devices in a connected ecosystem. Prompt 638 indicates that it is related to the journaling application and includes details regarding the activity event of going to the zoo. Prompt 638 includes a description of where the user went (e.g., route to zoo) and a photo the user took as part of the activities (e.g., photo 1). Prompt 638 is selectable to initiate a process to create a journaling entry in the journaling application.

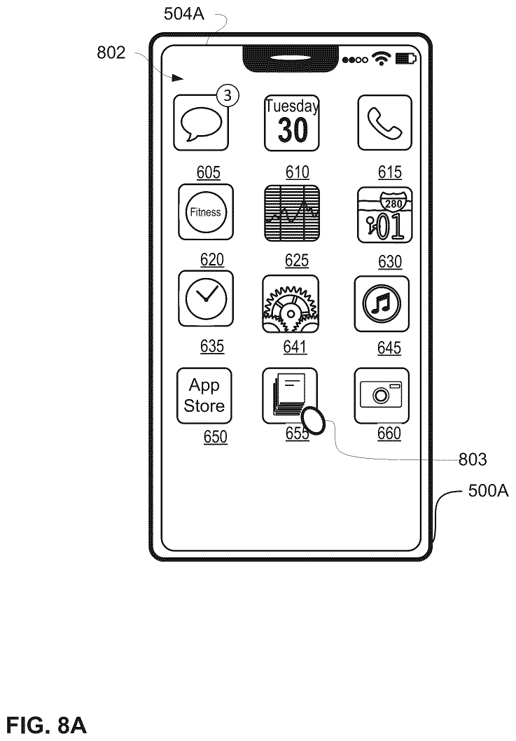

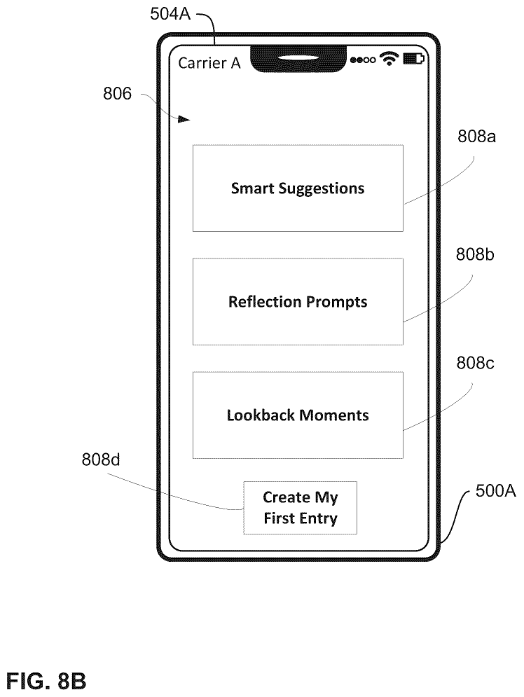

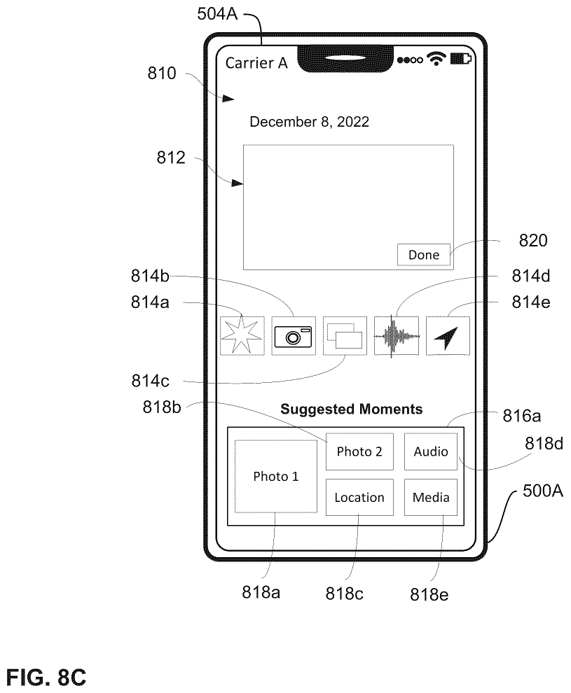

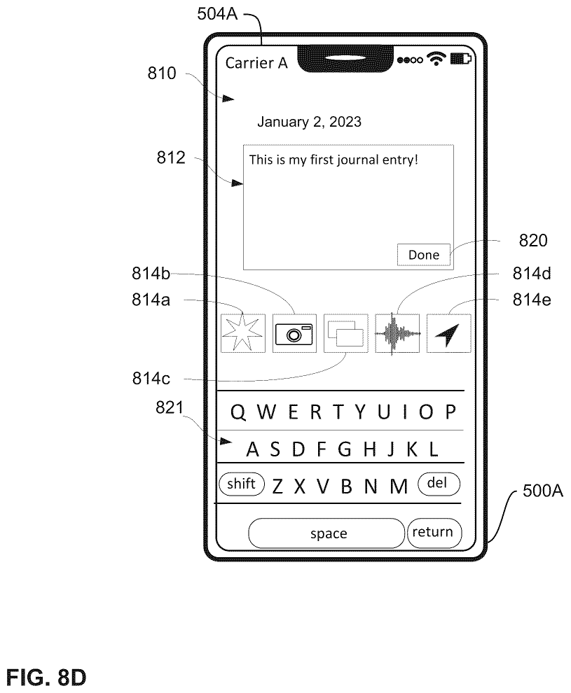

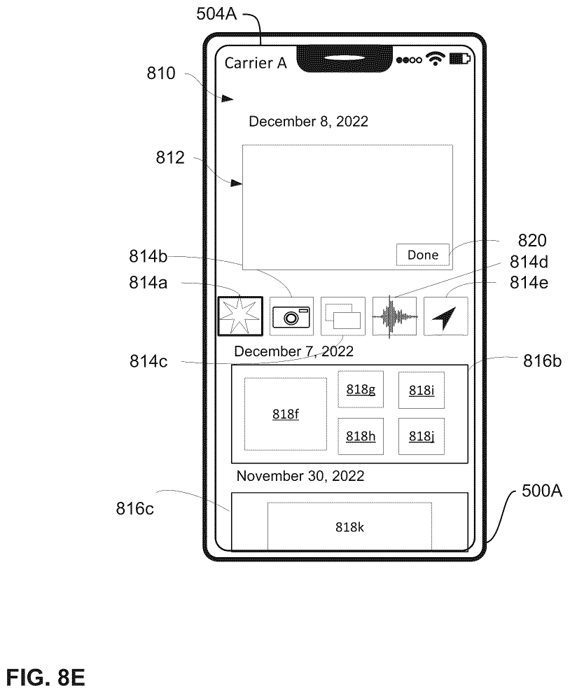

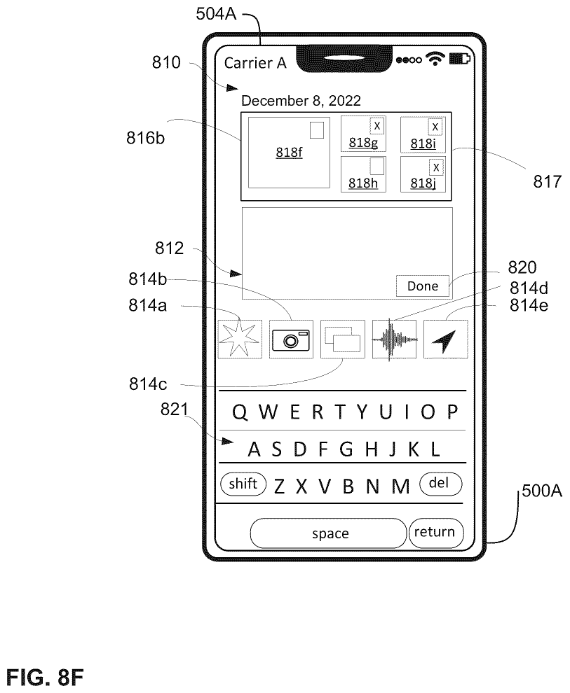

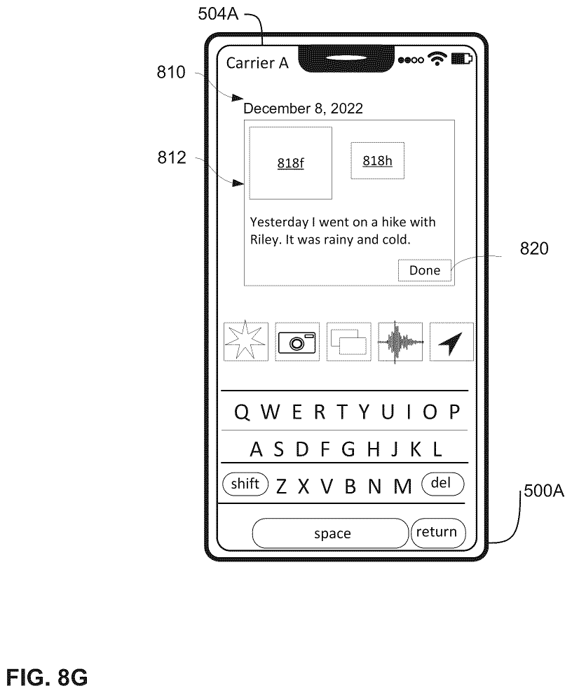

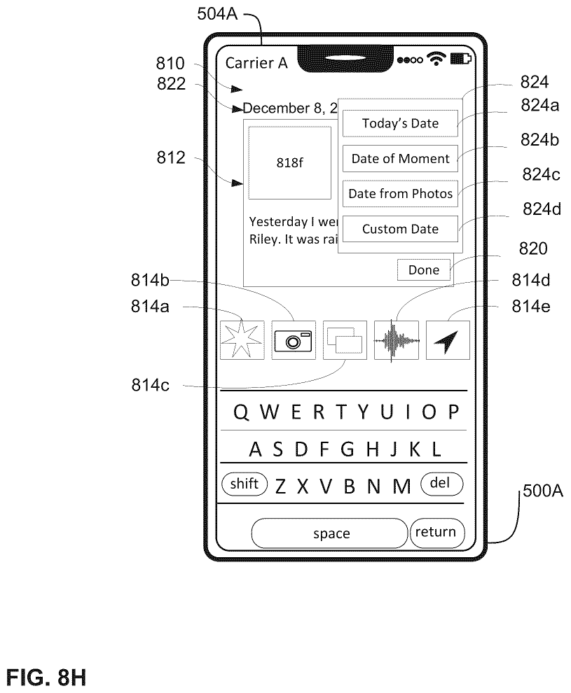

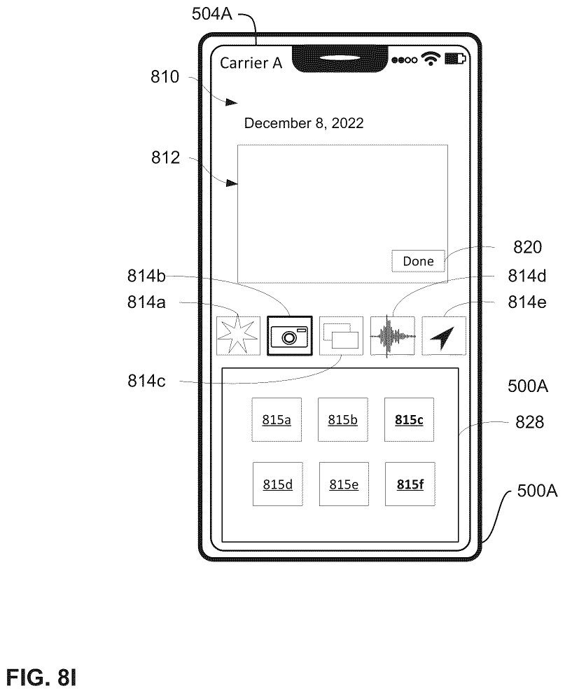

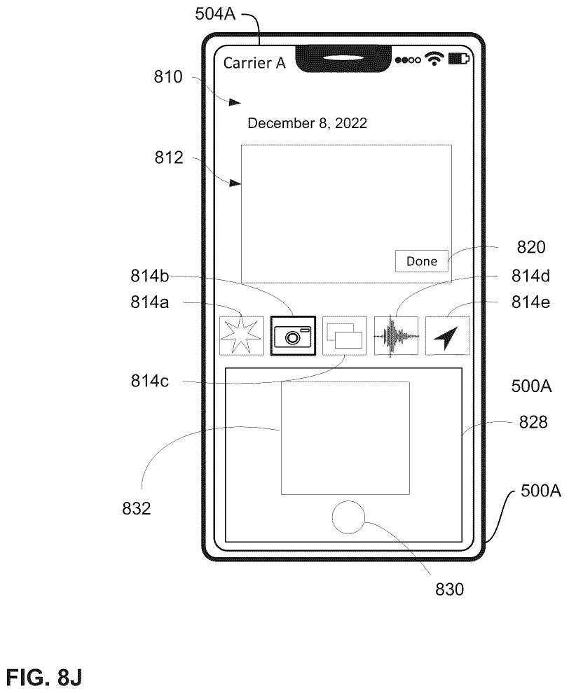

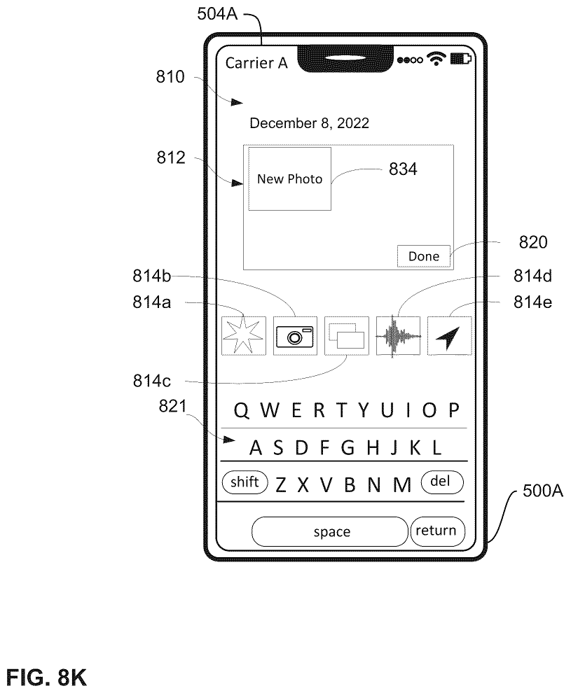

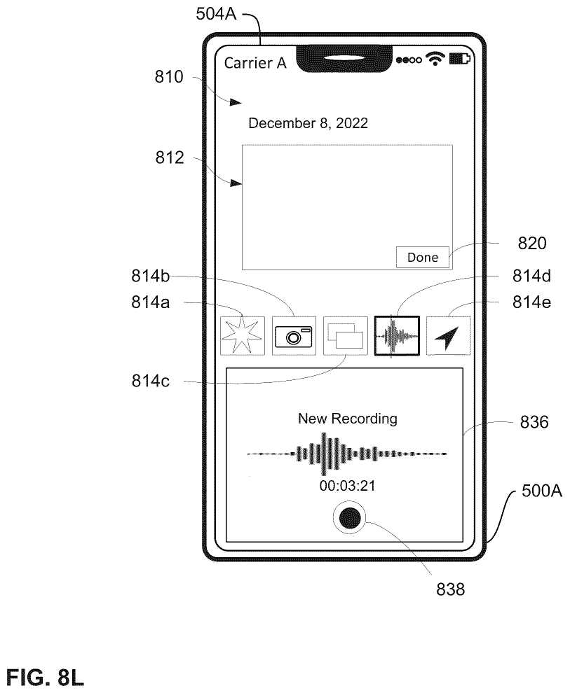

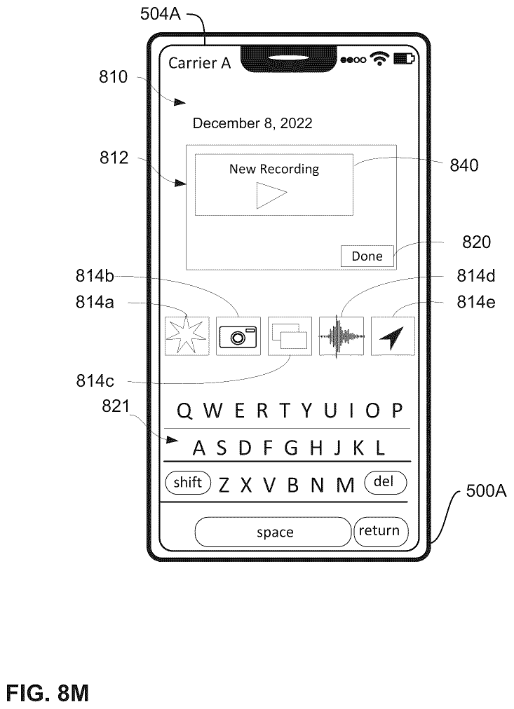

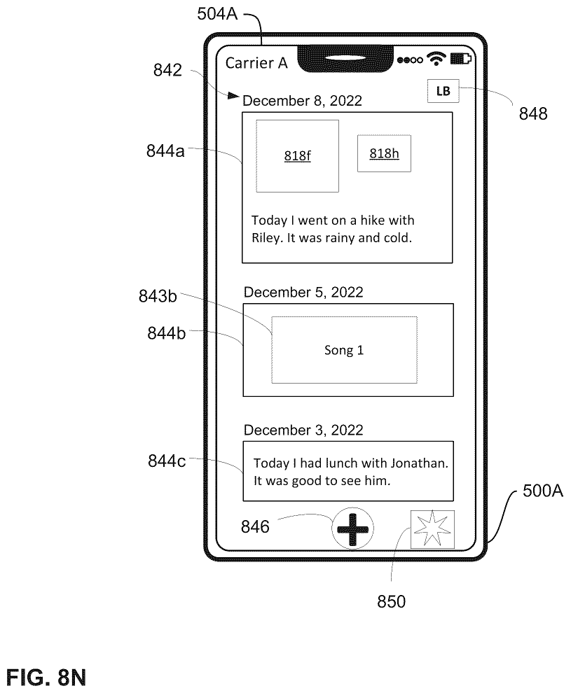

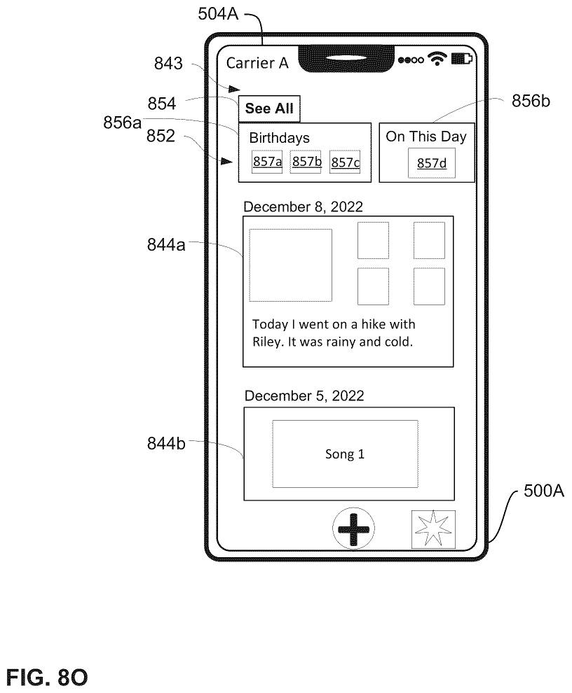

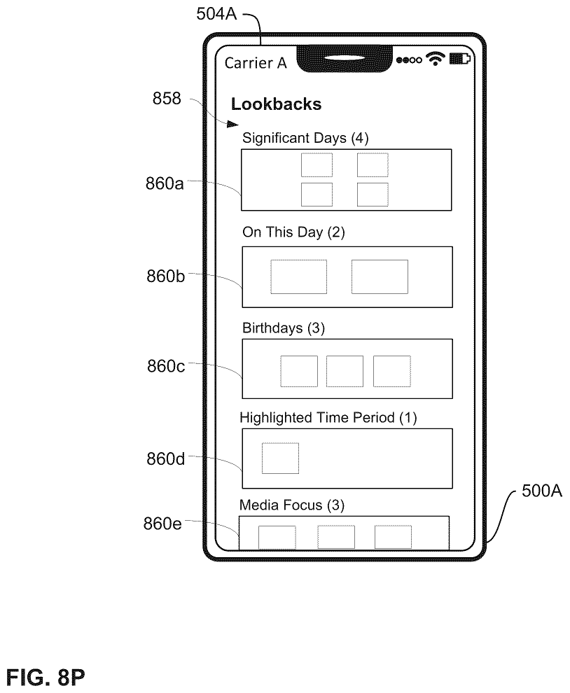

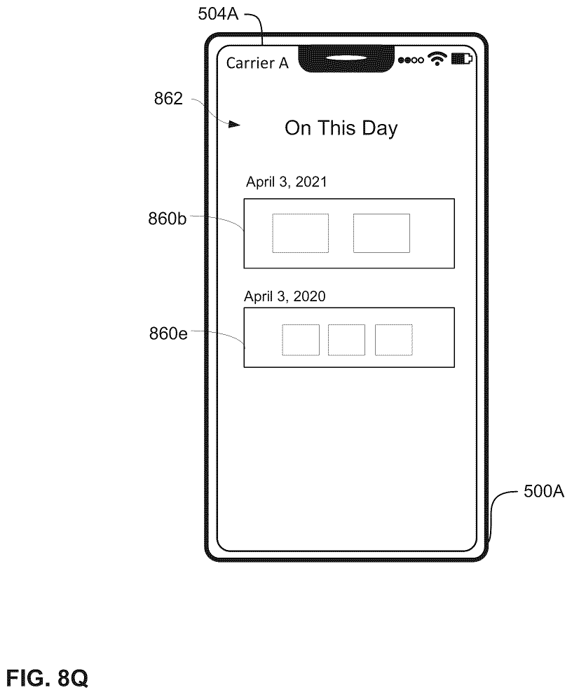

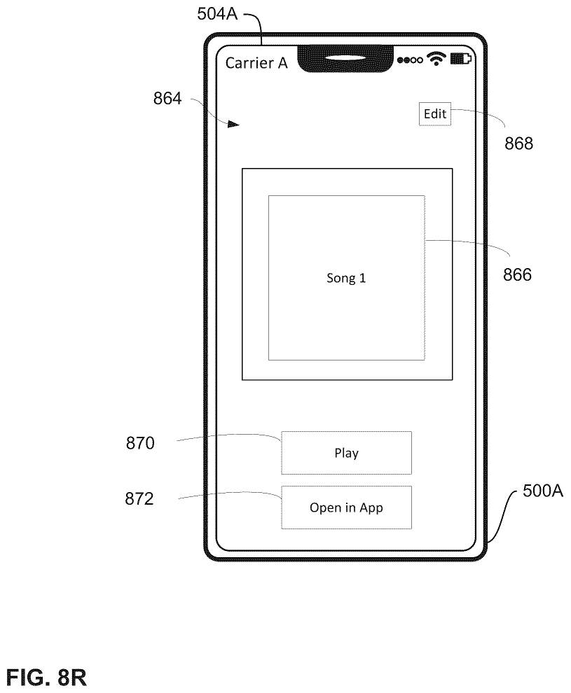

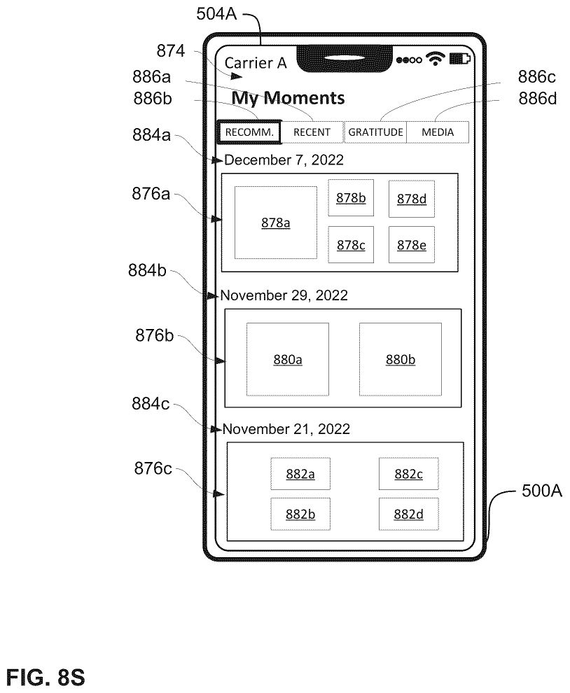

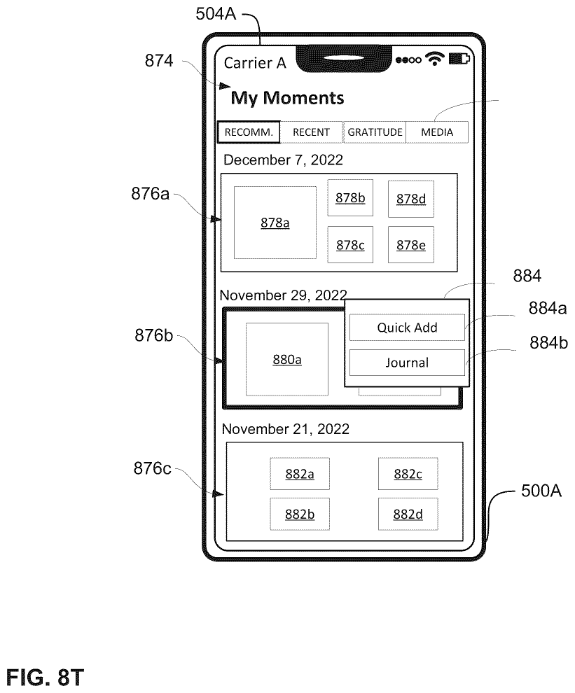

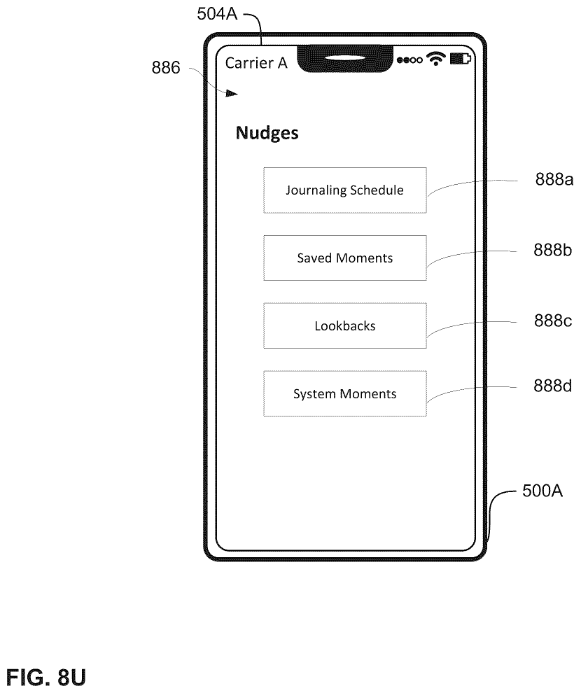

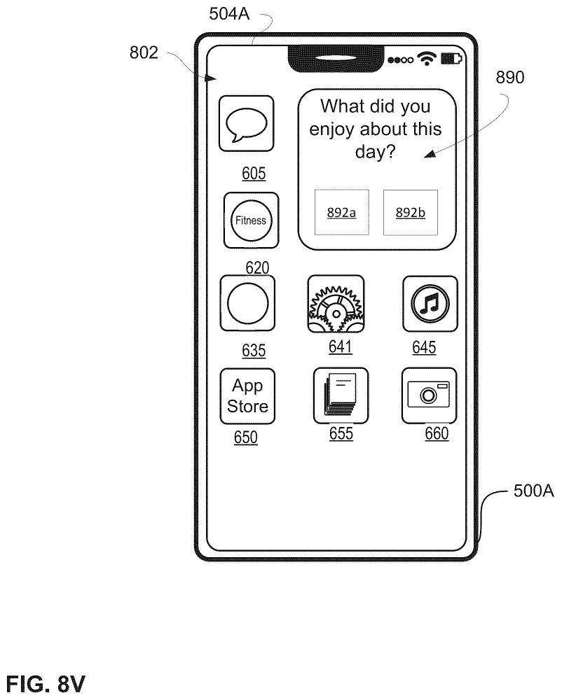

In some embodiments, prompt 638 is generated by the journaling application. In some embodiments, prompt 638 is generated by system-level software running on device 500A (e.g., software other than the journaling application), such as by an operating system of device 500A, based on activities associated with various applications installed on device 500A (such as the activities described above). Optionally, prompt 638 is generated in accordance with a journaling schedule associated with the journaling application (e.g., as described with reference to option 888a of FIG. 8U). Optionally, if the prompt 638 was generated by software other than an application with which the content and/or activities are associated, prompt 638 includes a graphical or textual indication that it was generated by the software on behalf of the application, such as on behalf of the journaling application (e.g., to alert the user that the prompt 638 is not from the journaling application). In some embodiments, prompt 638 can include multiple sub-prompts (e.g., prompts that are each associated with different activities and/or events), such as by including both “Reflect on your day at the zoo” and “Write about the trip you took last year” (for example). In some embodiments, in response to detecting a selection of prompt 638, device 500A displays a picker user interface that includes representations of content associated with prompt 638 (optionally, including representations of content associated with each of the sub-prompts of prompt 638), from which the user can pick (e.g., select) content to provide (e.g., transmit or make accessible to) to the journaling application (or to another application associated with the content or the sub-prompt). In some embodiments, the picker user interface is separate from (e.g., not part of) the journaling application. In some embodiments, the picker user interface is displayed within the journaling application. In some embodiments, the picker user interface includes a confirmation affordance for providing the selected content to the journaling application and optionally initiating a new journal entry in the journaling application (such as by displaying a journal entry user interface as described with reference to FIG. 8C, with the selected content displayed in the journal entry user interface). In some embodiments, the content is not provided (e.g., transmitted or made accessible) to the journaling application until the user confirms selection of the content (such as by selecting the content from the picker user interface and/or by selecting a confirmation affordance to maintain the privacy of the content until the user provides a confirmation that the user wishes to provide the content to the journaling application.

In some embodiments, in response to detecting a selection of prompt 638, device 500A displays a different user interface (e.g., without displaying a picker user interface), as described below with reference to FIG. 6L.

In FIG. 6L, device 500A detects selection of prompt 638 (e.g., via contact 603). In response, in FIG. 6M, device 500A displays user interface 640 that includes a prompt 642, a text or other content entry field 644, an indication 646, a soft keyboard 648, selectable option 651 selectable option 652, selectable option 654, and selectable option 656. In some embodiments, device 500A displays user interface 640 overlaid on the user interface that was displayed when device 500A detected selection of prompt 638, optionally without ceasing display of that user interface and/or without launching or displaying the journaling application. In FIG. 6M, prompt 642 includes information about the user activity event such as the location of the activity event (e.g., the zoo). Prompt 642 includes questions about the activity event such as what the highlight of the activity event was, who was there and what their reactions to the activity event were, as well as additional prompting to obtain information about the activity event (e.g., what else stands out?). Text entry field 644 is interactable to input text or other content as a response to prompt 642 for the journaling entry. Soft keyboard 648 is selectable to facilitate the text or other content entry into text entry field 644. Indication 646 is an indication or representation of a photo taken by device 500A during the activity event (e.g., taken at the zoo with mom, thus displayed with an “M” indication overlaid on a corner of the photo). Selectable option 651 is selectable to change the prompt to a new and/or updated prompt related to the activity event (e.g., a different question generated and/or provided by device 500A related to the activity event). Selectable option 652 is selectable to change the photo to a new and/or updated photo (e.g., taken by device 500A during the activity event). Selectable option 654 is selectable to move to the next prompt for facilitating the creation of the journaling entry. Selectable option 656 is selectable to end the display of prompt(s) for facilitating the creation of the journaling entry and for creating the journaling entry with the content entered into text entry field 644, parts of or all of prompt 642 and/or parts of or all of the photo corresponding to indication 646.

In FIG. 6M, device 500A detects selection of one or more keys in soft keyboard 648 (e.g., via contact 603). In response, in FIG. 6N, device 500A updates text entry field 644 of user interface 640 to include content corresponding to the input detected in FIG. 6M as a response to prompt 642.

In FIG. 6N, device 500A detects selection of selectable option 654 (e.g., via contact 603). In response, in FIG. 6O, device 500A updates user interface 640 to display a new prompt 658. Prompt 658 includes additional details about the activity event such as requesting words to describe the activity event. Prompt 658 is updated based on input in response to the previous prompt, a history of the electronic device, or both. Device 500A further updates user interface 640 to display a new photo associated with the activity event in indication 646.

In FIG. 6O, device 500A detects selection of one or more keys in soft keyboard 648 (e.g., via contact 603). In response, in FIG. 6P, device 500A updates text entry field 644 of user interface 640 to include content corresponding to the input detected in FIG. 6O as a response to prompt 642.

In FIG. 6P, device 500A detects selection of selectable option 654 (e.g., via contact 603). In response, in FIG. 6Q, device 500A updates user interface 640 to display a new prompt 661. Prompt 661 includes additional details about the activity event and/or a general question regarding what else stands out from the activity event and/or day. Device 500A further updates user interface 640 to display a new photo associated with the activity event in indication 646.

In FIG. 6Q, device 500A detects selection of one or more keys in soft keyboard 648 (e.g., via contact 603). In response, in FIG. 6R, device 500A updates text entry field 644 of user interface 640 to include content corresponding to the input detected in FIG. 6Q as a response to prompt 661. Optionally, device 500A generates and displays one or more additional follow-on prompts based on text and/or other content entered by the user. For example, device 500A optionally analyzes text or other content entered in text entry field 644 using a large language model (or other artificial intelligence-based and/or natural-language-based approach) to generate and display appropriate follow-on prompts and interact with the user. For example, in response to detecting the text content “We also met mom there and she was excited to see the penguins” as shown in FIG. 6R, device 500A optionally generates and displays an additional prompt (e.g., replacing prompt 661) that says “What did mom say about the penguins?” to encourage the user to enter additional details.

In response to the selection of selectable option 656 (e.g., via contact 603), device 500A creates a journaling entry that corresponds to the activity event (e.g., the zoo trip), and adds the journaling entry to the journaling application.

After creating the journaling entry, device 500A ceases display of user interface 640 and returns to displaying user interface 602 (or whatever user interface was displayed when prompt 638 was displayed and/or selected) as shown in FIG. 6S. In FIG. 6S, device 500A detects selection of application icon 655 (e.g., via contact 603). In response, in FIG. 6T, device 500A displays the journaling application user interface 606 that now includes the new journaling entry that was created via prompt 638, displayed as representation 670. Representation 670 of journaling entry includes a reference to and/or representations 672 of photos 1-3 that are associated with representation 670 (e.g., from within user interface 640).

In FIG. 6T, device 500A detects selection of representation 670 and/or representation 672 (e.g., via contact 603). In response, in FIG. 6U, device 500A updates user interface 606 to display a journal entry 674 that corresponds to representation 670. Representation 670 is generated based on the input received in response to the previously-described prompts. Representation 670 may include exactly what was inputted into text entry field 644 or may include an altered version of what was inputted into text entry field 644. Further, representation 670 may include all the photos that were presented with the prompts or only a subset of the photos.

As described in more detail with reference to method 700, device 500A optionally surfaces notifications of journal entries (e.g., featured journal entries) or generates animated video presentations for specific journal entries associated with events, people, places, or things, and displays notifications of those journal entries or animated video presentations that facilitate accessing those video presentations. In FIG. 6V, at a point in time after creation of the journaling entry 674, device 500A displays a notification 676 on user interface 602. Device 500A optionally displays notification 676 over whatever user interface device 500A is currently displayed. Notification 676 corresponds to an animated video presentation or some other representation for the respective journal entry. Notification 676 is selectable to initiate a process to view an animated video presentation associated with and/or of the content of journaling entry 674. Notification 676 includes an indication that the notification is from the journaling application and an indication of the corresponding date and person, place, event, or thing.

In FIG. 6V, device 500A detects selection of notification 676 (e.g., via contact 603). In response, in FIG. 6W, device 500A displays an animated video presentation 679 that includes photos and music. For instance, animated video presentation 679 includes text from the corresponding journaling entry, photos from the journaling entry, and music related to the journaling entry. Animated video presentation 679 includes a selectable option 680 that is selectable to save and/or share animated video presentation 679 with another user. In FIG. 6X, device 500A continues display of animated video presentation 679 (e.g., displaying a subsequent portion of animated video presentation 679) including the remaining photo.

In some embodiments, instead of being displayed as a notification, an option to display an animated video presentation of the journaling entry 674 is displayed in (or in the form of) a widget. For example, in FIG. 6Y, device 500A displays notification 683 shown as a widget on user interface 602 (e.g., a widget of the journaling application that device 500A had previously received input to include in user interface 602). Notification 683 is selectable, similar to notification 676, to initiate a process to display a representation associated with a journaling entry, e.g., an animated video presentation associated with journaling entry 674.

As described in more detail with reference to method 700, device 500A optionally allows users to create a journaling entry based on a content item. In FIG. 6Z, device 500A detects selection of application icon 635 (e.g., via contact 603). In response, in FIG. 6AA, device 500A displays a user interface of a photo application and following one or more additional inputs, displays photo 678. Photo 678 is displayed with a sharing option 680, a selectable option 682, and a selectable option 684. Sharing option 680 is selectable to share the photo with a contact or utilize the photo in another application, such as the journaling application. Selectable option 682 is selectable to add photo 678 to a collection of favorite photos. Selectable option 684 is selectable to delete photo 678.

In FIG. 6AA, device 500A detects selection of sharing option 680 (e.g., via contact). In response, in FIG. 6BB, device 500A displays photo 678 in a user interface 686. User interface 686 is optionally a user interface via which photo 678 can be shared. In FIG. 6BB, user interface 686 includes representations 687a-687d, selectable options 688a-688d, and selectable options 689a-689c. Representations 687a-687d represent messaging conversations that are selectable to initiate a process to transmit and/or use photo 678 in those messaging conversations. Selectable options 688a is selectable to initiate a process to transmit the photo 678 to a nearby device. Selectable option 688b is selectable to initiate a process to email photo 678. Selectable option 688c is selectable to initiate a process to send photo 678 to a messaging conversation. Selectable option 618d is selectable to initiate a process to utilize photo 678 to generate a journaling entry. Selectable option 688d is selectable to initiate a process to upload and/or use photo 678 in a corresponding social media application. Selectable option 689a is selectable to copy photo 678. Selectable option 689b is selectable to add photo 687 to a collection of favorite photos. Selectable option 689c is selectable to initiate a process to markup and/or modify photo 678.

In FIG. 6BB, device 500A detects selection of selectable option 618d (e.g., via contact 603). In response, in FIG. 6CC, device 500A displays user interface 640 (e.g., overlaid on the photos user interface, without launching or displaying the journaling application) including prompt 690 in a similar way to prompt 642 in FIG. 6M. Prompt 690 includes information about photo 678 such as the location the photo was taken and a question about photo 678. For instance, user interface 640 includes photo 4 as photo 4 is the initial content item that is the foundation of the creation of the journaling entry. User interface 640 is interactable in a similar way to user interface 640 in FIG. 6M to create a journaling entry based on photo 4.

As described in more detail with reference to method 700, device 500A optionally displays indications of existing journaling entries that are related to content items along with the display of the content items, such as a calendar entry. In FIG. 6DD, device 500A detects selection of application icon 610 (e.g., via contact 603). In response, in FIG. 6EE, and following one or more additional inputs, device 500A displays user interface 692 that includes calendar details about a user-selected day (e.g., Dec. 17, 2022) and selectable options 694a-694b that correspond to different calendar events of the selected day. Selectable option 694a includes details about a calendar event at 8 AM. Selectable option 694b includes details about a calendar event at 11 AM.

In FIG. 6EE, device 500A detects selection of 694b (e.g., via contact 603). In response, in FIG. 6FF, device 500A expands selectable option 694b to display user interface elements 695a-695c, and a selectable option 695d. User interface element 695a displays a title of the calendar event, user interface element 695b, user interface element 695c displays a representation of the period of time and/or duration of the calendar event on the selected day, and selectable option 695d includes an indication that a journaling entry corresponds to the calendar event and is selectable to initiate a process to display the journaling entry. User interface element 695b includes details about the calendar event such as the date and time of the calendar event. Thus, in some embodiments, because the calendar event is associated with a journaling entry, device 500A displays an indication of the existence of the journaling entry (e.g., option 695d) when displaying details of the calendar event and/or other user interfaces associated with the calendar event.

In FIG. 6FF, device 500A detects selection of selectable option 695d (e.g., via contact 603). In response, in FIG. 6GG, device 500A displays user interface 606 of the journaling application including representation 670 of a journaling entry. Selectable option 617 is selectable to initiate a process to view one or more animated video presentations that are related to activity events and/or journaling entries. In some embodiments, in response to the input in FIG. 6FF, device 500A displays the content of journaling entry 674 (e.g., such as illustrated in FIG. 6U).

As described in more detail with reference to method 700, device 500A optionally displays indications of existing journaling entries that are related to content items along with the display of the content items, such as one or more photos. In FIG. 6HH, device 500A detects selection of application icon 635 (e.g., via contact 603). In response, in FIG. 6II, device 500A displays a user interface of the photo application and displays photo representations 696a-696d along with corresponding indications if the corresponding photo is associated with a journaling entry. Photo representation 696a (corresponding to Photo 1) is associated with (e.g., is included in) a journaling entry from December 17th, and therefore is displayed with an indication of the journaling entry that is optionally selectable to display that journaling entry and optionally includes information about the journaling entry (e.g., the date of the journaling entry and/or the icon of the journaling application), photo representation 696b (corresponding to Photo 2) is associated with (e.g., is included in) the same journaling entry from December 17th, and therefore is displayed with the same indication of the journaling entry, and photo representation 696c (corresponding to Photo 3) is associated with (e.g., is included in) the same journaling entry from December 17th, and therefore is displayed with the same indication of the journaling entry. However, photo representation 696d (corresponding to Photo 4) is not associated with a journaling entry, and therefore is not displayed with an indication of a journaling entry.

As described in more detail with reference to method 700, device 500A optionally allows users to create a journaling entry based on a content item such as an achievement in a fitness application. In FIG. 6JJ, device 500A detects selection of application icon 620 (e.g., via contact 603). In response, in FIG. 6KK, and after one or more additional inputs, device 500A opens the fitness application and displays achievement 697 (e.g., a representation of an achievement earned in the fitness application). Device 500A further displays sharing option 698 that is selectable in a similar way to sharing option 680 described previously.

In FIG. 6KK, device 500A detects selection of sharing option 698 (e.g., via contact 603). In response, in FIG. 6LL, device 500A displays achievement 697 in user interface 686 in a similar way that photo 678 is displayed in user interface 686 in FIG. 6BB.

In FIG. 6LL, device 500A detects selection of selectable option 618d (e.g., via contact 603). In response, in FIG. 6MM, device 500A displays user interface 640 including prompt 699 in a similar way to prompt 642 in FIG. 6M. Prompt 699 includes information about achievement 697 such as the type of activity. Prompt 699 also includes questions about the activity event. User interface 640 is also interactable in similar ways to user interface 640 of FIG. 6M to create a journaling entry based on the achievement.

As described in more detail with reference to method 700, device 500A optionally allows users to request a prompt manually to create a journaling entry. In FIG. 6NN, device 500A displays selectable options 616 and 618 in user interface 606 of the journaling application, similar to FIG. 6D. In FIG. 6NN, device 500A detects selection of selectable option 618. In response, in FIG. 600, device 500A displays user interface 640 of FIG. 6D. User interface 640 optionally has one or more of the characteristics of user interface 640 in FIG. 6M. Thus, in some embodiments, device 500A displays user interface 640 based on (recent) activities of the user and/or device 500A in response to manual input detected to do so, even if the activities do not satisfy criteria for displaying prompt 638.

As described in more detail with reference to method 700, device 500A optionally allows users to create a journaling entry from a second device. FIG. 6PP illustrates an exemplary device 500B that includes touch screen 504B. Device 500B is optionally associated with device 500A (e.g., device 500A is a smart phone logged into and/or configured with a user account, and device 500B is a smart watch that is paired with device 500A and/or is logged into and/or configured with the same user account). In FIG. 6PP, device 500B is displaying user interface 607, which is optionally a watch face user interface of device 500B and includes an indication of time. In some embodiments, user interface 607 is a home screen user interface of device 500B (e.g., as described with reference to FIG. 4A). Device 500B further displays prompt 609 on touch screen 504B. Prompt 609 indicates that it is related to the journaling application and includes an invitation to create a journaling entry. Prompt 609 is optionally displayed on device 500B in response to the same criteria being satisfied as for the display of prompt 638 on device 500A. In some embodiments, prompt 609 is displayed in lieu of prompt 638 being displayed on device 500A. In some embodiments, prompt 609 is displayed on device 500B and prompt 638 is displayed on device 500A. Prompt 609 is optionally selectable to initiate a process to create a journaling entry to enter into the journaling application (e.g., on device 500A).

In FIG. 6PP, device 500B detects selection of prompt 609 (e.g., via contact 603). In response, in FIG. 6QQ, device 500B expands prompt 609 and/or displays a prompt user interface (e.g., having one or more of the characteristics of user interface 640), including a question that can be responded to as part of creating the journaling entry. In some embodiments, because the display size of device 500B is optionally small, expanded prompt 609 (or other user interface) includes selectable options 611a-611c corresponding to predefined responses to the question(s) displayed, rather than expanded prompt 609 (or other user interface) including a free-form text entry field via which to provide responses to the question(s) displayed. Selectable options 611a-611c are selectable to enter a response to prompt 609 (e.g., for inclusion in the journaling entry). In some embodiments, the predefined responses corresponding to selectable options 611a-611c are emoji responses. For example, selectable option 611a is selectable to enter a smiling face response to prompt 609 (e.g., for inclusion in the journaling entry), and optionally includes a representation (e.g., image) of the corresponding response. Selectable option 611b is selectable to enter a sad face response to prompt 609 (e.g., for inclusion in the journaling entry), and optionally includes a representation (e.g., image) of the corresponding response. Selectable option 611c is selectable to enter a concerned face response to prompt 609 (e.g., for inclusion in the journaling entry), and optionally includes a representation (e.g., image) of the corresponding response.

FIG. 7 is a flow diagram illustrating a method 700 of displaying a prompt to a user to generate journaling entries in accordance with some embodiments, such as in FIGS. 6A-6QQ. The method 700 is optionally performed at an electronic device such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to display a prompt to a user to generate journaling entries. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, such as in FIG. 6A, method 700 is performed at an electronic device (e.g., 500A) in communication with a display generation component (e.g., 504A) and one or more input devices (e.g., 504A). The electronic device may include, for example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by an automobile (e.g., at an infotainment system of an automobile having or in communication with one or more display generation components and/or input devices).

In some embodiments, the electronic device detects (702a) an activity event associated with a user of the electronic device, where the activity event corresponds to one or more operations performed by the electronic device, such as calling Mom in FIG. 6G, driving to the zoo in FIG. 6I, and taking photo 1 (e.g., 636) in FIG. 6K (e.g., during a time period, such as 5, 10, 30, 60, 120, 240 or 480 minutes). For example, the electronic device optionally tracks operations performed by the electronic device over time. In some embodiments, the operations correspond to actions the user of the electronic device performs in a given day. For instance, the operations optionally include the electronic device calling a contact stored in the electronic device, the electronic device detecting a movement of the electronic device from a first location to a second location (e.g., from a first city to a second city, a first state to a second state, and/or a first address to a second address), the electronic device detecting the storage and/or completion of a workout (e.g., a hike, a run, and/or a swim) using a workout application installed on the electronic device, the electronic device displaying content (e.g., a podcast, music, television show and/or movie) to the user of the electronic device, the electronic device taking photos and/or videos and/or parsing the photos and/or videos to match one or more contacts stored on the electronic device, and/or the electronic device detecting the existence of the electronic device at a location (e.g., a park, a restaurant, and/or a user's workplace) for an extended period of time (e.g., greater than 5, 10, 30, 60 or 120 minutes). Additionally or alternatively, in some embodiments, the electronic device detects the above operations being performed by one or more other electronic devices associated with the user (e.g., a smartwatch of the user, a tablet computer of the user, and/or a smartphone of the user, which are optionally all logged into the same user account, which is associated with the user).

In some embodiments, in response to detecting the activity event associated with the user (702b), in accordance with a determination that the activity event satisfies one or more criteria, such as calling Mom in FIG. 6G. In some embodiments, the one or more criteria include a criterion that is satisfied when the activity event is a notable activity for the user of the electronic device based on one or more factors described below. In some embodiments, the one or more criteria include a criterion that is satisfied when the activity event occurred within a threshold amount of time from the current time (e.g., within the last day, week, month, or year). For instance, the criterion is optionally satisfied by the electronic device calling a popular contact (e.g., a contact that the electronic device interacts with via a messaging application installed on the electronic device, via a phone call from the electronic device, and/or other communication application installed on the electronic device more than a threshold amount of the time (e.g., greater than 5, 10, 30, 60, 120 or 240 minutes during a given 30, 60, 120, 240, 480, 960 or 1920 minute period of time) and/or greater than a threshold proportion of device usage or communication usage (e.g., greater than 5%, 25%, 50%, 60%, 70%, 80%, or 90%)), the recording of a workout in the electronic device, or the detecting of a movement of the electronic device from a first location to a second location that is greater than a threshold distance from the first location (e.g., greater than 3, 5, 20, 50, 100, 150, 1000, 3000 or 5000 miles). Alternatively, the criterion is optionally not satisfied by the electronic device calling a phone number that is not stored in the electronic device and/or is not associated with a contact of a user profile of the electronic device, or the detecting of a movement of the electronic device from a first location to a second location that is less than the above-described threshold distance (e.g., 1, 2, 3, 4, or 5 feet).)

In some embodiments, the electronic device displays (702c), via the display generation component, a prompt associated with a journaling application on the electronic device, where input directed to the prompt associated with the journaling application initiates a process to provide input for a journaling entry associated with the activity event in the journaling application, such as prompt 638 in FIG. 6L. The prompt optionally includes a user selectable option, as will be described below. The prompt is optionally a notification displayed on a lock screen user interface, a wake screen user interface, or a home screen user interface of the electronic device. In some embodiments, the user selectable option is selectable to initiate a process to enter the journaling application and/or a process to receive input for content that will be entered into the journaling application via the prompt (e.g., without displaying the journaling application). In some embodiments, the prompt includes information about the user activity event (e.g., information such as the location of the activity event, the time of the activity event, and/or photos from the activity event). In some embodiments, the journaling application is an application that receives and/or stores journal entry input from a user of the electronic device.

In some embodiments, in accordance with a determination that the activity event does not satisfy the one or more criteria, the electronic device forgoes display (702d), via the display generation component, of the prompt associated with the journaling application, such as if the phone call in FIG. 6G was to the zoo which is not a popular contact. In some embodiments, if the activity event does not satisfy the one or more criteria, if the user of the electronic device wants to create a journal entry for the activity event in the journaling application, the user of the electronic device must manually launch the journaling application and provide input from within the journaling application to create the journal entry. Displaying a prompt to a user of the electronic device to provide content to a journaling application based on the user's activity provides the user with an easy and personalized platform for creating journal entries, thus reducing the number of inputs needed to create journal entries.

In some embodiments, the activity event does not satisfy the one or more criteria, such as if the route in FIG. 6I was to a gas station instead of the zoo. In some embodiments, after detecting the activity event, the electronic device receives, via the one or more input devices, a first user input corresponding to a request to manually create a respective journaling entry in the journaling application, such as contact 603 in FIG. 6C. In some embodiments, the first user input is a selection of a journaling icon from the home screen user interface of the electronic device, or selection of an option within a user interface of the journaling application to manually create a journaling entry.

In some embodiments, in response to receiving the first user input, the electronic device initiates a process to manually create the respective journaling entry in the journaling application, such as contact 603 in FIG. 6C and contact 603 in FIG. 6D to create journaling entry 621 in FIG. 6E. In some embodiments, the selection initiates a process to enter the journaling application and create a journal entry. In some embodiments, the journal entry is automatically created. In alternative embodiments, the electronic device requires an additional user input to create the journal entry. In some embodiments, initiating the process to manually create the journaling entry includes displaying a user interface into which user input for inclusion into the journaling entry is entered. Providing a manual entry point for journal entries provides the user with an easy entry point to create journal entries that is not dependent on being prompted to create the journal entries, thus providing increased flexibility for the creation of journal entries.

In some embodiments, the first user input is directed to a content item displayed in a first application different from the journaling application, such as contact 603 in FIG. 6AA. For instance, the first application is optionally stored or installed on the electronic device and is capable of communicating with the journaling application. In some embodiments, the first application is an application that stores and/or displays content items such as photos, music, fitness achievements, video content, calendar events, routes, books, podcast or games. In some embodiments, the content item is displayed with a user selectable option that is selectable to initiate a process to create a journal entry in the journaling application with or without ceasing display of the first application. In some embodiments, the process to manually create the respective journaling entry in the journaling application utilizes the content item as part of the journaling entry, such as photo 678 in FIG. 6AA. In some embodiments, the electronic device creates a journaling entry within the journaling application that connects to and/or includes the content item. In some embodiments, the electronic device displays a prompt associated with the content item as part of the process to manually create the respective journaling entry. In alternative embodiments, the electronic device displays a journal entry user interface that is configured to receive user input for populating the journal entry, where the journal entry already includes the content item. Automatically populating the journal entry with the content item provides the user with an easy way to journal about content items, thus reducing the number of inputs needed to create journal entries for content items.

In some embodiments, the first user input is directed to a user interface displayed in the journaling application, such as contact 603 in FIG. 6C. In some embodiments, the journaling entry is created directly from within the journaling application. For example, the first user input includes selection of an option displayed in a user interface of the journaling application for creating a journal entry in the journaling application. Providing a manual way to begin a journal entry from within the journaling application provides the user with an easy way to create journal entries from a user interface expected to include an option to create journal entries, thus reducing the number of inputs needed to find a journal entry creation point.

In some embodiments, before displaying the user interface in the journaling application, the electronic device receives, via the one or more input devices, a second user input corresponding to a request to display the journaling application, such as contact 603 in FIG. 6A (e.g., receiving selection of an icon for the journaling application on a home screen user interface of the electronic device).

In some embodiments, in response to receiving the second user input, the electronic device requires user authentication before displaying the journaling application, such as contact 603 in FIG. 6B. In some embodiments, the user authentication protects the journaling entries stored in the journaling application. In some embodiments, the electronic device will only allow entry to the journaling application upon receiving authentication input that is successfully authenticated, and will not display the journaling application if the authentication input is not successfully authenticated. Requiring authentication for entry to the journaling application ensures the journaling entries are secure and improves user privacy and security.

In some embodiments, the user authentication includes one or more of a facial identification, a fingerprint identification, or a passcode identification, such as shown as a passcode identification in FIG. 6B. In some embodiments, the user authentication requires the user to scan or take an image of their face via one or more cameras of the electronic device, to scan their fingerprint via one or more fingerprint sensors of the electronic device, and/or enter a passcode via the touch screen of the electronic device. Requiring authentication for entry to the journaling application ensures the journaling entries are secure and improves user privacy and security.

In some embodiments, after creating the journaling entry in the journaling application, the electronic device displays, via the display generation component, a user interface of the journaling application including a plurality of journaling entries (e.g., 608, 613, 612, and/or 614), including the journaling entry (e.g., 670), where the journaling entry is displayed within the user interface of the journaling application as a page of a book, such as user interface 606 of FIG. 6C. For instance, the journaling entry is displayed along with a plurality of journaling entries one by one, and in response to detecting selection of one of the journaling entries, the electronic device displays the selected journal entry. In some embodiments, the content of a given journal entry and/or the indications of the plurality of journal entries are displayed on one or more virtual pages of a virtual book. Displaying the journal entries in the user interface as a page of a book is an efficient manner of laying out the journal entries, and reduces the number of inputs needed to navigate to the correct journal entry.

In some embodiments, after creating the journaling entry in the journaling application, the electronic device displays, via the display generation component, a user interface of the journaling application including a plurality of journaling entries (e.g., 608, 612, 613, and/or 614), including the journaling entry (e.g., 670), where the plurality of journaling entries are displayed chronologically within the user interface of the journaling application, such as user interface 606 in FIG. 6C. For instance, the journal entry is displayed in the user interface after one or more journal entries with an earlier creation and/or last edit date than the journal entry, and/or before one or more journal entries with a later creation and/or last edit date. Displaying the journal entries in the user interface in chronological order enables the user to easily locate a desired entry, thus reducing the number of inputs needed to locate and/or access the desired entry.

In some embodiments, the journaling application, including the journaling entry, is accessible via a second electronic device that is associated with the electronic device, such as device 500B in FIG. 6PP. In some embodiments, the electronic device is a tablet, a watch, a computer, or a smart tv or set-top box. Accordingly, and in some embodiments, the second electronic device is a mobile phone while the electronic device is a smart watch. In such an instance, the journal entry is optionally entered and/or created via input at the smart watch (e.g., the electronic device), and when the second electronic device displays the journaling application, the second electronic device displays the journal entry that was created in response to input detected at the electronic device. In some embodiments, the second electronic device is associated with the electronic device when the second electronic device and the electronic device are both configured with and/or logged into the same user account and/or user profile. Allowing journal entry creation and/or journaling application display at multiple devices provides the user with various ways to create a journal entry.

In some embodiments, the activity event does not satisfy the one or more criteria, such as photo 678 in FIG. 6AA. In some embodiments, after detecting the activity event associated with the user and forgoing displaying, via the display generation component, the prompt associated with the journaling application, the electronic device receives, via the one or more input devices, a first user input directed to the journaling application corresponding to a request for a respective prompt associated with the journaling application, wherein the respective prompt is associated with the activity event, such as prompt 690 in FIG. 6CC. In some embodiments, the first user input is directed to a user interface of the journaling application. For example, the first user input is selection of a “display journaling prompt” button displayed in the user interface of the journaling application. In some embodiments, the first user input is directed to content such as photos, albums, maps, web searches, or podcasts.

In some embodiments, in response to receiving the first user input, the electronic device displays, via the display generation component, the respective prompt (e.g., 690), wherein input directed to the respective prompt (e.g., 690) initiates a process to provide input for a respective journaling entry associated with the activity event in the journaling application, such as by entering text into text entry field 644 and selecting selectable option 656 in FIG. 6CC. The prompt optionally includes a user selectable option, as will be described below. The prompt optionally includes information about the experience or information about the user activity event, as will be described below. Thus, in some embodiments, even if the activity event does not satisfy the one or more criteria, user input can cause the electronic device to manually display the respective prompt, which optionally includes information to guide the user through creating the journal entry, as described herein. Providing the user with an option to request a prompt provides the user with a quick way to display information related to recent activities to write about, thus reducing battery usage for the electronic device.

In some embodiments, the prompt includes one or more details related to the activity event, such as prompt 690 in FIG. 6CC. In some embodiments, the one or more details include the types of activities (e.g., run, phone call, trip, tv show, podcast, and/or music) performed as part of the activity event, the friends involved in the activity event (e.g., friends or family), the time of the activity event (e.g., from a first specific time to a second specific time and/or a specific date), and/or a photo or video or other content associated with and/or captured during the activity event. Providing the user with details of the activity facilitates efficient creation of the journal entry, thus reducing the number of inputs needed to correct undesired portions of the journal entry.

In some embodiments, while displaying the prompt (e.g., 638) associated with the journaling application, the electronic device receives, via the one or more input devices, a first user input directed to the prompt (e.g., 638), such as contact 603 in FIG. 6L (e.g., a selection of the prompt, a tap and hold directed to the prompt, or a swipe input directed to the prompt). In some embodiments, the first user input is input directed to one or more user interfaces displayed by the electronic device in response to detecting selection of the prompt.

In some embodiments, in response to receiving the first user input, and in accordance with a determination that the first user input includes speech input, the electronic device incorporates the speech input into the journaling entry, such as if the electronic device received speech input into text entry field 644 in FIG. 6M. For instance, the electronic device optionally receives speech input from the user for a longer entry that the user does not want to manually type. In some embodiments, the speech input is entered into the journaling entry as text.

In some embodiments, in accordance with a determination that the first user input includes emoji input, the electronic device incorporates the emoji input into the journaling entry, such as if the electronic device received emoji input into text entry field in FIG. 6M. For instance, the electronic device optionally receives emoji input from the user. In some embodiments, the emoji input includes detecting selection of an emoji key or keys displayed in an emoji keyboard or other emoji user interface. For example, the electronic device optionally displays one or more emojis to the user along with the prompt (or the user interfaces displayed in response to selection of the prompt) via the display device and, upon receiving selection of one of the one or more emojis, enters the selected emoji in the journaling entry. In some embodiments, the emoji input is speech input directed to an animated emoji (e.g., optionally customized by the user), and the animated emoji speaking the detected/recorded speech input is entered into the journaling entry. Providing the user with various ways to input content into a journal entry avoids erroneous input into the journal entry, and reduces the number of inputs needed to correct such erroneous input.

In some embodiments, the electronic device receives, via the one or more input devices, first user input corresponding to a request to create a respective journal entry associated with a content item, such as contact 603 in FIG. 6R. In some embodiments, the content item is a photo, music, fitness achievement, video content, calendar event, route, book, podcast, or game.

In some embodiments, in response to receiving the first user input, the electronic device creates the respective journal entry, including linking the respective journal entry to the content item, such as photos 1-3 with representation 670 in FIG. 6T. In some embodiments, a representation of the content item is stored within the respective journaling entry to alert the user that the respective journaling entry is associated with the content item. Furthermore, upon a user selection of the representation of the content item, the electronic device optionally displays a user interface of an application (e.g., optionally different from a user interface of the journaling application) that includes the content item. Providing a way for the user to link a content item with a journaling entry reduces the number of inputs needed to navigate to and/or display content items that are associated with journaling entries.

In some embodiments, after receiving the first user input and creating the respective journal entry, the electronic device receives, via the one or more input devices, a second user input corresponding to a request to access the content item, such as contact 603 in FIG. 6FF. For instance, the second user input is optionally a selection of the content item within a respective content browsing and/or playback application that is not the journaling application. In some embodiments, a representation of the content item is stored with the respective journal entry. Thus, the second user input is optionally a selection of the representation of the content item.

In some embodiments, in response to receiving the second user input to access the content item, the electronic device accesses (e.g., displays) the content item (e.g., 678) and displays, via the display generation component, a representation of the respective journal entry, such as representation 670 in FIG. 6GG. In some embodiments, the electronic device displays a representation of the journal entry concurrently with the content item. In some embodiments, the electronic device displays a representation of the journal entry without the content item. In some embodiments, the representation of the journal entry is selectable to display the (content of the) respective journal entry, including the content item. In some embodiments, the representation of the journal entry is a visual indication that indicates that the respective journal entry is associated with the content item. In some embodiments, the visual indication is displayed concurrently with the content item. In some embodiments, the visual indication is selectable to open the respective journal entry. Surfacing the journaling entry when the user revisits the content item provides the user with an efficient way to access the journaling entry, thus reducing the number of inputs needed to access the journaling entry when revisiting the content item.

In some embodiments, while displaying the prompt (e.g., 638) associated with the journaling application, the electronic device receives, via the one or more input devices, a first user input directed to the prompt associated with the journaling application, such as contact 603 in FIG. 6L. In some embodiments, the first user input includes a click, a tap or a swipe input directed to the prompt. In some embodiments, the electronic device displays, in the prompt, an additional user selectable option that when selected displays the below-described user interface that includes the one or more details related to the event.

In some embodiments, in response to receiving the first user input, the electronic device displays, via the display generation component, a user interface that includes one or more details related to the activity event, such as prompt 642 in FIG. 6M. In some embodiments, the details include a song listened to during the activity event, a route taken during the activity event, photos or videos taken during the activity event, a restaurant eaten at during the activity event, fitness information obtained during the activity event, people associated with the activity event (e.g., people who appeared in photos taken during the activity event and/or people who were located at the location(s) of the activity event during the activity event), a podcast listened to during the activity event, a movie or show watched during the activity event, and/or a location visited during the activity event. Providing the user with details of the activity facilitates efficient creation of the journal entry, thus reducing the number of inputs needed to correct undesired portions of the journal entry.

In some embodiments, the one or more details include one or more indications of one or more people associated with one or more photos taken by the electronic device during the activity event, such as the “M” to represent mom in FIG. 6M. In some embodiments, the electronic device determines the people associated with the photos based on photo activity stored on the electronic device. In some embodiments, the people are indicated in the user interface as a representative avatar or initial. In some embodiments, the people identified are those people that were with the electronic device when the electronic device took pictures or video during the activity event and/or those people that appear in the pictures and/or videos taken during the activity even. Identifying people associated with the activity event facilitates efficient creation of the journal entry, thus reducing the number of inputs needed to correct undesired portions of the journal entry.

In some embodiments, while displaying the prompt (e.g., 638) associated with the journaling application, the electronic device receives, via the one or more input devices, a first user input directed to the prompt associated with the journaling application, such as contact 603 in FIG. 6L (e.g., an input interacting with the prompt, as described herein).

In some embodiments, in response to receiving the first user input, the electronic device displays, via the display generation component, a first question related to the activity event, such as prompt 642 in FIG. 6M. In some embodiments, the first question is a question related to one or more details associated with the activity event. For instance, the first question optionally includes a question about a location at which the electronic device was located during the activity event, and/or a person within a picture the electronic device took during the activity event.

In some embodiments, while displaying the first question (e.g., 642) related to the activity event, the electronic device receives, via the one or more input devices, a second user input corresponding to a first response that indicates a response to the first question, wherein at least a portion of the first response is included in the journaling entry, such as text entry field 644 in FIG. 6N. In some embodiments, the response includes text input provide by the user (e.g., via a hardware or software keyboard), and includes the user's response to the first question: for example, a description of the location and the person's reaction to the location. In some embodiments, the journaling entry includes one or both of the descriptions. Prompting the user and incorporating details of the response into the journal entry facilitates efficient population of content into a journal entry.

In some embodiments, after receiving the second user input, the electronic device displays, via the display generation component, a second question related to the activity event, wherein the second question is based on the first response, such as prompt 658 in FIG. 6O. In some embodiments, the second question is determined by a machine learning model. In some embodiments, the content of the second question is based on the content of the first response, and optionally is different if different responses to the first question are provided. For instance, if the first response introduced a particular activity that occurred during the activity event, the second question is optionally directed to the particular activity. For instance, if the device detects an activity event of a hike, the first question is optionally “How was the hike today?,” and the second question is optionally “Three words to describe the hike” if the first response does not mention a particular activity other than the hike. However, if first response is “Great! The middle provided a great place to meditate”—“meditate” corresponding to an activity different from the hike—the second question will optionally be “Three words to describe today's meditation.” Providing follow-up questions based on earlier responses increases the amount of content in the journal entry that is relevant to the activity event.

In some embodiments, after receiving the second user input, the electronic device displays, via the display generation component, a second question related to the activity event, wherein the second question is based on information associated with the activity event such as if prompt 658 in FIG. 6O is based on the response in text entry field 44 in FIG. N. In some embodiments, the information associated with the activity event includes a song listened to during the activity event, a route taken during the activity event, photos taken during the activity event, a restaurant eaten at during the activity event, fitness information obtained during the activity event, people associated with the activity event, a podcast listened to during the activity event, a movie or show watched during the activity event, and/or a location visited during the activity event. For instance, a first question is optionally based on people detected in the activity event such as “How was lunch with Abby?”, because Abby was determined by the electronic device to be present at the activity event. Providing follow-up questions based on earlier responses increases the amount of content in the journal entry that is relevant to the activity event.

In some embodiments, after receiving the second user input, the electronic device displays, via the display generation component, a second question related to the activity event, wherein the second question is based on one or more prior journaling entries in the journaling application, such as if prompt 658 in FIG. 6O is based on the details of journaling entries 608-612 in FIG. 6C. In some embodiments, the electronic device utilizes information entered by the user in prior journaling entries to determine the second question. For instance, if one or more of the prior journaling entries (often) discuss meditation at the top of a particular hill, and the activity event includes a hike at the particular hill, the second question optionally includes a question about meditation such as “nice hike, did you meditate today?” Providing follow-up questions based on earlier responses increases the amount of content in the journal entry that is relevant to the activity event.

In some embodiments, the one or more criteria include a criterion that is satisfied based on a relationship between a current time of day at the electronic device and information associated with the user of the electronic device, such as if prompt 638 in FIG. 6L is displayed outside of work hours (e.g., and not during work hours). In some embodiments, the relationship creates a “smart” time for the electronic device to prompt the user. For instance, if the current time of day is 6 PM (e.g., the end of the day) and the information associated with the user of the electronic device indicates that the user is typically using the electronic device at 6 PM, the relationship optionally indicates this is a “smart” time for a prompt, and the criterion is satisfied. In some embodiments, the “smart” time is optionally based on a user-preferred setting. In additional embodiments, the “smart” time is optionally based on a focus mode of the device (e.g., the prompt is delayed while the electronic device is in a mode during which one or more notifications are suppressed, such as notifications for incoming calls, incoming messages or incoming emails). Providing the user with the prompt at an appropriate time increases the likelihood the user will engage with the prompt, and avoids wasting resources on displaying the prompt when the prompt is unlikely to be interacted with.

In some embodiments, the one or more criteria include a criterion that is satisfied based on one or more of a frequency with which the user of the electronic device contacts a contact associated with the activity event, such as if Mom was contacted often as in FIG. 6G. For instance, if the electronic device detects that the activity event involves a popular contact (e.g., the popular contact is present at the activity event) the electronic device contacts relatively frequently (e.g., more than 2, 3, 5, or 10 times a day) the criterion is satisfied. Alternatively, if the electronic device detects that the activity event involves a contact that the electronic device contacts relatively infrequently (e.g., less than 2, 3, 5, or 10 times a day) the criterion is not satisfied.

In some embodiments, the one or more criteria include a criterion that is satisfied based on one or more of a movement of the electronic device from a first location to a second location that is associated with the activity event, such as moving from home to the zoo, as in FIG. 6I. For instance, if the movement of the electronic device moves from a first location to a that is a location the electronic device visits frequently (e.g., more than 2, 3, 5, or 7 times a week), the criterion is satisfied (and optionally not satisfied if otherwise). Alternatively, if the electronic moves from a first location to a second location, and the second location is a location the electronic device visits relatively infrequently (e.g., less than 1 time a year), the criterion is satisfied (and optionally not satisfied if otherwise).

In some embodiments, the one or more criteria include a criterion that is satisfied based on one or more of a photo taken by the electronic device that is associated with the activity event, such as the taking of photo 1 (e.g., 636), such as in FIG. 6K. For instance, if the photo includes a popular contact as described above, the criterion is satisfied. Alternatively, if the photo does not include a popular contact, the criterion is not satisfied. For instance, if the photo is taken at a location that is visited infrequently (e.g., less than 1 time a year), such as when the user of the electronic device is on vacation, the criterion is satisfied. As another example, if the electronic device takes more than a threshold number (e.g., 1, 3, 5, 10, 20, 50 or 100) of photos during the activity event, the criterion is satisfied, and is not satisfied otherwise

In some embodiments, the one or more criteria include a criterion that is satisfied based on one or more of operations performed by a second electronic device associated with the user of the electronic device, wherein the operations are associated with the activity event, such as if a smart watch was worn at the zoo and counted steps while carrying device 500B of FIG. 6PP. For instance, if the second electronic device is a watch that is associated with the electronic device (e.g., both the electronic device and the second electronic device are logged into and/or configured with the same user account or user profile), and the operations are recording a workout activity (optionally more than a threshold number of times, such as 1, 3, 5, 10 or 20, during a time period such as 6 hours, 12 hours, 1 day, 3 days, 7 days or 30 days), the criterion is satisfied. In some embodiments, if the second electronic device is a watch and the operations are playing a song that the electronic device plays frequently (e.g., more than 5, 7, or 10 times a day), the criterion is satisfied. If, on the other hand, the second electronic device (e.g., a watch) performs operations that do not substantially differ from operations performed by the second electronic device on an average day, the criterion is not satisfied.

In some embodiments, the one or more criteria include a criterion that is satisfied based on one or more of content accessed by the electronic device that is associated with the activity event, such as calling Mom in FIG. 6G. For instance, if the electronic device detects calling a popular contact as described above during or following the activity event (e.g., a contact that was present at the activity event), the criterion is satisfied. For instance, if the electronic device detects opening a photo during or following the activity event (e.g., a photo taken during the activity event), the criterion is satisfied.

In some embodiments, the one or more criteria include a criterion that is satisfied based on one or more of one or more applications the electronic device accessed that are associated with the activity event, such as opening the map application for the zoo trip in FIG. 6I. For instance, if the electronic device detects opening a fitness application during or following the activity event, the criterion is satisfied. For instance, if the electronic device detects opening a map application during or following the activity event, the criterion is satisfied. Providing a criteria for prompting the user allows for an efficient way for the user to recall details of the activity event, thus increasing the likelihood of engagement with the prompt and reduces wasting resources to display prompts or create journaling entries that are not useful.

In some embodiments, after detecting the activity event and after creating the journaling entry associated with the activity event in the journaling application, the electronic device displays, via the display generation component, a selectable option that is associated with the activity event, such as notification 676 in FIG. 6V. In some embodiments, the selectable option includes one or more representations of the activity event. In some embodiments, the selectable option includes text describing the activity event. In some embodiments, the selectable option is displayed on a wake screen user interface, a lock screen user interface, or a home screen user interface of the electronic device. In some embodiments, the user selectable option is selectable to initiate a process to view an animated video presentation associated with the journaling entry (e.g., of the content included in the journaling entry).

In some embodiments, while displaying the selectable option (e.g., 676) that is associated with the activity event, the electronic device receives, via the one or more input devices, a first input corresponding to selection of the selectable option, such as contact 603 in FIG. 6V. In some embodiments, the first input includes a click, a tap or a swipe input directed to the selectable option.

In some embodiments, in response to receiving the first input, the electronic device displays, via the display generation component, an animated video presentation associated with journaling entry, wherein the animated video presentation associated with the journaling entry includes one or more entries of the journaling entry and one or more content items associated with the activity event, such as animated video presentation 679 in FIG. 6W. In some embodiments, the content items are photos, achievements, representations of content items such as a route, text entries, and/or emoji entries that were entered into the journaling entry when it was created. In some embodiments, the electronic device displays the animated video presentation along with music. In some embodiments, the music was not part of the journaling entry (e.g., the electronic device did not detect input from the user to associate the music with the journaling entry). Thus, in some embodiments, the electronic device selects (automatically, without user input) the music to play along with displaying the animated video presentation. Providing the user with an option to view an animated video presentation for journaling entries provides for an efficient review of journaling entries and reduces the number of inputs needed to access the content of those journaling entries.

In some embodiments, displaying the selectable option (e.g., 638) includes in accordance with a determination that a current time of day at the electronic device satisfies one or more display criteria, the electronic device displays the selectable option, such as displaying prompt 638 in FIG. 6L outside of work hours (e.g., and not during work hours). For instance, if the current time of day is outside of work hours, the criteria is satisfied. In some embodiments, if the current time of day is at least a threshold of time (e.g., 15, 30, or 60 minutes) prior to the typical time of day where the user of the electronic device stops using the electronic device, the criteria is satisfied. In some embodiments, if the current time of day is at least a threshold of time (e.g., 15, 30, or 60 minutes) after a workout, the criteria is satisfied. In some embodiments, if the current time of day is at least a threshold of time (e.g., 1, 2, 5, or 7 days) after an activity event, the criteria is satisfied.

In some embodiments, in accordance with a determination that the current time of day at the electronic device does not satisfy the one or more display criteria, the electronic device forgoes displaying the selectable option (e.g., 678 in FIG. 6L). In some embodiments, if the current time of day is during work hours, the criteria is not satisfied. In some embodiments, if the current time of day is during an “evening time” where the user of the electronic device does not typically use the electronic device, the criteria is not satisfied. Displaying the selectable option at appropriate times increases the likelihood the user will engage with the selectable option, reduces wasting resources on displaying the selectable option when it is unlikely to be interacted with, and avoids interruption of device usage, thus reducing errors in usage.

In some embodiments, the selectable option (e.g., 676) is displayed on a user interface of the electronic device outside of the journaling application, such as user interface 602 in FIG. 6V. In some embodiments, the selectable option is displayed on a wake screen user interface, a lock screen user interface, a user interface of an application other than the journaling application (e.g., a photos application, a messaging application, an email application and/or a movie/television show playback application) or a home screen user interface of the electronic device.

In some embodiments, the selectable option is displayed on a user interface of the journaling application, such as if notification 676 of FIG. 6V is displayed within user interface 606 of FIG. 6T. In some embodiments, the selectable option is displayed within the user interface of the journaling application. In some embodiments, the selectable option is displayed within a separate tab of the user interface of the journaling application. Displaying the selectable option for the animated video presentation in different user interfaces increases the likelihood of user interaction, thus reducing the number of inputs to view the animated video presentation and reduces wasting resources on displaying the selectable option when it is unlikely to be interacted with.

In some embodiments, the animated video presentation associated with the journaling entry includes first party content, third party content, or both, such as that animated video presentation 679 of FIG. 6W includes Photo 1 and Photo 2 but also included online reviews for the zoo. In some embodiments, the first party content is content stored on the electronic device such as key photos, songs, web searches, photos, people and/or faces, names, routes and/or maps, and locations. In some embodiments, the third party content is stored on a separate electronic device or server such as online reviews and online photos. For instance, the animated video presentation optionally includes a map taken to the activity event, photos from the activity event, and also displays names of the people involved in the activity event or reviews about a restaurant visited during the activity event, where the reviews are optionally downloaded from a third party server that includes reviews, photos and/or other (optionally crowd-sourced) information about restaurants, including the visited restaurant. Expanding the content associated with the journaling entry to include multiple sources of content provides for a more comprehensive animated video presentation, and reduces the need for further input to manually search for additional information related to the activity event and/or journaling entry.

In some embodiments, the displaying of the animated video presentation associated with the journaling entry includes presenting music, such as shown in FIG. 6W (e.g., playing the music concurrently with displaying the animated video presentation). In some embodiments, the electronic device auto-selects the music (e.g., without user input for selecting the music). In some embodiments, the electronic device selects the music based on the journaling entry. For instance, if the journaling entry is about an outside fun activity, the electronic device will optionally select upbeat music for the animated video presentation. In some embodiments, the electronic device includes a user selectable option as part of the animated presentation for the user to change the music. Incorporating music into the animated video presentation avoids the need for additional user input to play music along with the animated presentation.

In some embodiments, the prompt is displayed, via the display generation component, in a widget displayed in a system user interface of the electronic device, such as notification 683 (e.g., widget) in FIG. 6Y. In some embodiments, the widget is displayed on the home screen user interface of the electronic device. In some embodiments, the widget is displayed on a side screen user interface of the electronic device (e.g., a user interface that includes one or more widgets for different applications, including the widget including the prompt). In some embodiments, the widget includes the same information included in the prompt. In some embodiments, the widget includes a portion of the information included in the prompt. Displaying the prompt in a widget increases the likelihood the user will interact therewith, and reduces wasting resources on displaying the selectable option when it is unlikely to be interacted with.

In some embodiments, the prompt is displayed in a first application other than the journaling application, such as if notification 676 of FIG. 6V is displayed within the application that corresponds to application icon 620 of FIG. 6A. In some embodiments, the first application is a notes application, a music application, a fitness application, a maps application, a photos application, a content viewing application or any other application other than the journaling application. In some embodiments, the prompt is displayed in the first application based on the activity event being associated with the first application. For instance, if the electronic device detects accomplishment of an achievement defined by a fitness application on the device as an activity event (or part of the activity event), a prompt is optionally displayed in the fitness application. As another example, if usage of an application (or more applications) is determined by the electronic device to be part of the activity event, the prompt is optionally displayed in that application (or the more applications). In some embodiments, the prompt is displayed in the first application merely because the electronic device is displaying a user interface of the first application at the time the prompt is to be displayed. Prompting the user while the electronic device is displaying an application other than the journaling application increases the likelihood the user will interact with the prompt, and reduces the number of inputs to create journaling entries.

In some embodiments, the electronic device receives, via the one or more input devices, a first user input directed to the prompt (e.g., 638 in FIG. 6L). In some embodiments, the first user input includes a click, a tap or a swipe input directed to the prompt.

In some embodiments, in response to receiving the first user input, the electronic device displays, via the display generation component, information related to the activity event without ceasing display of the first application, such as if the electronic device receives an input to a prompt in the application that corresponds to application icon 620 in FIG. 6A, a separate user interface would be overlaid on application that corresponds to application icon 620. In some embodiments, the information is concurrently displayed with the first application in a separate user interface within or overlaid on the first application. In some embodiments, the electronic device enables the user to switch between the first application and the separate user interface. Providing the user with a way to interact with the prompt and not leave the first application does not disrupt the user's interaction with the first application, reduces the number of inputs to return to the first application, and reduces errors in device usage.

In some embodiments, the journaling entry is accessible via the journaling application, such as representation 670 in FIG. 6T. In some embodiments, the journaling entry is viewable via the journaling application. In some embodiments, the journaling entry is searchable via the journaling application. In some embodiments, the journaling entry is accessible via the journaling application. Storing the journaling entries in the journaling application provides the user with an accessible repository to access the journaling entries at a later date, thus reducing the number of inputs needed to access journaling entries.

In some embodiments, the prompt is displayed as a notification on the electronic device, such as prompt 638 in FIG. 6L. In some embodiments, the prompt is displayed, as a notification, on a lock screen or other user interface. Thus, in some embodiments, the prompt is displayed as a notification in the same manner and/or in the same user interfaces that notifications for other applications (e.g., email application, messaging application, phone application, and/or calendar applications) are displayed. Displaying the prompt as a notification provides the user with an accessible and consistent alert, thus reducing the number of inputs to create a journaling entry and reducing errors in device usage.

In some embodiments, in response to detecting the activity event associated with the user, and in accordance with the determination that the activity event satisfies the one or more criteria, the electronic device initiates a process to display a second prompt associated with the journaling application on a second electronic device associated with the electronic device (e.g., the electronic device and the second electronic device are both logged into and/or configured with the same user account or user profile), where input directed to the second prompt initiates a process to provide input for the journaling entry associated with the activity event in the journaling application, such as prompt 609 and contact 603 in FIG. 6PP. In some embodiments, the second electronic device is a watch and the electronic device is a phone. Thus, the second prompt is optionally displayed on the watch and includes sample responses to the second prompt in the form of one or more emojis. In some embodiments, upon user selection of an emoji or the one or more emojis as responses, the electronic device creates the journaling entry with those emoji responses included. In some embodiments, if the second prompt is displayed on the second electronic device, the prompt is not displayed on the electronic device. In some embodiments, if the prompt is displayed on the electronic device, the second prompt is not displayed on the second electronic device. In some embodiments, the prompt is displayed on the electronic device and the second prompt is displayed on the second electronic device. Prompting the user on a different electronic device that is associated with the electronic device increases the likelihood the user will interact with the prompt, thus reducing the number of inputs to create a journaling entry.

In some embodiments, the prompt displayed by the electronic device is configured to accept input of a first type and a second type, such as device 500A in FIG. 6L. In some embodiments, the first type is an emoji input and the second type is a text (e.g., prose) input. For instance, if the electronic device is a phone, the phone displays a prompt that is optionally configured to receive both emoji inputs (e.g., from an emoji keyboard displayed by the phone) and/or text inputs (e.g., from a text keyboard displayed by the phone).

In some embodiments, the second prompt displayed by the second electronic device is configured to accept input of the first type but not the second type, such as selectable option 611a-611c in FIG. 6QQ. For instance, if the second electronic device is a watch that is associated with the phone (e.g., as described previously), the watch displays a prompt that is optionally configured to receive emoji inputs (e.g., from an emoji keyboard displayed by the phone) but not text inputs (e.g., because the watch does not display a text keyboard with the prompt). Providing the user with different input options for different prompts ensures the prompts occupy appropriate screen size for the respective devices on which they are displayed.

It should be understood that the particular order in which the operations in FIG. 7 has been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, detecting operation 702a and displaying operation 702c are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIGS. 8A-8C depict a flow for creating a first journal entry in a journaling application (e.g., to assist a user in creating their first journal entry), such as the journaling application described with reference to methods 700, 900, and 1000.

FIG. 8A illustrates an exemplary device 500A that includes touch screen 504A and is displaying a user interface 802, which corresponds to user interface 602 shown in FIG. 6A. User interface 802 includes application icon 655, which corresponds to a journaling application for creating and accessing journaling entries as described with reference to FIG. 6A.

In FIG. 8A, device 500A detects selection of application icon 655 (e.g., via contact 803). In some embodiments, in response to detecting the selection of application icon 655 and in accordance with a determination that the user has not previously saved a journal entry (e.g., the user is invoking the journaling application for the first time), device 500a displays user interface 806 as shown in FIG. 8B, optionally after displaying an authentication user interface such as described with reference to FIG. 6B.

User interface 806 includes affordances 808a, 808b, and 808c that indicate, to the user, various options the user has for creating a journal entry. User interface 806 includes affordance 808d, which is selectable to initiate creation of a new journal entry.

In response to detecting a selection of affordance 808d, device 500A displays journal entry user interface 810 as shown in FIG. 8C to allow the user to create a new journal entry. Journal entry user interface 810 is optionally a user interface of the journaling application. Journal entry user interface 810 includes journal entry field 812 for adding text and/or content items to a journal entry. In some embodiments, journal entry field 812 has one or more of the characteristics of text entry field 644 described with reference to FIG. 6M. Content items that can be added to a journal entry using journal entry user interface 810 (and/or other user interfaces described herein) include, for example, photos, videos, audio clips, locations (e.g., routes or specific locations that have previously been mapped or otherwise captured by device 500A), some or all of a text message conversation, phone calls (e.g., a date, time, and/or duration of a phone call, along with the name of the caller/callee), fitness activities, songs, playlists, books, articles, podcasts, health metrics, images of electronic tickets, links to any of these types of content, and/or or other types of content items that are generated by and/or accessible to device 500A.

Journal entry user interface 810 includes moments icon 814a, camera icon 814b, photo library icon 814c, audio clip icon 814d, and location icon 814e, which collectively provide a navigation user interface as described below.

Moments icon 814a, when selected, causes device 500A to display one or more “moments” each including one or more related content items as described with reference to FIG. 8E. In some embodiments, moments are collections of one or more related content items, such as content items having the same date or that are associated with the same event. In some embodiments. device 500A generates, identifies, and/or stores moments (e.g., collections of one or more related content items) on device 500 (e.g., in the journaling application) based on analysis of content items stored on and/or accessible to device 500A, such as by identifying content items that are associated with a particular date or event that may be of interest to the user. For example, device 500A may determine that several photos in the user's camera roll, a text message conversation between the user and another person, and a location that was visited by the user are all associated with the date of the user's birthday, and may group such content items into a birthday-related “moment.” Optionally, a moment includes, in addition to the content items, metadata associated with the content items, such as a date associated with the content items, a title associated with the content items, event data associated with the content items, a location associated with the content items, or other types of metadata. Optionally, device 500A determines and/or generates (e.g., automatically) the metadata based on information embedded in or associated with the content items (e.g., data captured and/or generated by an application associated with the content item). Optionally, device 500A generates, identifies, and/or stores moments without explicit inputs regarding content items to include in a moment from the user (e.g., device 500A generates moments automatically, in the background). As described herein, device 500A may present such “moments” to the user to prompt the user to create journal entries associated with the moments.

Photo library icon 814c, when selected by the user, displays thumbnails of the user's photo library in journal entry user interface 810 (e.g., below journal entry field 812) and allows the user to select one or more photos for inclusion in the journal entry, as described with reference to FIG. 8I. Camera icon 814b, when selected, causes device 500A to display a camera user interface that allows a user to capture a new photo and add it to the journal entry, as described with reference to FIGS. 8J-8K. Audio clip icon 814d, when selected, allows the user to record an audio clip and add it to a journal entry as described with reference to FIGS. 8L-8M. Location icon 814c, when selected, displays one or more location items (e.g., maps of previously recorded trips or locations of previous activities) and allows the user to select one or more of the location items for inclusion in journal entry field 812.

Journal entry user interface 810 optionally includes a suggested moment 816a (optionally, displayed below journal entry field 812) that includes multiple content items that have been determined (e.g., by device 500A and/or by another device), to be related to each other, such as by being associated with a single event, location, and/or date that may be considered a “moment” in the user's life. Suggested moment 816a may serve as a prompt to suggest, to the user, an activity or event to journal about. In the example of FIG. 8C, suggested moment 816a includes a first photograph 818a, a second photograph 818b, a location item 818c (e.g., a location or route on a map), an audio item 818d (e.g., an audio clip or song), and a media item 818c (e.g., a podcast or book). Other types of content items that are optionally included in a suggested moment include videos, text messages, fitness activities, or other types of content items generated by various applications. In some embodiments, in response to detecting a selection of suggested moment 816a (e.g., a tap on suggested moment 816a), moment 816a and/or representations of content items 818a-818e are added to journal entry field 812 and/or to a content entry region 817 (e.g., above journal entry field 812), as described with reference to FIGS. 8F-8G.

Journal entry user interface 810 also includes affordance 820, which when selected causes the content of the journal entry field to be saved as a journal entry (e.g., to the journaling application). Optionally, after saving a journal entry in response to detecting a selection of affordance 820, device 500A exits journal entry user interface 810 and optionally displays a journal timeline interface as described with reference to FIG. 8N.

In some embodiments, a user can initiate text entry into journal entry field 812 by selecting journal entry field 812 (e.g., by tapping within journal entry field 812). In response to detecting a selection of journal entry field 812, device 500A displays a soft keyboard 821 in user interface 810 to allow the user to enter text, as shown in FIG. 8D. Optionally, device 500A expands an area of journal entry field 812 within journal entry user interface 810 from a first area to a second area if the user enters more text than can fit in the first area of journal entry field 812. After entering the desired text and/or adding content items from the suggested moment 816a and/or using icons 814a-814e to the journal entry field 812, the user can save the journal entry (e.g., save the content in journal entry field) by selecting affordance 820.

In FIG. 8E, a user selects moments icon 814a (e.g., by tapping moments icon 814a) and device 500A responds by displaying moment 816b and moment 816c. Moment 816b includes multiple content items 818f-818j that are optionally associated with a first date (e.g., Dec. 7, 2022). Moment 816c includes a single content item 818k that is optionally associated with a second date (e.g., Nov. 30, 2022). Content items 818f-818j and 818k can include, for example, photos, videos, maps, audio clips, media content, or other types of content items. Content items 818f-818j and 818k are optionally displayed, in moments 816b and 816c (respectively) and or in journal entry field 812, as representations (e.g., thumbnails, excerpts, titles, or other representations) of content items 818f-818j and 818k rather than as the content items themselves.

A user can optionally select a moment (e.g., moment 816a or 816b) to add the moment (e.g., optionally including metadata) and/or content items of the moment to a journal entry. For example, in response to detecting that the user has selected moment 816b in FIG. 8E, device 500A displays representations of the content items 818f-818j of moment 816b in a separate region 817 (e.g., a content entry region) of user interface 810, such as above journal entry field 812, to indicate to the user that the user has selected moment 816a for (potential) inclusion in the journal entry. Optionally, user interface 810 displays content items 818f-818j with an option (e.g., an affordance, a checkbox, or another type of option) to individually remove one or more of the selected content items so that the selected content items will not be added to the journal entry. Optionally, in response to detecting selection of moment 816b, the computer system ceases to display moment 816b in its original location (e.g., below journal entry field 812 and/or below icons 814a-814c).

In the example of FIG. 8F, the user has indicated that content items 818g, 818i, and 818j are not to be added to (e.g., are to be excluded from) the journal entry by checking boxes that are displayed with content items 818g, 818i, and 818j. After the user has (optionally) indicated content items to be removed, the user can provide an input to add the remaining content items to the journal entry field 812, such as by tapping on the region 817 in which the content items 818f-818j are displayed or tapping in journal entry field 812. In response to detecting the user input, device 500A ceases to display content items 818f-818j in the region 817 above journal entry field 812, and displays content items 818f and 818h (or representations of content items 818f and 818h) in the journal entry field 812 (e.g., to be added to the journal entry), as shown in FIG. 8G. The user can then (optionally) enter text in the journal entry field 812, as shown in FIG. 8G, and save the journal entry including content items 818f and 818h and any entered text by selecting affordance 820. In some embodiments, the user can delete content items from journal entry field 812 before saving the journal entry, such as by selecting the content item to be deleted and providing a delete input.

In some embodiments, the user can select a date for the journal entry that is the same as or different from the date on which the journal entry is created. For example, as shown in FIG. 8H, device 500A optionally displays a default date 822 when a user begins to create a journal entry. The default date 822 is optionally today's date, a date associated with added moments or content items (e.g., moment 816b and/or content items 818f and 818g), or another default date that is selected by device 500A or configured by the user (e.g., as a configuration setting associated with the journaling application). In response to detecting a selection of default date 822 (such as a tap on date 822), device 500A displays a menu 824 of date options that optionally includes one or more of today's date 824a, date of moment 824b (e.g., a date associated with a moment added to the journal entry, such as the date that the user went on a hike corresponding to the moment), date from photos 824c (e.g., a date associated with a photo(s) added to the journal entry, such as the date that the photo(s) were taken by device 500A), and custom date 824d (e.g., a date of the user's choosing). In response to detecting a user selection of one of date options 824a-824d, device updates the default date 822 to the selected date, which will then be saved as the date of the journal entry. In some embodiments, menu 824 excludes (e.g., does not display) one or more of date options 824a-824d. For example, if the user has not added a moment and/or photo to the journal entry, menu 824 optionally excludes date options 824b and/or 824c, respectively. As another example, if the default date 822 is today's date, menu 824 optionally excludes date option 824a. In some embodiments, menu 824 always includes custom date 824d to allow the user to choose their own date for the journal entry.

FIG. 8I illustrates an example of allowing a user to select photos from a photo library to add to a journal entry. In FIG. 8H, the user selects photo library icon 814c in user interface 810. In response to detecting the selection of photo library icon 814c, in FIG. 8I, device 500A displays, in a region of user interface 810 (e.g., below journal entry field 812), representations (e.g., thumbnails) of photos 815a-815f from the user's photo library. The user can optionally select one or more of the photos 815a-815f for inclusion in journal entry field 812 (e.g., by tapping or clicking on one or more of the photos 815a-815f), such as to add the selected photos to a journal entry.

FIGS. 8J and 8K illustrate an example of using a camera user interface and/or application to capture a new photo and add it to a journal entry in the journaling application.

In FIG. 8H, the user selects camera icon 814b in user interface 810. In response to detecting the selection of camera icon 814b, in FIG. 8J, device 500A displays, in a region of user interface 810 (e.g., below journal entry field 812), a camera interface 828 having a preview pane 832 for displaying a live view from a camera of device 500A and a virtual button 830 for capturing a new photo or video, optionally along with other selectable options such as a video option, flash option, zoom option, or other options. Camera interface 828 is optionally displayed within the user interface of the journaling application. In response to detecting an activation of virtual button 830, device 500A captures a new photo using a camera of device 500A and optionally automatically (e.g., without additional user input) adds the new photo (e.g., new photo 834) to journal entry field 812, as shown in FIG. 8K. In some embodiments, in response to detecting an activation of virtual button 830 and after capturing the new photo, device 500A requests confirmation from the user before adding the new photo 834 to journal entry field 812. In some embodiments, when the new photo 834 is added to the journal entry field 812 (either automatically or in response to a user confirmation to add the new photo 834 to the journal entry field 812), device 500A ceases to display the camera interface 828 and optionally displays soft keyboard 821 to enable the user to add text to the journal entry field 812 (e.g., in addition to new photo 834).

Alternatively, if a video option is selected in camera interface 828, in response to detecting an activation of virtual button 830, device 500A begins to capture a new video using a camera of device 500A. In response to detecting a subsequent activation of virtual button 830, device 500A stops recording the new video and optionally adds the new video to journal entry field 812 (this process is not shown) in a manner similar to that described above and shown in FIG. 8J.

FIGS. 8L and 8M illustrate an example of using an audio capture application (e.g., a voice memo application or another audio capture application) to capture a new audio recording and add it to a journal entry.

In FIG. 8H, the user selects audio clip icon 814d in user interface 810. In response to detecting the selection of audio clip icon 814d, in FIG. 8L, device 500A displays, in a region of user interface 810 (e.g., below journal entry field 812), an audio capture interface 836 a virtual button 838 for capturing a new audio recording, optionally along with other selectable options such as a recording volume option. Audio capture interface 836 is optionally displayed in the user interface of the journaling application. In response to detecting a first activation of virtual button 838 (such as shown in FIG. 8L), device 500A begins to capture a new audio clip (e.g., “New Recording” shown in FIG. 8L) using a microphone of device 500A. Optionally, device 500A displays a dynamic elapsed time and/or an indication of the volume or spectral content of the audio recording as it is recorded. In response to detecting a second activation of virtual button 838, device 500A ceases to record the audio recording and optionally automatically (e.g., without additional user input) adds the new audio recording (e.g., new audio recording 840) to journal entry field 812, as shown in FIG. 8M. In some embodiments, new audio recording 840 can be played back and/or deleted after it is added to journal entry field 812. In some embodiments, in response to detecting the second activation of virtual button 838 and after capturing the new audio recording, device 500A requests confirmation from the user before adding the new audio recording 840 to journal entry field 812. In some embodiments, the new audio recording can be played back from the audio capture interface 836 (e.g., before adding to the journal entry field 812). In some embodiments, when the new audio recording 840 is added to the journal entry field 812 (either automatically or in response to a user confirmation to add the new audio recording 840 to the journal entry field 812), device 500A ceases to display the audio capture interface 836 and optionally displays soft keyboard 821 to enable the user to add text to the journal entry field 812 (e.g., in addition to new audio recording 840).

FIG. 8N depicts an example of a timeline user interface 842 of the journaling application. Optionally, timeline user interface 842 is displayed in response to a selection of the journaling application icon 655 from user interface 602 and/or in response to selection of affordance 820 in the journal entry user interface 810. Timeline user interface 842 displays a timeline of journal entry representations 844a-844c, such as representations of journal entries that were created using techniques described in FIGS. 8A-8L. Journal entry representations shown in timeline 842 optionally provide a preview of the corresponding journal entry by including representations of content items and/or text that are included in the corresponding journal entry, as depicted in journal entry representations 844a-844c. As shown in FIG. 8N, journal entries can include a combination of content items and text (e.g., journal entry representation 844a), content items only (e.g., journal entry representation 844b), or text only (e.g., journal entry representation 844c). Optionally, journal entry representations corresponding to journal entries that include longer text entries include a subset of the text of the journal entry. For example, journal entry representations optionally include the first 1, 2, 3, 4, 5, 6, 7, 8, 9, or 10 lines of the text of the corresponding journal entry. As previously discussed, content items in journal entries optionally include photos, videos, maps, fitness activities, podcasts (e.g., the podcast itself, a portion of the podcast, a link to the podcast, art associated with the podcast), text messages, books or articles (e.g., the book or article itself, a portion of the book or article, a link to the book or article, art associated with the book or article), or other types of content. In some embodiments, each journal entry indication 844a-844c is displayed with an associated date (e.g., the date associated with the journal entry).

Optionally, timeline user interface 842 displays journal entry representations 844a-844c in chronological order, with a journal entry representation corresponding to the most recently added journal entry shown at the top of timeline user interface 842. If the user has created more journal entries than are shown in a single screen, the user can scroll down to see additional journal entry representations.

Timeline user interface 842 optionally includes lookback affordance 848, which when selected, causes device 500A to display lookback selection interface in timeline user interface 842, as described with reference to FIG. 8O.

Timeline user interface 842 optionally includes add affordance 846, which when selected causes device 500A to display journal entry user interface 810 for adding a new journal entry.

Optionally, selection of a journal entry representation 844a-844c in timeline user interface 842 causes device 500A to display text and/or content items associated with the journal entry in a full-screen format, in which each content item and/or textual content is displayed in a full screen and the user can navigate between screens displaying content items by providing left/right swipe inputs. Optionally, selecting a content item in a journal entry 844a-844c displayed in timeline user interface 842 causes device 500A to display the selected content item in a full-screen interface. For example, selecting “Song 1” content item in journal entry 844b causes device 500A to display a full-screen music interface such as described with reference to FIG. 8R.

Timeline user interface 842 optionally includes moments affordance 850, which when selected causes device 500A to display a moments user interface, as described with reference to FIG. 8S.

FIG. 8O illustrates an example of displaying a lookback selection interface 852 in timeline user interface 842. In some embodiments, in response to detecting a selection of lookback affordance 848 (shown in FIG. 8N) in timeline user interface 842, device 500A displays a lookback selection interface 852 in timeline user interface 842, optionally at the top of timeline user interface 842, such as shown in FIG. 8O. Lookback selection interface 852 includes one or more lookback panes with representations of one or more types of lookbacks (e.g., Birthdays, On This Day, Significant Days, Highlighted Time Period). In some embodiments, a lookback includes a collage, slideshow, animated video, or other form of visual (and optionally, audible) presentation generated by device 500A based on one or more previously created journal entries (e.g., including content items and/or text in one or more journal entries) that are associated with a particular date or event. For example, a Birthday lookback optionally includes journal entries having a date that is associated with the user's (or someone else's) birthday. An “On This Day” lookback optionally includes one or more journal entries having the same month and day as the current date. A “Significant Day” lookback optionally includes one or more journal entries have a date that is determined, by device 500A or by the user, to be significant, such as a date on which the user got married or started a new job. A “Highlighted Time Period” lookback includes one or more journal entries having dates that have been determined by device 500A or the user to be associated with a particular period of time or multi-day event that is potentially of interest, such as “Fall in Sweden.” A “Media Focus” lookback includes one or more journal entries having dates that have been determined by device 500A or the user to be associated with a particular period of time or multi-day event and that include (or reference) music and/or videos played during that time period or event. In some embodiments, a lookback has one or more of the characteristics of animated video presentation 679 described with reference to FIG. 6V and/or method 700.

In the example of FIG. 8O, lookback selection interface 852 includes a first lookback pane 852a associated with “Birthdays” lookbacks and a second lookback pane 856b associated with “On This Day” lookbacks. In some embodiments, lookback selection interface 852 is horizontally scrollable to navigate to additional lookback panes, such as lookback panes associated with Significant Days lookbacks and/or Highlighted Time Period lookbacks.

In some embodiments, lookback panes 852a-852b are selectable to cause device 500A to display a full screen of selectable lookback representations of the selected lookback type, where each lookback option is associated with a particular lookback. For example, in response to detecting a selection of lookback pane 856a, device 500A optionally displays one or more Birthday lookback representations 857a-857c, each of which is associated with a “Birthday” lookback. A user can select a particular lookback option to display the associated Birthday lookback (e.g., to play the animated video or display the collage).

In some examples, in response to detecting a selection of affordance 854 in lookback selection interface 843 in FIG. 8O, device 500A displays lookback interface 858 as shown in FIG. 8P. Lookback interface 858 optionally displays lookback representations 860a-860e that are associated with representative lookbacks of the different types of lookbacks, and optionally displays a quantity of lookbacks associated with the different types of lookbacks. In the example of FIG. 8P, there are four “Significant Day” lookbacks, two “On This Day” lookbacks, three “Birthday” lookbacks, one “Highlighted Time Period” lookback, and three “Media Focus” lookbacks. In some embodiments, lookback representations 860a-860e include content items (or representations of content items) and/or text associated with the representative lookback.

In some embodiments, lookback representations 860a-860d of FIG. 8P are optionally horizontally scrollable to reveal additional lookback representations of the same lookback type. For example, horizontally scrolling lookback option 860a optionally reveals one or more additional “Birthday” lookback representations that can be selected to display the corresponding lookback.

In some embodiments, lookback representations 860a-860d are selectable to cause device 500A to display the corresponding representative lookback, such as in the case when there is a single lookback associated with the selected type. In some embodiments, lookback representations 860a-860d are selectable to cause device 500A to display additional lookbacks of the same lookback type (including the representative lookback), such as in the case when there are multiple lookbacks associated with the selected type. For example, in response to detecting a selection of lookback representation 860b in FIG. 8P (corresponding to an “One This Day” lookback type, which has two associated lookbacks in the example of FIG. 8P), device 500A optionally displays lookback type user interface 862 with lookback representations 860b and 860e associated with “On This Day” lookbacks, as shown in FIG. 8Q.

Returning to FIG. 8N and timeline user interface 842, as previously discussed, in some embodiments moments and/or representations of content items (e.g., representations of content items 818f and 818h shown in FIG. 8N) are selectable to cause device 500A to display the corresponding content item(s) (or a representation of the content item) in a full-screen interface, optionally with the ability to navigate between different content items in the moment by left/right swiping. For example, in response to detecting a selection of content item representation 818h in FIG. 8M (which is, optionally, a representation of a song, such as the title of the song, cover art associated with the song, or another type of representation), device 500A optionally displays content user interface 864, as shown in FIG. 8R.

Content user interface 864 includes a second content item representation 866, which may be the same as or different than content item representation 843b displayed in timeline user interface 842. In some embodiments, content item representation 866 is larger than content item representation 843b.

Content user interface 864 optionally includes editing affordance 868, which when selected, allows the user to edit the content item included in the journal entry and represented by content item representation 866. Additionally or alternatively, selection of editing affordance 868 allows the user to edit the journal entry that includes the content item, such as to add text to the journal entry (optionally to be associated with the content item).

In some embodiments, if the content item represented by content item representation 866 is playable (e.g., it is a video, an audio recording, or another type of playable content) it can be played from content user interface 864 without launching an application associated with the content item. In some embodiments, if the content item represented by content item representation 866 is playable, content user interface 864 includes playback affordance 870, which when selected, causes the content item represented by content item representation 866 to play (e.g., by playing Song 1, in the example of FIG. 8R) while remaining within content user interface 864. In some embodiments, content user interface 864 forgoes display of playback affordance 870 if the content item is not playable, such as if the content item is a photograph or map.

In some embodiments, content user interface 864 includes application icon (and/or button) 872 which, when selected, causes device 500A to launch an application associated with the content item represented by content item representation 866. For example, if the content item is a song (as shown in FIG. 8R), selection of application icon 872 optionally causes device 500A to launch a music-playing application associated with the song. Other types of content items included in a journal entry may be associated with other types of applications, such as photo-editing applications, voice memo applications, text message applications, or fitness applications, that may similarly be launched by device 500A in response to detecting selection of application icon 872. For example, if a content item in a journal entry is a portion of a text message conversation, the content user interface 864 optionally reproduces, in a full screen, the portion of the text message conversation that is included in the journal entry. If the user selects application icon 872, device 500A launches the corresponding text messaging application and navigates (e.g., automatically, without input from the user) to the portion of the conversation that is included in the journal entry.

Returning again to FIG. 8N and timeline user interface 842, as previously discussed, in some embodiments moments affordance 850 is selectable to cause device 500A to display a moments user interface, shown in FIG. 8S.

Moments user interface 874 includes one or more moments 876a-876c, each of which is, optionally, associated with a moment date 884a-884c and includes text and/or representations of one or more content items (e.g., content item representations 878a-878c, 880a-880b, 882a-882d). As previously discussed, in some embodiments, device 500A generates moments 876a-876c based on analysis of content items stored and/or accessible on device 500A, such as by identifying content items that are associated with a particular date or event that may be of interest to the user. In some embodiments, moments 876a-876c that are displayed in moment user interface 874 are moments that have not previously been journaled about by the user (e.g., are not included in a journal entry in the journaling application) and are provided to prompt the user to select a moment to journal about (e.g., to include in a journal entry).

In the example of FIG. 8S, moments user interface 874 includes icons or buttons 886a-886d, which are selectable to cause device 500A to select (e.g., filter) which moments and/or prompts to present in moments user interface 874. For example, in response to selection of icon 886a (as shown in FIG. 8S), device 500A displays moments that are recommended by device 500A, such as based on analysis of previous activities or indications of interests of the user. For example, in response to selection of icon 886b, device 500A displays moments that are associated with recent dates, such as dates within the last day, week, month, or year. For example, in response to selection of icon 886c, device 500A optionally displays one or more textual prompts to encourage the user to create a journal entry and provide a topic. An example of such a prompt would be “What are you thankful for today?” For example, in response to selection of icon 886d, device 500A optionally displays representations of one or more media items (e.g., books, songs, articles, podcasts, or other types of media content) that the user may wish to include in a journal entry. In response to detecting a selection of a displayed moment, prompt, or representation of a media item in moments user interface 874, device 500A optionally displays journal entry user interface 810 with the selected moment, prompt or media item displayed above journal entry field 812 (e.g., as shown in FIG. 8F) or within journal entry field 812 (e.g., as shown in FIG. 8G), thereby providing a simple way for the user to journal about the selected item.

In some embodiments, in response to detecting selection of a moment 876a-876c, device 500A displays a menu that allows the user to create a journal entry that includes the moment and/or content items in the moment, as shown in FIG. 8T.

As shown in FIG. 8T, in response to detecting a selection of moment 876b, device 500A displays menu 884 that includes a first selectable option 884a and a second selectable option 884b.

In response to detecting selection of option 884a, device 500a creates a new journal entry that includes the content items represented by content item representations 880a-880b and saves the journal entry (e.g., without the user providing additional inputs). Optionally, device 500A saves the journal entry while continuing to display moments user interface 874, without displaying journal entry user interface 810.

In some embodiments, in response to detecting selection of option 884b, device 500a displays journal entry user interface 810 with the selected moment and/or content item representations 880a-880b displayed in journal entry field 812 (e.g., in a manner similar to that shown in FIG. 8G) or above journal entry field 812 (e.g., in a manner similar to that shown in FIG. 8F). The user can then add text, add additional content items, or save the journal entry as described with reference to FIGS. 8C-8L.

In some embodiments, a user can configure the journaling application and/or device 500A to display or provide notifications (which may be referred to as “nudges”) that remind or encourage the user to create or review journal entries. For example, a user can invoke display of a nudges user interface 886 as shown in FIG. 8U, such as from a configuration settings menu associated with the journaling application, to configure the journaling application to send reminder notifications in accordance with various criteria.

Nudges user interface 886 optionally includes one or more selectable options 888a-888d that can be selected, by the user, to cause device 500A to display notifications associated with the options 888a-888d. Such notifications are optionally displayed in a visual manner similar to that shown in FIG. 6V and/or described with reference to method 700, for example.

In some embodiments, selection of option 888a configures device 500A to display scheduled reminder notifications in accordance with a schedule (e.g., a schedule provided by the user or determined by device 500A). For example, selection of option 888a optionally configures device 500A to display reminder notifications at a specified time daily, weekly, or monthly, or in accordance with another schedule. In some embodiments, device 500A determines, at the specified reminder notification time, whether one or more criteria are met that indicate whether the user is likely to want to receive a reminder notification at the scheduled time. For example, device 500A optionally determines whether device 500A is operating in a notification suppression mode, or if a calendar application on device 500A indicates that the user is in a meeting, or if a telephone application indicates that the user is on a call. Optionally, device 500A temporarily or permanently suppresses the reminder notification in accordance with a determination that the one or more criteria are met, and optionally provides the notification later after the one or more criteria are no longer met.

In some embodiments, such reminder notifications optionally include saved moment notifications, lookback notifications, and/or system moment notifications described in more detail below. Scheduled reminder notifications optionally include a prompt to create a journal entry and/or a suggested topic for a journal entry. In some embodiments, in response to detecting selection of a scheduled reminder notification, device 500A displays journal entry user interface 810, such as shown in FIG. 8C.

In some embodiments, selection of option 888b configures device 500A to display saved moment notifications associated with moments that have been saved in a journal entry by the user (e.g., using a “quick add” function) but have not been written about by the user. In some embodiments, device 500A displays saved moment notifications associated in accordance with a schedule. In some embodiments, saved moment notifications include one or more representations of content items that are associated with one or more saved moments. In some embodiments, in response to detecting selection of a saved moment notification, device 500a displays journal entry user interface 810 with content item representations associated with the saved moment displayed in journal entry field 812 (e.g., in a manner similar to that shown in FIG. 8G). The user can then add text, add additional content items, or save the journal entry as described with reference to FIGS. 8C-8M.

In some embodiments, selection of option 888c configures device 500A to display lookback notifications associated with one or more existing journal entries. In some embodiments, device 500A displays lookback notifications in accordance with a schedule and/or in accordance with a determination that a journal entry is associated with the same month and day as the current month and day. In some embodiments, in response to detecting selection of a lookback notification, device 500A displays the corresponding lookback associated with one or more journal entries.

In some embodiments, selection of option 888d configures device 500A to display system moment notifications associated with new moments that are generated, identified and/or saved by device 500 and have not yet been added by the user to a journal entry. In some embodiments, device 500A displays system moment notifications in accordance with a schedule and/or when one or more new moments are generated, identified, and/or saved by device 500A. In some embodiments, system moment notifications include one or more representations of related content items (e.g., content items having the same date, location, or other indication of relatedness). In some embodiments, in response to detecting selection of a system moment notification, device 500A displays a moments user interface (e.g., moments user interface 874 of FIG. 8T) that includes the system moment. In some embodiments, in response to detecting selection of a system moment notification, device 500a displays journal entry user interface 810 with content item representations associated with the system moment displayed in journal entry field 812 (e.g., in a manner similar to that shown in FIG. 8G) or above journal entry field 812 (e.g., in a manner similar to that shown in FIG. 8F). The user can then add text, add additional content items, or save the journal entry as described with reference to FIGS. 8C-8M.

In some embodiments, instead of and/or in addition to being displayed as a notification, device 500A displays reminders (e.g., corresponding to the above-described notifications) to create and/or review journal entries in (or in the form of) a widget associated with the journaling application. For example, in FIG. 8V, device 500A displays a prompt to journal about a moment (e.g., a saved moment or system moment that includes content items represented by content item representations 892a and 892b) in widget 890 in user interface 802 (e.g., a home screen user interface of device 500A). Widget 890 includes a prompt to journal about the moment. In some embodiments, in response to detecting selection of widget 890, device 500a displays journal entry user interface 810 with content item representations 892a-892b displayed in journal entry field 812 (e.g., in a manner similar to that shown in FIG. 8G) or above journal entry field 812 (e.g., in a manner similar to that shown in FIG. 8F). The user can then add text, add additional content items, or save the journal entry as described with reference to FIGS. 8C-8M.

In some embodiments, if device 500A identifies a saved moment notification, lookback notification, and/or system moment notification within a predetermined time period of a scheduled reminder notification, device 500A waits to display the saved moment notification, lookback notification, and/or system moment notification until the scheduled reminder time. For example, device 500A optionally batches notifications for display at a scheduled reminder time, if device 500A is configured to provide scheduled reminder notifications.

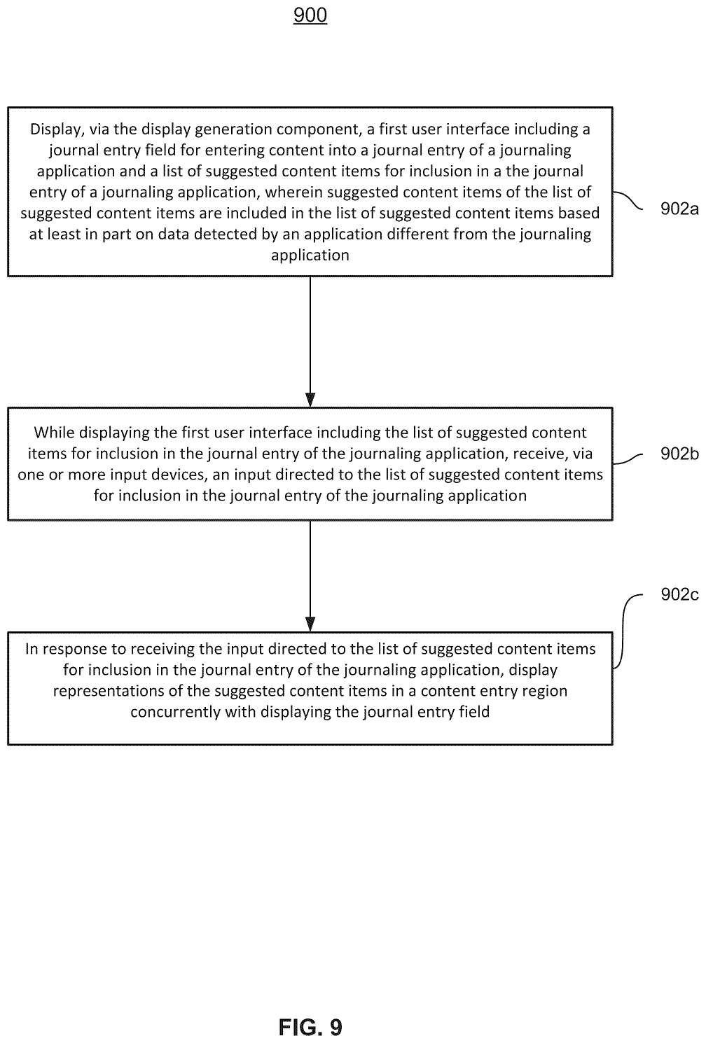

FIG. 9 is a flow diagram illustrating a method 900 of displaying user interfaces for journaling in accordance with some embodiments, such as in FIGS. 8A-8V. The method 900 is optionally performed at an electronic device such as device 100, device 300, or device 500 as described above with reference to FIGS. 1A-1B, 2-3, 4A-4B and 5A-5H. Some operations in method 900 are optionally combined and/or the order of some operations is, optionally, changed.

In some embodiments, method 900 is performed at an electronic device in communication with a display generation component and one or more input devices. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 900 is performed at or by an automobile (e.g., at an infotainment system of an automobile having or in communication with one or more display generation components and/or input devices).

In some embodiments, the electronic device displays (902a), via the display generation component, a first user interface (e.g., user interface 810 of FIG. 8C or 8E) including a journal entry field (e.g., journal entry field 812 of FIG. 8E) for entering content into a journal entry of a journaling application (e.g., journal entry representation 844a of FIG. 8M) and a list (e.g., moment 816b of FIG. 8E) of suggested content items (e.g., content items 818f-818j) for inclusion in the journal entry, wherein suggested content items of the list of suggested content items are included in the list of suggested content items based at least in part on data detected by an application different from the journaling application (such as a date of the content item, a location of the content item, a person associated with the content item, an event associated with the content item, or other types of data).

For example, content items 818f-818j are selected (e.g., by the electronic device) for inclusion in moment 816b because they are associated with the same date, where the date is detected by an application associated with the content item (e.g., a photo capture application, a mapping application, or another type of application). In some embodiments, the list of suggested content items includes graphical and/or textual representations of one or more of the content items, such as a photo or video thumbnail, a map thumbnail, a song or book title, an excerpt of a message (e.g., a text message or email message), an event title, a date, a name of a person, a representation of an audio signal, or another type of representation of the content item. In some embodiments, the list of suggested content items is shown within a visual boundary (e.g., within a rectangle, oval, circle, or other type of boundary) to indicate that the content items are part of the list of suggested content items. In some embodiments, the list of suggested content items includes and/or is displayed with a date associated with the list of suggested content items, such as the date “Dec. 7, 2022” associated with moment 816b in FIG. 8E and displayed as part of moment 816b. For example, the date is optionally a date on which one or more of the content items occurred, were captured, were shared (e.g., either to the user of the electronic device or by the user of the electronic device), and/or with which the content items are otherwise associated.

In some embodiments, while displaying the first user interface including the list of suggested content items for inclusion in the journal entry of the journaling application, such as suggested moments 816b and 816c in FIG. 8E, the electronic device receives (902b), via the one or more input devices, an input directed to the list of suggested content for inclusion in the journal entry of the journaling application, such as a touch contact input, a button input, a voice input, or another type of input selecting suggested moment 816b in FIG. 8E. For example, a user can optionally select a moment for inclusion by touching anywhere on the moment (e.g., on a touchscreen), by clicking on the moment, by verbally selecting the moment (such as by saying “select the moment associated with the date of Dec. 7, 2022”), by providing an air hand gesture (such as an air pinch gesture) directed to the moment, and/or by directing their attention to the moment (e.g., such as in an augmented reality or virtual reality application with gaze detection, in which the electronic device can detect that the user is looking at the moment).

In some embodiments, in response to receiving the input directed to the list of suggested content items for inclusion in the journal entry of the journaling application, the electronic device displays (902c) representations of the suggested content items in a content entry region concurrently with displaying the journal entry field, such as illustrated with representations of content items in suggested moment 816b being displayed in content entry region 817 of FIG. 8G above journal entry field 812 (e.g., while journal entry field 812 is concurrently displayed). Optionally, in response to receiving the input directed to the list of suggested content items for inclusion in the journal entry of the journaling application, the electronic device ceases to display the list of suggested content items (e.g., ceases to display moment 816b below the journal entry field).

In some embodiments, the electronic device concurrently displays, via the display generation component: the first user interface including the journal entry field and the list of suggested content items for inclusion in the journal entry of the journaling application, such as suggested moments 816b and 816c in FIG. 8E, and a navigation user interface including a plurality of selectable user interface elements (e.g., a navigation user interface that includes icons 814b through 814e of FIG. 8C) that are respectively selectable to initiate a process to cause the electronic device to forgo displaying (e.g., cease to display or not display), via the display generation component, the list of suggested content items for inclusion in the journal entry of the journaling application (e.g., ceasing to display suggested moments 816b and 816c in FIG. 8E) and display, via the display generation component, content of a respective type for inclusion in the journal entry of the journaling application without displaying content of a type different from the respective type. For example, while displaying the user interface 810 of FIG. 8E including suggested moments 816b and 816c in FIG. 8E, the electronic device receives an input selecting photos icon 814c of FIG. 8E, and in response, displays thumbnails of the user's photos (e.g., below journal entry field 812) such as shown in FIG. 8I, optionally ceasing to display moments 816b and 816c. For example, while displaying the user interface 810 of FIG. 8E including suggested moments 816b and 816c in FIG. 8E, the electronic device receives an input selecting camera icon 814b of FIG. 8E. In response to detecting selection of camera icon 814b, the electronic device ceases to display suggested moments 816b and 816c in FIG. 8E and displays, as illustrated in FIG. 8J, a camera interface 828 having a preview pane 832 for displaying a live view from a camera of the device, and including a virtual button 830 for capturing a photo or video for inclusion in journal entry field 812. In some embodiments, in response to detecting a selection of one of the selectable user interface elements (e.g., icons 814a-814c), the electronic device ceases to display a keyboard (e.g., keyboard 821 of FIG. 8F) and/or replaces display of a keyboard with display of the content of the respective type.

In some embodiments, in response to receiving the input directed to the list of suggested content items for inclusion in the journal entry of the journaling application, the device displays a keyboard for entering keyboard content into the journal entry field of the second user interface concurrently with displaying the representations of the suggested content items in the content entry region, such as illustrated in FIG. 8F with suggested moment 816b displayed in content entry region 817 while keyboard 821 is concurrently displayed.

In some embodiments, the first suggested content items include a first content item and a second content item, such as content item 818f and content item 818g in FIG. 8F. In some embodiments, the first content item and the second content item are associated with (e.g., captured by and/or accessed via) the application different from the journaling application, such as content items 818f and 818g in FIG. 8F being photos (e.g., associated with a photo application different from the journaling application), or the first content item is associated with the application different from the journaling application and the second content item is associated with a second application different from the first application, such as the content item 818f in FIG. 8F being a photo captured by a photo application, and content item 818g in FIG. 8F is being music (e.g., a song) associated with a music application. In some embodiments, displaying representations of the suggested content items in the content entry region of the journaling application includes displaying a representation of the first content item and a representation of the second content item in the content entry region (optionally, along with other content items from the same moment, such as content items 818h, 818i, and 818j) in the content entry region, such as representations of content items 818f and 818g in FIG. 8F being displayed in the content entry region 817 of the user interface 810 as described above with reference to FIG. 8F. In some embodiments, after displaying the representation of the first content item and the representation of the second content item in the content entry region, detecting, via the one or more input devices, a second input requesting to remove the first content item from the content entry region (e.g., to exclude the first content item from being added to the journal entry field), such as an input selecting content item 818g in FIG. 8F for removal as illustrated with the checked box in content item 818g. In some embodiments, in response to detecting the second input requesting to remove the first content item from the content entry region, the device ceases to display the representation of the first content item in the content entry region without ceasing to display (e.g., while maintaining display of) the representation of the second content in the content entry region. For example, the user can optionally remove some or all of the content items from the content entry region before adding the (remaining) content items in the content entry region to the journal entry.

In some embodiments, after detecting the second input requesting to remove the first content item from the content entry region, the electronic device detects a user input corresponding to a request to add the content items in the content entry region to the journal entry field (e.g., such as a tap on content entry region 817 in FIG. 8F, optionally after removing some of the content items from the content entry region 817), and in response to detecting the user input corresponding to a request to add the content items to the journal entry field, the electronic device displays representations of one or more of the content items of the first suggested content items in the journal entry field, including the second content item and excluding the first content item. For example, in the example of FIG. 8G, the electronic device detects a user input corresponding to a request to add content items of moment 816b to journal entry field 812 while content items 818g, 818i, and 818, are marked for exclusion (or optionally have already been removed from content entry region 817). In response to detecting the user input corresponding to the request to add moment 816b to the journal entry field 812, the electronic device displays representations of content items 818f and 818h in journal entry field 812 as shown in FIG. 8H, and optionally ceases to display content items 818f-818j in content entry region 817, and/or ceases to display content entry region 817. In some embodiments, after displaying representations of content items in the journal entry field 812, the electronic device detects a selection of an affordance (e.g., affordance 820 in FIG. 8G), and in response to detecting the selection of the affordance, saves the content that is displayed in the journal entry field (e.g., text content and/or content items) as a journal entry (e.g., to the journaling application). Optionally, the device saves the journal entry locally and/or remotely.

In some embodiments, the first content item is a first type and the second content item is a second type different from the first type, such as content item 818f of FIG. 8E being (or representing) a photo and content item 818g of FIG. 8E being (or representing) an audio clip.

In some embodiments, before displaying the first user interface including the list of suggested content for inclusion in the journal entry of the journaling application, the electronic device displays, via the display generation component, a selectable user interface element for displaying the list of suggested content for inclusion in the journal entry of the journaling application, such as by displaying affordance 808d in user interface 806 of FIG. 8B. In some embodiments, before displaying the first user interface including the list of suggested content for inclusion in the journal entry of the journaling application, the electronic device detects, via the one or more input devices, an input directed to the selectable user interface element for displaying the list of suggested content for inclusion in the journal entry of the journaling application, such as by detecting a selection of affordance 808d of FIG. 8B (e.g., by detecting a tap on affordance 808d, a click on affordance 808d, or another type of input indicating a selection of affordance 808d). In some embodiments, in response to detecting the input directed to the selectable user interface element for displaying the list of suggested content for inclusion in the journal entry of the journaling application, the electronic device displays, via the display generation component, the first user interface including the list of suggested content for inclusion in the journal entry of the journaling application, such as by displaying journal user interface 810 and suggested moment 816a of FIG. 8C.

In some embodiments, the first user interface consumes a first display area in accordance with a determination that one or more first criteria is satisfied, such as the display area of suggested moment 816a of FIG. 8C. In some embodiments, the first user interface consumes a second display area, greater than the first display area, in accordance with a determination that one or more second criteria are satisfied, such as the display area consumed by suggested moments 816b and 816c in FIG. 8E, which is greater than the display area of suggested moment 816a of FIG. 8C. As another example, the device optionally expands the area consumed by journal entry field 812 (and therefore the area consumed by the first user interface) in accordance with a determination that an amount of text entered into journal entry field 812 is greater than a threshold amount of text, such as greater than 2, 3, 5, 8, 10, 20, or 30 lines of text.

In some embodiments, while displaying a second list of suggested content items including second content items (optionally, while the journal user interface is not displayed), the device receives, via the one or more input devices, an input directed to the second list of suggested content items (e.g., a touch or tap on the second list of suggested content items, or another type of input). In some embodiments, in response to receiving the second input directed to the second list of suggested content items for inclusion in the journal entry of the journaling application, and in accordance with a determination that one or more first criteria are satisfied, the device saves (e.g., generates and/or stores) the second content items in a journal entry of the journal application without initiating a process to add further content to the journal entry of the journaling application. For example, the second list of suggested content is optionally moment 876b of FIG. 8T, and when the one or more first criteria are satisfied, which optionally include a criterion that is satisfied when the electronic device detects an input selecting first selectable option 884a of FIG. 8T, the electronic device optionally saves the content items in the moment 876b to a journal entry (e.g., by creating a journal entry that includes the content items in the moment 876b) without initiating the process to add further content to the journal entry (e.g., without displaying journal user interface 810, without displaying a keyboard, and/or without displaying representations of the second content items in the content entry region 817 and/or in journal entry field 812 of journal user interface 810).

In some embodiments, in response to receiving the second input directed to the second list of suggested content items for inclusion in the journal entry of the journaling application, and in accordance with a determination that one or more second criteria, different from the one or more first criteria, are satisfied, the device displays representations of the second content items in the content entry region of the journal user interface (and optionally launches the journal user interface, if it is not already displayed). For example, the first suggested content is optionally moment 876b of FIG. 8T, and when the one or more second criteria are satisfied, which optionally include a criterion that is satisfied when the electronic device detects input selecting second selectable option 884a of FIG. 8T, the electronic device optionally displays journal user interface 810 (if not already displayed) and displays representations of content items of moment 876b to the content entry region 817 and/or to journal entry field 812 (such as by displaying journal entry user interface 810 of FIG. 8G, but with content item representations 880a-880b displayed in journal entry field 812), thereby initiating the process to add further content (e.g., text or additional content items) to the journal entry.

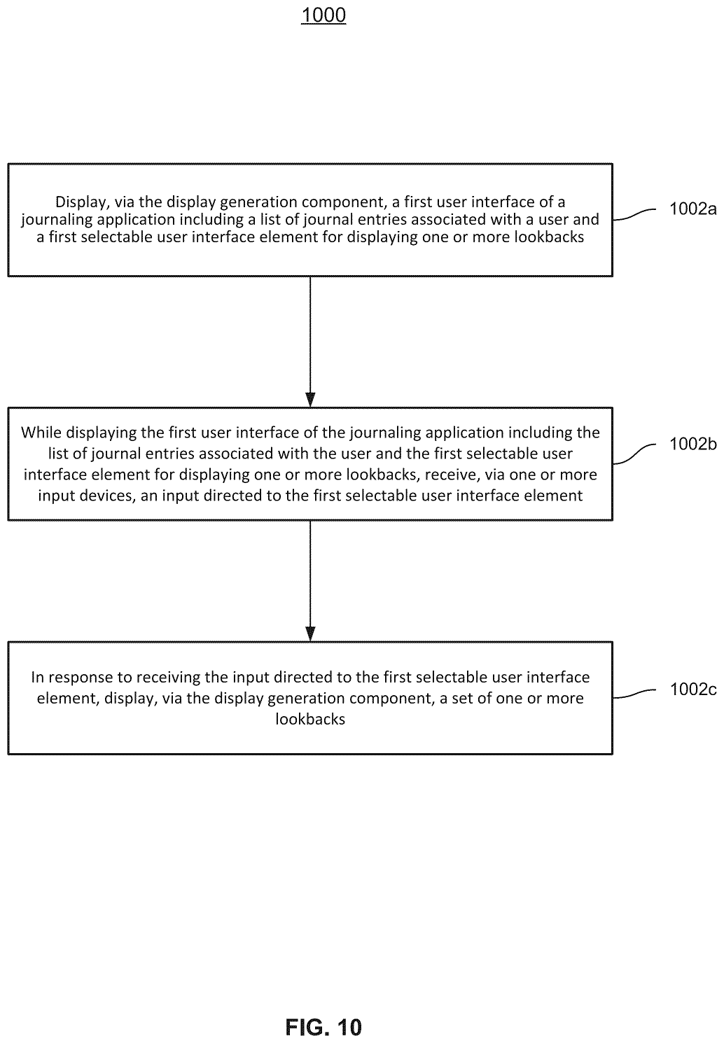

FIG. 10 is a flow diagram illustrating a method 1000 of displaying user interfaces including lookbacks in accordance with some embodiments, such as in FIGS. 8N-8R. The method 1000 is optionally performed at an electronic device such as device 100, device 300, or device 500 as described above with reference to FIGS. 1A-1B, 2-3, 4A-4B and 5A-5H. Some operations in method 1000 are optionally combined and/or order of some operations is, optionally, changed.

In some embodiments, method 1000 is performed at an electronic device in communication with a display generation component and one or more input devices. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 1000 is performed at or by an automobile (e.g., at an infotainment system of an automobile having or in communication with one or more display generation components and/or input devices).

In some embodiments, the electronic device displays (1002a), via the display generation component, a first user interface of a journaling application including a list of journal entries associated with a user (e.g., journal entries generated and/or saved by the user in the journaling application, such as while logged in to the journaling application), such as timeline of journal entry representations 844a-844c in timeline user interface 842 of FIG. 8N and a first selectable user interface element for displaying one or more lookbacks, such as lookback affordance 848 in timeline user interface 842 of FIG. 8N. In some embodiments, while displaying the first user interface of the journaling application including the list of journal entries associated with the user and the first selectable user interface element for displaying one or more lookbacks, the electronic device receives (1002b), via the one or more input devices, an input (e.g., a touch, tap, click, or other input) directed to the first selectable user interface element, such as an input selecting lookback affordance 848 in timeline user interface 842 of FIG. 8N. In some embodiments, in response to receiving the input directed to the first selectable user interface element, the electronic device displays (1002c), via the display generation component, a set of one or more lookbacks, such as first lookback pane 856a associated with a set of “Birthdays” lookbacks 857a-857c in FIG. 8O or second lookback pane 856b associated with an “On This Day” lookback 857d.

In some embodiments, the set of one or more lookbacks are associated with one or more journal entries that satisfy a criterion that is satisfied when a date associated with the one or more journal entries is within a range of dates (e.g., a range between two dates, or a range of a single date, which can include the month, day, and/or year). For example, in response to detecting selection of lookback representation 860b in FIG. 8P, the electronic device optionally displays a lookback type user interface 862 of FIG. 8Q with lookback representations associated with the current month and day (“On This Day”).

In some embodiments, the set of one or more lookbacks are associated with one or more journal entries that satisfy a criterion that is satisfied when a date associated with the one or more journal entries is an annual date, such as lookback type user interface 862 with lookback representations 860b and 860e associated with “On This Day” lookbacks in FIG. 8P and/or a lookback type user interface including lookback representations associated with “Birthdays” lookback.

In some embodiments, the set of one or more lookbacks are associated with one or more journal entries that satisfy a criterion that is satisfied when a type of content of the journal entries is media content. For example, a lookback representation, such as lookback representation 860e of FIG. 8P, is optionally associated with journal entries associated with (e.g., that include or reference) music and/or videos played by the user over the specific time period, such as over a most recent summer. In this example, in response to detecting selection of the lookback representation 860e, the electronic device optionally displays a lookback type user interface 862 of FIG. 8Q, but with representations of music and/or video content that the user played the over the time period (e.g., the most recent summer) and with a heading associated with the time period, such as “Music Over the Summer” (instead of “On This Day”).

In some embodiments, displaying, via the display generation component, the set of journal entries that satisfy the one or more first criteria includes displaying, via the display generation component: in a first portion, a first set of one or more lookbacks that satisfy a criterion that is satisfied when a date associated with one or more journal entries corresponding to the first set of one or more lookbacks is a first date or is within a first range of dates, such as lookback representation 860a in FIG. 8P, in a second portion, a second set of one or more lookbacks that satisfy a criterion that is satisfied when a time of day associated with one or more journal entries of corresponding to the second set of one or more lookbacks is a first time of day or is within a first range of time of days, such as lookback representation 860b in FIG. 8P, and/or in a third portion, a third set of one or more lookbacks that satisfy a criterion that is satisfied when a type of content of journal entries corresponding to the third set of one or more lookbacks includes a first type of content, such as a lookback representation 860e in FIG. 8P, but including representations of journal entries associated with music and/or videos played by the user over a specific time period.

In some embodiments, aspects/operations of methods 700, 900, and/or 1000, may be interchanged, substituted, and/or added between these methods. For example, the journaling application of methods 700, 900, and/or 1000, are optionally interchanged, substituted, and/or added between these methods. For brevity, these details are not repeated here.

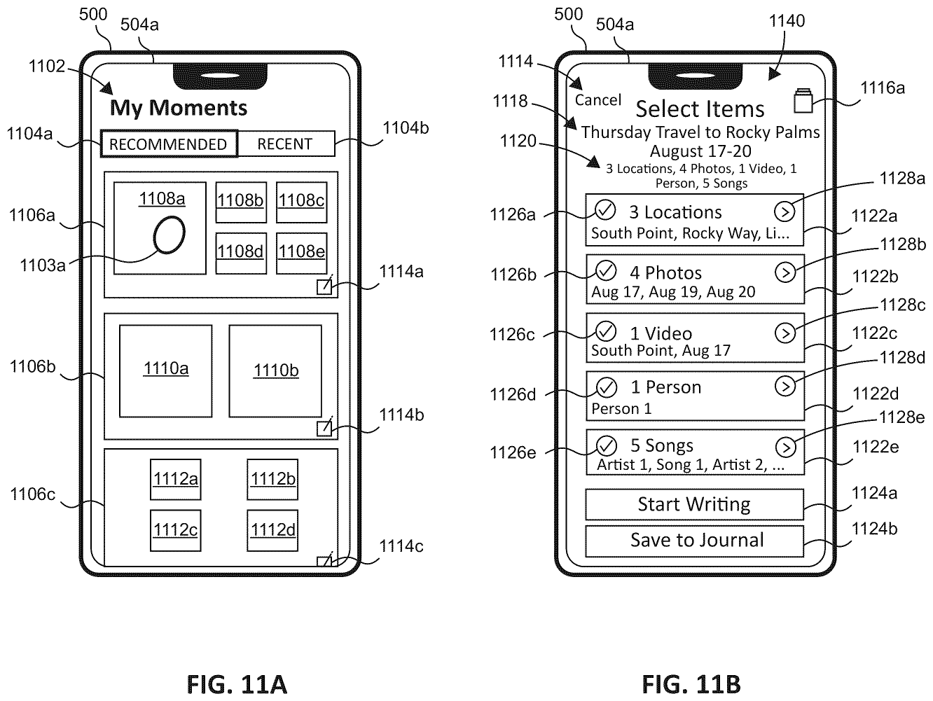

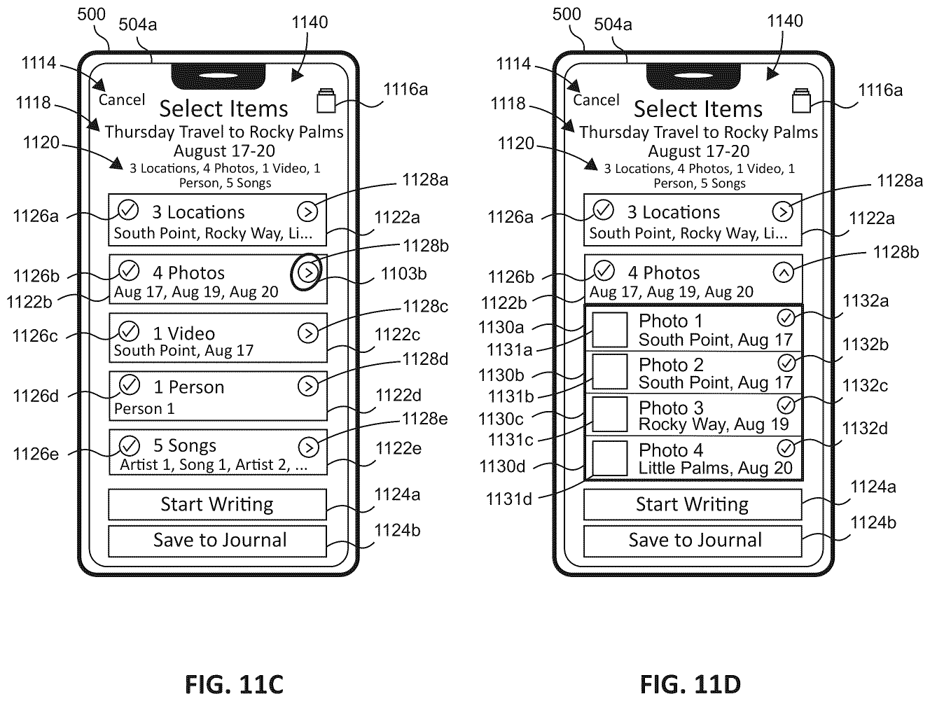

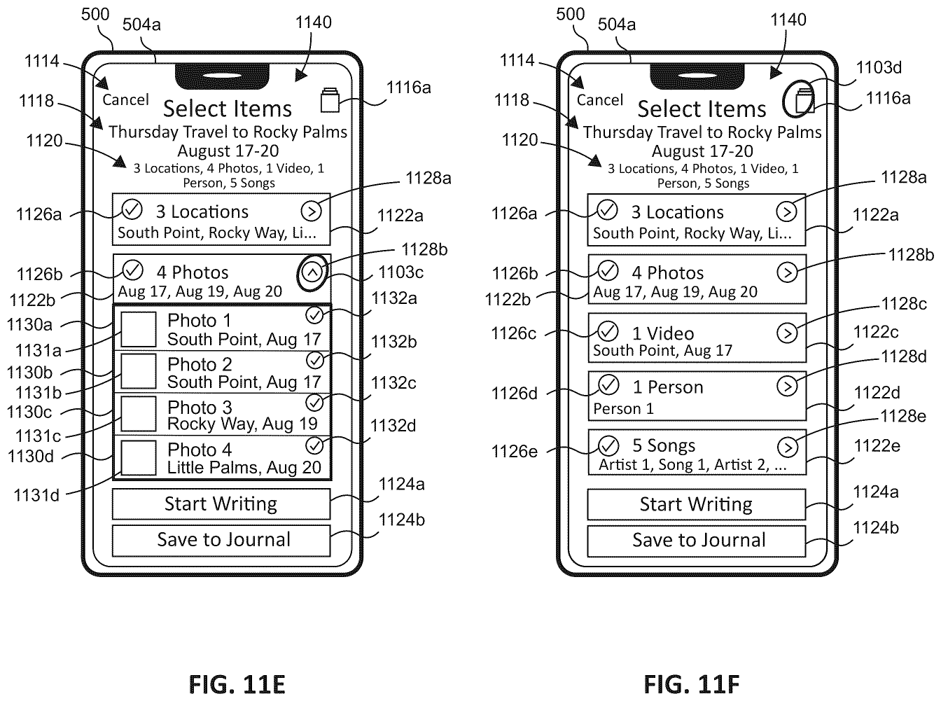

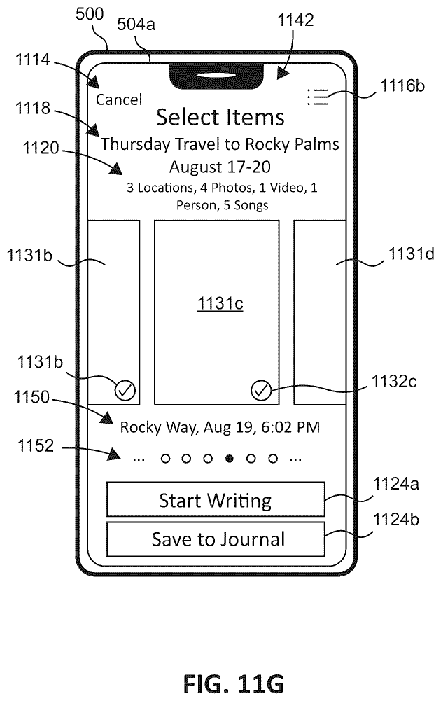

FIGS. 11A-11G generally illustrate ways to selectively include content of a list of suggested content items in a journal entry of a journaling application in accordance with some embodiments.

FIG. 11A illustrates a moments user interface 1102. Moments user interface 1102 includes moments 1106a-1106c, each of which is, optionally, associated with a moment date (or a moment date range) and includes text and/or representations of content items (e.g., content item representations 1108a-1108c, 1110a-1110b, 1112a-1112d), respectively. As previously discussed, in some embodiments, device 500A generates moments 1106a-1106c based on analysis of content items stored and/or accessible on device 500A, such as by identifying content items that are associated with a particular date or event that may be of interest to the user. In some embodiments, moments 1106a-1106c that are displayed in moment user interface 1102 are moments that have not previously been journaled about by the user (e.g., are not included in a journal entry in the journaling application) and are provided to prompt the user to select a moment to journal about (e.g., to include in a journal entry). Moments 1106a-1106c are optionally respective lists of suggested content items. In some embodiments, a number of content items included in a respective moment in FIG. 11A is greater than a number of representations of content items in a respective moment in FIG. 11A. For example, moment 1106a is optionally associated with fourteen content items although in FIG. 11A, moment 1106a includes five content item representations 1108a-1108c.

In FIG. 11A, moments user interface 1102 includes selectable option 1104a and selectable option 1104b, each of which is optionally selectable to cause device 500A to select (e.g., filter) which moments and/or prompts to present in moments user interface 1102. For example, in response to selection of selectable option 1104a (which is shown as selected in FIG. 11A), device 500A optionally displays moments that are recommended by device 500A, such as based on analysis of previous activities or indications of interests of the user. In response to selection of selectable option 1104b, device 500A displays optionally moments that are associated with recent dates, such as dates within the last day, week, month, or year. In some embodiments, moments user interface 1102 includes additional selectable options, such as icon 886c and icon 866d of FIG. 8S. In some embodiments, moments user interface 1102 of FIG. 11A includes selectable option 1104a and selectable option 1104b of FIG. 11A, without including icon 886c and 866d of FIG. 8S, such as shown in FIG. 11A.

In FIG. 11A, moments 1106a-1106c include selectable options 1102a-1104c, respectively, each of which is optionally selectable to cause device 500A to display a journal entry user interface, such as journal entry user interface 810 of FIG. 8F, that includes the content items of the respective moment to which the respective selected selectable option corresponds. For example, in response to selection of selectable option 1114a, device 500A optionally displays the journal entry user interface 810 of FIG. 8G or FIG. 8F, but with content items of selected moment 1106a (e.g., all content items of selected moment 1106a, which is optionally more than the number of content item representations 1108a-1178e of FIG. 11A) displayed in journal entry field 812 (e.g., in a manner similar to that shown in FIG. 8G) or above journal entry field 812 (e.g., in a manner similar to that shown in FIG. 8F). The user can then add text, add additional content items, or save the journal entry, such as described with reference to FIGS. 8C-8M.

In FIG. 11A, each of moments 1106a-1106c is optionally selectable to display an editing user interface for editing which content items of the respective moment are to be included in a journal entry or to be saved to journal from the respective moment. For example, in response to receiving selection (e.g., via contact 1103a of FIG. 11A) of moment 1106a (e.g., in a region of moment 1106a in FIG. 11A that is outside of selectable option 1102a), device 500A optionally displays editing user interface 1140 of FIG. 11B. Editing user interface 1140 of FIG. 11A is for selectively including content of a list of suggested content items in a journal entry of a journaling application from moment 1106a.

Editing user interface 1140 of FIG. 11B is optionally a more detailed view of moment 1106a compared with the visual display (e.g., the visual indication) of moment 1106a in moments user interface 1102 of FIG. 11A, as described further below. For example, editing user interface 1140 is more descriptive of moment 1106a, as it includes the content items of moment 1106a, organized by type of content item, in addition to other features described below.

Editing user interface 1140 of FIG. 11B includes description 1118 (“Thursday Travel to Rocky Palms”) of the event that corresponds to the moment 1106a. Editing user interface 1140 of FIG. 11B also includes textual content 1120 indicating respective amounts of respective types of content items included in moment 1106a. For example, textual content 1120 indicates that moment 1106a includes three locations, four photos, one video, one person, and five songs.

Editing user interface 1140 of FIG. 11B includes user interface elements 1122a-1122e. User interface elements 1122a-1122e visually indicate the respective type of content to which the respective user interface element 1122a-1122e corresponds, in additional to visually indicating data (e.g., metadata) related to the respective content item to which the respective user interface element corresponds. For example, user interface element 1122a visual indicates that moment 1106a includes three locations, and further indicates names of the locations themselves; user interface element 1122b visually indicates that moment 1106a includes four photos, and further indicates respective dates associated with the four photos; user interface element 1122c visually indicates that moment 1106a includes one video, and further indicates a date and location corresponding to the capture of the video; user interface element 1122d visually indicates that moment 1106a includes one person (e.g., a tagged person), and further indicates the name of the person; user interface element 1122e visually indicates that moment 1106a includes five songs, and further indicates artists associated with the songs and the song titles.

User interface elements 1122a-1122e of FIG. 11B include selectable options 1126a-1126e, respectively, for globally selecting or globally deselecting the respective type of content (to which user interface element 1122a-1122e corresponds) of moment 1106a from inclusion in a journal entry corresponding to moment 1106a. In FIG. 11B, selectable options 1126a-1126e are each in a state corresponding to global selection of the respective type of content of moment 1106a in journal entry from moment 1106a. Thus, from the embodiment of FIG. 11B, selectable option 1126a is optionally selectable to exclude the location content items from a journal entry that corresponds to moment 1106a; selectable option 1126b is optionally selectable to exclude photo content items from the journal entry that corresponds to moment 1106a; selectable option 1126c is optionally selectable to exclude the video content items from the journal entry that corresponds to moment 1106a; selectable option 1126d is optionally selectable to exclude person content items from the journal entry that corresponds to moment 1106a; selectable option 1126e is optionally selectable to exclude the media content items from the journal entry that corresponds to moment 1106a. If a respective selectable option 1126a-1126e is in a deselected state, the respective selectable option 1126a-1126e is selectable to enter a selected state, optionally in which all content items of the respective type corresponding to the respective selectable option 1126a-1126e are selected for inclusion. In some embodiments, a respective selectable option 1126a-1126e that is in a deselected state has a first visual appearance (e.g., does not include a checkmark) and a respective selectable option 1126a-1126e that is in a selected state has a second visual appearance (e.g., includes a checkmark) that is different from the first visual appearance in order to provide the user a visual distinction between which content item types are to be included in the journal entry and which content item types are not to be included in the journal entry.

It should be noted that in some embodiments, when electronic device displays editing user interface 1140 of FIG. 11B in response to detection of contact 1103a of FIG. 11A, all content items and/or all content item types are in a selected state (e.g., without further user input). In some embodiments, when electronic device displays editing user interface 1140 of FIG. 11B in response to detection of contact 1103a of FIG. 11A, all content items and/or all content item types are in a deselected state (e.g., without further user input).

User interface elements 1122a-1122e of FIG. 11B include selectable options 1128a-1128e, each of which is selectable for viewing and/or further selectively including content items corresponding to a respective type of content item in the journal entry for moment 1106a on a per content item of the respective type basis. For example, in response to detecting selection of selectable option 1128b via contact 1103b of FIG. 11C, device 500A optionally displays editing user interface 1140 of FIG. 11D.

Editing user interface 1140 of FIG. 11D includes a list of the photo content items associated with moment 1106a (e.g., the four photos of moment 1106a), from which the user can select or deselect which photos the user desires to include in the journal entry from moment 1106a. In FIG. 11D, the list of photo content items is shown in user interface elements 1130a-1130d, as user interface elements 1130a-1130d include photo content 1131a-1121d, respectively. A respective user interface element 1130a-1130d includes details about the respective photo (e.g., a date and location corresponding to the capture of the photo), and a respective selectable option 1132a-1132d for including or excluding the respective photo in the journal entry from for moment 1176a. In FIG. 11D, user interface elements 1132a-1132d are optionally each in a state corresponding to inclusion of the respective photo of moment 1176a in journal entry corresponding to moment 1176a. In FIG. 11D, each of user interface elements 1132a-1132d can optionally change in visual appearance, such as discussed with reference to user interface elements 1126a-1126e, based on whether they are selected. In FIG. 11D, selectable option 1128b is optionally selectable to remove user interface elements 1132a-1132d (e.g., to return to editing user interface 1140 of FIG. 11B). For example, in response to detecting selection (e.g., via contact 1103c of FIG. 11E), device 500A optionally displays editing user interface 1140 of FIG. 11B.

In some embodiments, textual content 1120 indicated by editing user interface 1140 of FIG. 11B or FIG. 11C updates in real-time as the user makes selections or deselections of particular content item types (e.g., from user interface elements 1126a-1126e of FIG. 11C) or from user interface elements that correspond to selections or deselections particular content items within particular content types (e.g., user interface elements 1132a-1132d of FIG. 11C). For example, the textual content 1120 indicated by editing user interface 1140 of FIG. 11B indicates a date range of Aug. 17, 2023-Aug. 20, 2023 corresponding to “Thursday Travel to Rocky Palms”, and in response to detecting that, due to user selections, no content item is currently selected that includes (e.g., as metadata) the date of Aug. 17, 2023 and content items that are currently selected includes (e.g., as metadata) dates of Aug. 17, 2023-Aug. 19, 2023, device 500A optionally updates the visually indicated date range to indicate dates of Aug. 17, 2023-Aug. 19, 2023 instead of visually indicating date range of Aug. 17, 2023-Aug. 20, 2023 corresponding to journal entry for moment 1106a. In some embodiments, the amounts of respective types of content that device 500A visually indicate updates based on user selections. For example, in response to a user excluding two of the four photos in editing user interface 1140 of FIG. 11D, device 500A optionally updates the number of photos that editing user interface 1140 of FIG. 11D visually indicates in textual content 1120 (e.g., description) to visually indicate two photos instead of four photos, optionally in addition to updating the number of photos that the editing user interface 1140 of FIG. 11D visually indicates in user interface element 1122b.

Returning back to FIG. 11B, editing user interface 1140 includes user interface element 1124a and user interface element 1124b. (As illustrated, the user interfaces of FIG. 11B-11G likewise includes user interface element 1124a and user interface element 1124b). User interface element 1124a is optionally selectable to cause device 500A to display a journal entry field that includes the content of moment 1106a that is selected for inclusion based on user selections (e.g., selections in FIG. 11B or FIG. 11D). User interface element 1124b is optionally selectable to cause device 500A to save (e.g., save for later journaling) content of moment 1106a that is selected for inclusion based on user selections (e.g., selections in FIG. 11B or FIG. 11D) without content entry region and/or a journey entry field. In some embodiments, user interface element 1124a and user interface element 1124b are as described with respect to selectable option 884b and selectable option 884a of FIG. 8T, respectively.

Editing user interface 1140 of FIG. 11B includes selectable option 1114 and selectable option 1116a. In some circumstances, a user wishes to cancel selecting items from moment 1106a for journaling or adding to journal. In response to detecting selection of selectable option 1114 (e.g., via contact 1103d of FIG. 11F), device 500A optionally displays moments user interface 1102 of FIG. 11A. In some circumstances, a user wishes to view content of moment 1106a or wishes to make selections of content from moment 1106a in another view. In response to detection of selection (e.g., via contact 1103d) of selectable option 1116a, device 500A optionally displays editing user interface 1142 of FIG. 11G.

Editing user interface 1142 of FIG. 11G includes a horizontal scrollable view of content items of moment 1106a. In horizontal scrollable view, device 500A displays content of moment 1106a with horizontal scrolling functionality, such that a user can optionally scroll laterally (e.g., touch contact on content of moment 1106a with lateral movement) to view and make selections or deselections from content of moment 1106a for inclusion in a journal entry. Editing user interface 1142 of FIG. 11G includes a navigation pane 1152 for notifying the user of a position in the scroll. In FIG. 11G, editing user interface includes photo content 1131c, the metadata 1150 of photo content 1131c (e.g., a location, date, and time of capture of photo content 1131c), selectable options 1132c for selecting or deselecting photo content 1131c for or from inclusion in the journal entry. Editing user interface 1142 of FIG. 11G optionally groups respective content items of respective content item types in the horizontal scroll. For example, in editing user interface 1142 of FIG. 11G, the four photos of moment 1106a are optionally adjacent to each other in the horizontal scroll, the three locations of moment 1106a are optionally adjacent to each other, and the five songs are optionally adjacent to each other. In FIG. 11G, editing user interface 1142 includes selectable options 1132c for selecting or deselecting the respective content item for or from inclusion in the journal entry. In the illustrated example of FIG. 11G, editing user interface 1142 does not include any of selectable options 1126a-1126e. A user can return to editing user interface 1140 of FIG. 11F via selection of selectable option 1116b. Editing user interface 1142 of FIG. 11G is optionally scrollable to view any content item of moment 1106a, and as a user scrolls from a first content item to a second content item, the metadata 1150 optionally updates to correspond to the content that item that is in view. For example, since photo content 1131c is in view in FIG. 11G, device 500A displays metadata 1150 corresponding to photo content 1131c. Continuing with this example, in response to detection a scroll input to one of the five songs of moment 1106a, device 500A displays metadata corresponding to the one of the five songs instead of the metadata 1150 corresponding to photo content 1131c.

Editing user interface 1140 of FIG. 11F and editing user interface 1142 of FIG. 11G optionally updates based on selection performed in the other editing user interface. For example, a user optionally deselects one or more content items or one or more content item types of moment 1106a while device 500A displays editing user interface 1140 of FIG. 11B or FIG. 11D, and in response to detection selection of selectable option 1116a in FIG. 11B or FIG. 11D, device 500A optionally displays editing user interface 1142 of FIG. 11G, including the one or more content items of moment 1106a that were deselected in editing user interface 1140 being likewise deselected in editing user interface 1142 of FIG. 11G (e.g., without further user input). As another example, a user optionally selects one or more content items or one or more content item types of moment 1106a while device 500A displays editing user interface 1140 of FIG. 11B or FIG. 11D, and in response to detection selection of selectable option 1116a in FIG. 11B or FIG. 11D, device 500A optionally displays editing user interface 1142 of FIG. 11G, including the one or more content items of moment 1106a that were selected in editing user interface 1140 being likewise selected in editing user interface 1142 of FIG. 11G (e.g., without further user input).

Thus, present embodiments provide a user an ability to seamlessly create journaling entries and/or edit content item types and/or content items for inclusion in or exclusion from a journal entry, without subjecting the user to making additional inputs, thereby providing a simple way for the user to journal about the selected item.

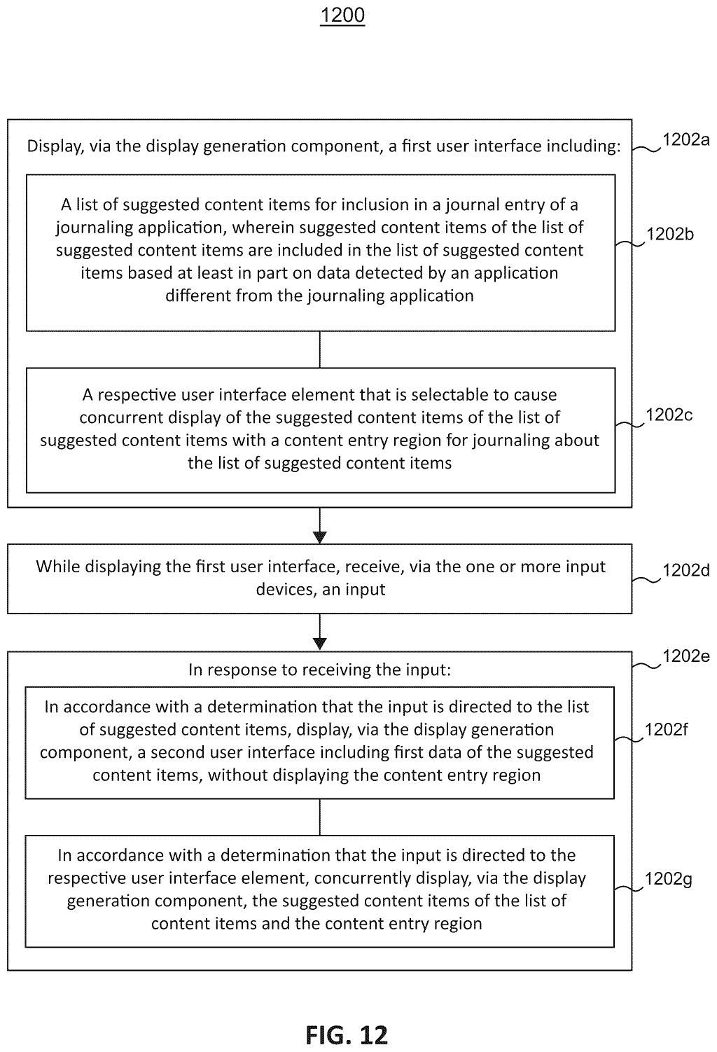

FIG. 12 is a flow diagram illustrating a method 1200 of displaying user interfaces for journaling in accordance with some embodiments, such as in FIGS. 11A-11G. The method 1200 is optionally performed at an electronic device such as device 100, device 300, or device 500 as described above with reference to FIGS. 1A-1B, 2-3, 4A-4B and 5A-5H. Some operations in method 1200 are optionally combined and/or order of some operations is, optionally, changed.

In some embodiments, method 1200 is performed at an electronic device in communication with a display generation component and one or more input devices. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 1200 is performed at or by an automobile (e.g., at an infotainment system of an automobile having or in communication with one or more display generation components and/or input devices).

In some embodiments, the electronic device displays (1202a), via the display generation component, a first user interface (e.g., moments user interface 1102 of FIG. 11A) including a list (e.g., moment 1106a of FIG. 11A) of suggested content items (e.g., content items included in moment 1106a of FIG. 11A such as content items 1108a-1108e) for inclusion in a journal entry of a journaling application, wherein suggested content items of the list of suggested content items are included in the list of suggested content items based at least in part on data detected by an application different from the journaling application, such as a date of the content item, a location of the content item, a person associated with the content item, an event associated with the content item, or other types of data, (1202b), and a respective user interface element (e.g., selectable option 1114a of FIG. 11A) that is selectable to cause concurrent display of suggested content items of the list of suggested content items with a content entry region for journaling about the list of suggested content items, such as content entry region 817 of FIG. 8F or journal entry field 812 of FIG. 8G (1202c).

In some embodiments, while displaying the first user interface, the electronic device receives (1202d), via the one or more input devices, an input, such as contact 1103a of FIG. 11A.

In some embodiments, in response to receiving the input (1202c), in accordance with a determination that the input is directed to the list of suggested content items, the electronic device displays (1202f), via the display generation component, a second user interface (e.g., editing user interface 1140 of FIG. 11B or editing user interface 1142 of FIG. 11G) including first data of the suggested content items (e.g., description 1118 of FIG. 11B, textual content 1120 of FIG. 11B, and/or other indications of data of the suggested content items shown in FIG. 11B, such as visual indications in user interface elements 1122a-1122c) without displaying the content entry region (e.g., without displaying journal entry field 812 or content entry region 817 of FIG. 8F). In some embodiments, the electronic device displays the second user interface with the content entry region and/or a journal entry field.

In some embodiments, in response to receiving the input (1202e), in accordance with a determination that the input is directed to the respective user interface element, the electronic device concurrently displays (1202g), via the display generation component, the suggested content items of the list of suggested content items and the content entry region, such as displaying journal entry user interface 810 of FIG. 8F, that includes the content items of the respective moment to which the respective selected selectable option corresponds. For example, in response to selection of selectable option 1114a, device 500A optionally displays the journal entry user interface 810 of FIG. 8G or FIG. 8F, but with content items of selected moment 1106a (e.g., all content items of selected moment 1106a, which is optionally equal to or more than the number of content item representations 1108a-1108e of FIG. 11A) displayed in journal entry field 812 (e.g., in a manner similar to that shown in FIG. 8G) or above journal entry field 812 (e.g., in a manner similar to that shown in FIG. 8F). The user can then add text, add additional content items, or save the journal entry such as described with reference to FIGS. 8C-8L.

In some embodiments, the second user interface includes user interface elements including a first user interface element corresponding to a first type of content item (e.g., a song, a photo, a person, a location, or a video) in the list of suggested content items, wherein the first user interface element visually indicates the first type of content item, a number of content items of the first type, and/or other metadata associated with content items of the first type of content item, such as user interface element 1122b of FIG. 11B, and a second user interface element corresponding to a second type of content item in the list of suggested content items, wherein the second user interface element visually indicates the second type of content item, a number of content items of the second type, and/or other metadata associated with content items of the second type of content item, such as user interface element 1122c of FIG. 11B.

In some embodiments, the first user interface element includes a first selectable option for excluding or including content items of the first type of content item on a per first content item type basis, such as selectable option 1126b of FIG. 11B, and the second user interface element includes a second selectable option for excluding or including content items of the second type of content item on a per second content item type basis, such as selectable option 1126c of FIG. 11B.

In some embodiments, the first user interface element includes a first selectable option for viewing content items of the first type of the list of suggested content items, such as selectable option 1128b of FIG. 11B. In some embodiments, the electronic device receives, via the one or more input devices, an input directed to the first selectable option, such as contact 1103b of FIG. 11C. In some embodiments, in response to receiving the input directed to the first selectable option, the electronic device concurrently displays, via the display generation component, first respective content items of the first type of content item of the list of suggested content items, such as user interface elements 1130a-1130d in FIG. 11D and/or photo content 1131a-1131d in FIG. 11D, and first respective selectable options for excluding or including the first respective content items on a per content item of the first type basis, different from a per first content item type basis, such as selectable options 1132a-1132d of FIG. 11D.

In some embodiments, the second user interface includes user interface elements including: a third selectable option for displaying a horizontal scrollable view of content items of suggested content items, such as selectable option 1116a of FIG. 11B. In some embodiments, the electronic device receives, via the one or more input devices, an input directed to third selectable option, such as contact 1103d of FIG. 11F, and in response to receiving the input directed to the third selectable option, the electronic device displays, via the display generation component, a third user interface including a horizontal scrollable view of content items of suggested content items (e.g., editing user interface 1142 of FIG. 11G), the third user interface including user interface elements including first respective content items of the first type of the list of suggested content items, such as photo content 1131c of FIG. 11G and the content items that are adjacent to photo content 1131c of FIG. 11G, and first respective selectable options for excluding or including the first respective content items on a per content item of the first type basis, different from a per first content item type basis, such as selectable option 1144c of FIG. 11C.

In some embodiments, the third user interface includes a fourth selectable option for displaying the second user interface, such as selectable option 1116b of FIG. 11G. In some embodiments, while displaying, via the display generation component, the third user interface, the electronic device receives, via the one or more input devices, an input directed to a first selectable option of the first respective selectable options, such as selectable option 1144c of FIG. 11C, wherein the first selectable option is selectable to exclude a first respective content item of the first respective content items from inclusion of the journal entry. In some embodiments, while displaying, via the display generation component, the third user interface, in response to receiving the input directed to the first selectable option of the first respective selectable options, the electronic device visually indicates, via the display generation component, that the first respective content is not selected for inclusion in the journal entry. For example, in response to detection of selectable option 1144c of FIG. 11G corresponding to a request to exclude content item 1130c from inclusion in a journal entry corresponding to moment 1106a, the electronic device optionally visually indicates, via selectable option 1144c, that first respective content is not selected for inclusion in the journal entry. In some embodiments, while displaying, via the display generation component, the third user interface, after receiving the input directed to the first selectable option of the first respective selectable options, the electronic device receives, via the one or more input devices, an input directed to the fourth selectable option, such as selectable option 1116b of FIG. 11G. In some embodiments, in response to receiving the input directed to the fourth selectable option, the electronic device displays, via the display generation component, the second user interface including the first data modified due to the input directed to the first selectable option of the respective selectable options. For example, in response to receiving the input directed to the fourth selectable option after receiving the input corresponding to the request to exclude content item 1130c from inclusion in a journal entry corresponding to moment 1106a, and content item 1130c is of a respective content item type, the electronic device optionally displays the second user interface with textual content 1120 visually indicating a respective number of a content items of a respective content item type that does not include count content item 1130c in the respective number.

In some embodiments, aspects/operations of methods 700, 900, 1000 and/or 1200, may be interchanged, substituted, and/or added between these methods. For example, the journaling application, journal entry user interfaces, content entry regions, journal entry field, prompts, moments, moment user interfaces, and/or editing user interfaces of methods 700, 900, 1000 and/or 1200, are optionally interchanged, substituted, and/or added between these methods. For brevity, these details are not repeated here in further detail.

As described above, one aspect of the present technology is the gathering and use of data available from specific and legitimate sources to improve the ability for users to create journaling entries. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to detect activity events. Accordingly, use of such personal information data enables users to be prompted with activity events to create journaling entries. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide personal data and/or device or object location data. In yet another example, users can select to limit the length of time personal data and/or device or object location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data and/or location data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
displaying, via the display generation component, a first user interface, including:
a list of suggested content items for inclusion in a journal entry of a journaling application, wherein suggested content items of the list of suggested content items are included in the list of suggested content items based at least in part on data detected by an application different from the journaling application; and
a respective user interface element that is selectable to cause concurrent display of the suggested content items of the list of suggested content items with a content entry region for journaling about the list of suggested content items;
while displaying the first user interface, receiving, via the one or more input devices, an input; and
in response to receiving the input:
in accordance with a determination that the input is directed to the list of suggested content items, displaying, via the display generation component, a second user interface including first data of the suggested content items, without displaying the content entry region; and
in accordance with a determination that the input is directed to the respective user interface element, concurrently displaying, via the display generation component:
the suggested content items of the list of suggested content items; and
the content entry region.

2. The method of claim 1, wherein:
the second user interface includes first user interface elements including:
a first user interface element corresponding to a first type of content item in the list of suggested content items, wherein the first user interface element visually indicates the first type, a number of content items of the first type, and/or other metadata associated with content items of the first type; and
a second user interface element corresponding to a second type of content item in the list of suggested content items, wherein the second user interface element visually indicates the second type, a number of content items of the second type, and/or other metadata associated with content items of the second type.

3. The method of claim 2, wherein:
the first user interface element includes a first selectable option for excluding or including content items of the first type on a per first content item type basis; and
the second user interface element includes a second selectable option for excluding or including content items of the second type on a per second content item type basis.

4. The method of claim 2, wherein:
the first user interface element includes a first selectable option for viewing content items of the first type of the list of suggested content items, and
the method comprises:
receiving, via the one or more input devices, input directed to the first selectable option; and
in response to receiving the input directed to the first selectable option, concurrently displaying, via the display generation component:
first respective content items of the first type of the list of suggested content items; and
first respective selectable options for excluding or including the first respective content items on a per content item of the first type basis, different from a per first content item type basis.

5. The method of claim 2, wherein
the second user interface includes first user interface elements including:
a third selectable option for displaying a horizontal scrollable view of content items of suggested content items; and
the method comprises:
receiving, via the one or more input devices, input directed to third selectable option; and
in response to receiving the input directed to the third selectable option, displaying, via the display generation component:
a third user interface including a horizontal scrollable view of content items of suggested content items, the third user interface including second user interface elements including:
first respective content items of the first type of the list of suggested content items; and
first respective selectable options for excluding or including the first respective content items on a per content item of the first type basis, different from a per first content item type basis.

6. The method of claim 5, wherein the third user interface includes a fourth selectable option for displaying the second user interface, and the method comprising:
while displaying, via the display generation component, the third user interface:
receiving, via the one or more input devices, an input directed to a first selectable option of the first respective selectable options, wherein the first selectable option is selectable to exclude a first respective content item of the first respective content items from inclusion of the journal entry; and
in response to receiving the input directed to the first selectable option of the first respective selectable options, visually indicating that the first respective content is not selected for inclusion in the journal entry;
after receiving the input directed to the first selectable option of the first respective selectable options, receiving, via the one or more input devices, an input directed to the fourth selectable option;
in response to receiving the input directed to the fourth selectable option, displaying, via the display generation component, the second user interface including the first data modified due to the input directed to the first selectable option of the respective selectable options.

7. An electronic device, comprising:
one or more processors;
memory; and
one or more programs, wherein the one or more programs are stored in the memory and configured to be executed by the one or more processors, the one or more programs including instructions for:
displaying, via a display generation component, a first user interface, including:
a list of suggested content items for inclusion in a journal entry of a journaling application, wherein suggested content items of the list of suggested content items are included in the list of suggested content items based at least in part on data detected by an application different from the journaling application; and
a respective user interface element that is selectable to cause concurrent display of the suggested content items of the list of suggested content items with a content entry region for journaling about the list of suggested content items;
while displaying the first user interface, receiving, via one or more input devices, an input; and
in response to receiving the input:
in accordance with a determination that the input is directed to the list of suggested content items, displaying, via the display generation component, a second user interface including first data of the suggested content items, without displaying the content entry region; and
in accordance with a determination that the input is directed to the respective user interface element, concurrently displaying, via the display generation component:
the suggested content items of the list of suggested content items; and
the content entry region.

8. A non-transitory computer readable storage medium storing one or more programs, the one or more programs comprising instructions, which when executed by one or more processors of an electronic device, cause the electronic device to perform a method comprising:
displaying, via a display generation component, a first user interface, including:
a list of suggested content items for inclusion in a journal entry of a journaling application, wherein suggested content items of the list of suggested content items are included in the list of suggested content items based at least in part on data detected by an application different from the journaling application; and
a respective user interface element that is selectable to cause concurrent display of the suggested content items of the list of suggested content items with a content entry region for journaling about the list of suggested content items;
while displaying the first user interface, receiving, via one or more input devices, an input; and
in response to receiving the input:
in accordance with a determination that the input is directed to the list of suggested content items, displaying, via the display generation component, a second user interface including first data of the suggested content items, without displaying the content entry region; and
in accordance with a determination that the input is directed to the respective user interface element, concurrently displaying, via the display generation component:
the suggested content items of the list of suggested content items; and
the content entry region.
